(19) United States
(12) Patent Application Publication
(10) Pub. No.: US 2026/0273955 A1
(43) Pub. Date: Sep. 17, 2026

(54) UV LASER MARKER

(71) Applicant: Keyence Corporation, Osaka (JP)

(72) Inventors: Masakazu NISHIKI, Osaka (JP); Yukinobu ITO, Osaka (JP)

(73) Assignee: Keyence Corporation, Osaka (JP)

(21) Appl. No.: 19/466,663

(22) Filed: Feb. 2, 2026

(30) Foreign Application Priority Data
Mar. 11, 2025 (JP) 2025-038761

(51) Int. Cl. B41J 2/44; B41J 2/47; B41J 3/44; B41J 11/00; B41J 29/377

(52) U.S. Cl. CPC B41J 2/442; B41J 2/47; B41J 3/44; B41J 11/0095; B41J 29/377

(57) ABSTRACT

Printing failure in a UV laser marker is suppressed. A laser printing apparatus as a UV laser marker includes: a print head incorporating an excitation light generation section, a laser light generation section, a coupling section that optically couples the excitation light generation section and the laser light generation section, and a laser light scanning section; and a printing controller electrically connected to the print head. The print head includes: an emission window that emits UV laser light two-dimensionally scanned by the laser light scanning section to the outside of the print head; and a wide-area camera that has an imaging optical axis independent of a laser optical path of the UV laser light emitted from the emission window and images a workpiece via the emission window.

### CROSS-REFERENCE TO RELATED APPLICATIONS

The present application claims foreign priority based on Japanese Patent Application No. 2025-038761, filed Mar. 11, 2025, the contents of which are incorporated herein by reference.

### BACKGROUND OF THE INVENTION

### 1. Technical Field

The present disclosure relates to a UV laser marker.

### 2. Description of the Related Art

For example, JP2019-104047A discloses a laser machining apparatus as a UV laser marker. This laser machining apparatus generates UV laser light on the basis of excitation light, and performs printing machining by scanning the generated UV laser light.

The laser machining apparatus according to JP2019-104047A includes a housing in which a camera is built. This camera is a so-called coaxial camera in which an imaging axis (light receiving axis) is coaxial with an optical axis of the UV laser light. The coaxial camera images a partial region forming a part of a printing region by controlling a galvano scanner as a laser light scanning section.

The captured image obtained by the coaxial camera can be used for position correction of a printing pattern, confirmation of a printing result, and the like.

By the way, in laser printing with UV laser light, in a case where the UV laser light is increased in power, the laser printing can be quickly performed in a wider printing region by the increased power.

In this case, it is advantageous if the position correction of the printing pattern, the confirmation of the printing result, and the like can be performed in a short period of time, but it is not sufficient to cope with a wider printing region only by imaging the partial region by the coaxial camera. If the position correction of the printing pattern, the confirmation of the printing result, and the like are insufficient, desired laser printing cannot be executed, and there is a possibility that printing failure occurs.

### SUMMARY OF THE INVENTION

The present disclosure has been made in view of such a point, and an object thereof is to suppress printing failure in a UV laser marker.

One embodiment of the present disclosure relates to a UV laser marker. According to one embodiment of the present disclosure, the UV laser marker includes: an excitation light generation section configured to generate excitation light; a laser light generation section including a nonlinear optical crystal and configured to generate UV laser light on the basis of the nonlinear optical crystal and the excitation light generated by the excitation light generation section; a coupling section configured to optically couple the excitation light generation section and the laser light generation section; a laser light scanning section configured to two-dimensionally scan the UV laser light generated by the laser light generation section and irradiate a printing object with the UV laser light; a print head configured to incorporate the excitation light generation section, the laser light generation section, the coupling section, and the laser light scanning section; and a printing controller electrically connected to the print head and including a control section configured to control the excitation light generation section, the laser light generation section, and the laser light scanning section, in which the print head includes: an emission window configured to emit UV laser light two-dimensionally scanned by the laser light scanning section to an outside of the print head; and an imaging section having an imaging optical axis independent of a laser optical path of the UV laser light emitted from the emission window and configured to image the printing object via the emission window.

According to one embodiment described above of the present disclosure, the coupling section that optically couples the excitation light generation section and the laser light generation section is incorporated in the print head. This allows the coupling section to be covered by a housing of the print head and to keep it in a desired state. As a result, the excitation light can be appropriately sent from the excitation light generation section to the laser light generation section, which contributes to high power of the UV laser light.

Moreover, according to one embodiment described above of the present disclosure, by the imaging section capturing an image of the printing object, it is possible to support laser printing in a wider printing region. Therefore, even if the UV laser light is increased in power, the position correction of the printing pattern and the confirmation of the printing result can be sufficiently performed, and the printing failure can be suppressed.

Furthermore, according to another embodiment of the present disclosure, the print head may include a housing extending in a predetermined longitudinal direction and configured to accommodate the excitation light generation section, the laser light generation section, the coupling section, and the laser light scanning section, the imaging section may be disposed in a first accommodation space indicating one of two spaces when an internal space of the housing is divided into two at a center portion in the longitudinal direction, and the excitation light generation section may be disposed in a second accommodation space indicating another of the two spaces when the internal space of the housing is divided into two at the center portion in the longitudinal direction.

According to another embodiment described above of the present disclosure, the imaging section and the excitation light generation section are disposed on opposite sides in the longitudinal direction of the housing. With this arrangement, the thermal influence of the excitation light generation section on the imaging section can be suppressed as much as possible. Therefore, it is possible to cause the imaging section to exhibit desired performance, which is advantageous for suppressing printing failure using the imaging section.

Furthermore, according to still another embodiment of the present disclosure, the print head may include a return light suppression measure configured to suppress incidence of return light of UV laser light reflected on a surface of the printing object on the imaging section.

According to still another embodiment described above of the present disclosure, by including the return light suppression measure, it is possible to suppress incidence of UV laser light on the imaging section. This is advantageous for suppressing printing failure using the imaging section.

Furthermore, according to still another embodiment of the present disclosure, the return light suppression measure may be configured by a wavelength selective coating applied to a surface of an imaging lens of the imaging section.

According to still another embodiment described above of the present disclosure, by using the wavelength selective coating for the return light suppression measure, the number of components can be suppressed as compared with a configuration in which a new component is newly installed. This is advantageous for compactness of the print head.

Furthermore, according to still another embodiment of the present disclosure, the print head may include a coaxial camera having an imaging optical axis separated from the laser

optical path between the laser light generation section and the laser light scanning section, and configured to receive image forming light along the imaging optical axis to image the printing object via the laser light scanning section and the emission window, and the coaxial camera may be disposed in the first accommodation space.

According to still another embodiment described above of the present disclosure, the coaxial camera and the excitation light generation section are disposed on the opposite sides in the longitudinal direction of the housing. With this arrangement, the thermal influence of the excitation light generation section on the coaxial camera can be suppressed as much as possible. Therefore, it is possible to cause the coaxial camera to exhibit desired performance, which is advantageous for suppressing printing failure using both the imaging section and the coaxial camera.

Furthermore, according to still another embodiment of the present disclosure, the coupling section may be configured by an optical fiber cable, and the coupling section may be disposed adjacent to the excitation light generation section in the second accommodation space in a state of being wound around a center axis extending in the longitudinal direction.

According to still another embodiment described above of the present disclosure, the optical fiber cable that optically couples the excitation light generation section and the laser light generation section is incorporated in the print head. In general, deflection of the optical fiber cable may lead to inconvenience in stabilizing the output of the UV laser light.

On the other hand, by covering the optical fiber cable with the housing of the print head, it is possible to maintain the optical fiber cable in a desired state without causing deflection of the optical fiber cable. This contributes to an increase in power of the UV laser light.

Moreover, as in still another embodiment described above of the present disclosure, by disposing the optical fiber cable in a state of being wound around the center axis extending in the longitudinal direction, it is possible to suppress an increase in volume of the housing in the longitudinal direction.

Furthermore, according to still another embodiment of the present disclosure, the print head may include: a distance measurement light generation section configured to generate and emit distance measurement light for measuring a distance from the print head to a surface of the printing object; a merging mechanism configured to merge the distance measurement light generated by the distance measurement light generation section with the laser optical path; and a

distance measurement light receiving section configured to receive distance measurement light that merges in the merging mechanism and is two-dimensionally scanned via the laser light scanning section, the distance measurement light being reflected on the surface of the printing object, returned via the laser light scanning section, and separated from the laser optical path by the merging mechanism, the printing controller may include a distance measurement section configured to measure a distance from the print head to the surface of the printing object on a basis of a light receiving position of the distance measurement light received by the distance measurement light receiving section, the distance measurement light generation section and the distance measurement light receiving section may constitute an integrated distance measurement unit, and the distance measurement unit may be disposed in the first accommodation space.

According to still another embodiment described above of the present disclosure, the distance measurement section measures the distance from the print head to the surface of the printing object, so that it is possible to manually or automatically focus the UV laser beam using the measurement result. Therefore, even in a case where workpieces having steps on the upper and lower sides or a plurality of workpieces having different upper and lower heights is set as printing objects, it is possible to suppress printing failure.

Moreover, according to still another embodiment described above of the present disclosure, the distance measurement unit and the excitation light generation section are disposed on opposite sides in the longitudinal direction of the housing. With this arrangement, the thermal influence of the excitation light generation section on the distance measurement unit can be suppressed as much as possible. Therefore, the measurement accuracy of the distance measurement unit can be kept high, which is advantageous for suppressing printing failure using the measurement result.

Furthermore, according to still another embodiment of the present disclosure, the distance measurement unit may include a support base configured to support the distance measurement light generation section and the distance measurement light receiving section, and the distance measurement unit may be disposed in the first accommodation space in an attitude in which the support base is disposed along a height direction orthogonal to the longitudinal direction.

According to still another embodiment described above of the present disclosure, by disposing the distance measurement unit in an attitude in which the support base is disposed

along the height direction, the distance measurement unit can be further separated from the excitation light generation section. It is possible to further suppress the thermal influence of the excitation light generation section on the distance measurement unit. Therefore, the measurement accuracy of the distance measurement unit can be kept high, which is advantageous for suppressing printing failure using the measurement result.

Furthermore, according to still another embodiment of the present disclosure, the print head may include a focus adjustment section disposed in a middle of a laser optical path of the UV laser light generated by the laser light generation section and reaching the laser light scanning section and configured to adjust a focal position of the UV laser light generated by the laser light generation section on the basis of a measurement result of the distance measurement section.

According to still another embodiment described above of the present disclosure, the focus adjustment section automatically adjusts the focal position of the UV laser light. Automatic adjustment of the focal point of the UV laser light contributes to improvement of user convenience.

Furthermore, according to still another embodiment of the present disclosure, the print head may include a heat dissipation heat sink disposed to straddle the first accommodation space and the second accommodation space and extending in the longitudinal direction.

According to still another embodiment described above of the present disclosure, by disposing the heat dissipation heat sink so as to straddle the first accommodation space and the second accommodation space, it is possible to dissipate heat over a wide range inside the print head. This makes it possible to suppress the thermal influence of various components on the imaging section. As a result, it is possible to cause the imaging section to exhibit desired performance, which is advantageous for suppressing printing failure using the imaging result.

Furthermore, according to still another embodiment of the present disclosure, the heat dissipation heat sink may be disposed to be sandwiched between the excitation light generation section and the laser light generation section in a lateral direction orthogonal to the longitudinal direction.

According to still another embodiment described above of the present disclosure, the excitation light generation section and the laser light generation section can be efficiently cooled by the heat dissipation heat sink. Therefore, the thermal influence of the excitation light

generation section and the laser light generation section on the imaging section can be suppressed as much as possible. Therefore, it is possible to cause the imaging section to exhibit desired performance, which is advantageous for suppressing printing failure using the imaging result.

Furthermore, according to still another embodiment of the present disclosure, the UV laser marker may include an air cooling fan configured to air-cool the heat dissipation heat sink.

According to still another embodiment described above of the present disclosure, the heat dissipation heat sink can be cooled by the air cooling fan. Therefore, the thermal influence of the excitation light generation section and the laser light generation section on the imaging section can be suppressed through cooling of the heat dissipation heat sink. As a result, it is possible to cause the imaging section to exhibit desired performance, which is advantageous for suppressing printing failure using the imaging result.

As described above, according to the present disclosure, printing failure in the UV laser marker can be suppressed.

### BRIEF DESCRIPTION OF THE DRAWINGS

FIG. 1 is a diagram illustrating an overall configuration of a laser printing system;

FIG. 2 is a diagram illustrating a schematic configuration of a laser printing apparatus;

FIG. 3 is a block diagram illustrating details of a setting device;

FIG. 4A is a diagram illustrating a schematic configuration of a print head;

FIG. 4B is a diagram illustrating a schematic configuration of a print head;

FIG. 4C is a diagram illustrating a schematic configuration of a print head;

FIG. 5 is a perspective view schematically illustrating an appearance of a print head;

FIG. 6 is a perspective view illustrating an appearance of a print head;

FIG. 7 is a diagram schematically illustrating an internal structure of a print head;

FIG. 8 is a perspective view illustrating an internal structure of a print head;

FIG. 9 is a perspective view illustrating an internal structure of a print head;

FIG. 10 is a perspective view illustrating an internal structure of a print head;

FIG. 11 is a left side view illustrating an internal structure of a print head;

FIG. 12 is a diagram schematically illustrating a configuration of a laser light generation section;

FIG. 13 is a side view illustrating a configuration of a three-dimensional scanning section;

FIG. 14 is a perspective view illustrating a configuration of a laser light scanning section;

FIG. 15 is a perspective view illustrating a configuration of a laser light scanning section;

FIG. 16 is a cross-sectional view illustrating a configuration of a laser light scanning section;

FIG. 17 is a perspective view illustrating a configuration of a printing region inspection section;

FIG. 18 is a perspective view illustrating a configuration of a printing region inspection section;

FIG. 19 is a perspective view illustrating a configuration of a distance measurement unit;

FIG. 20 is a perspective view illustrating a configuration of a distance measurement unit;

FIG. 21 is a transverse cross-sectional view illustrating a calibration optical path;

FIG. 22 is a side view illustrating a configuration of a calibration member and a calibration optical path;

FIG. 23 is a diagram for explaining a triangulation method;

FIG. 24 is a bottom view illustrating first and second heat dissipation heat sinks;

FIG. 25 is a plan view illustrating an example of an air cooling fan;

FIG. 26 is a plan view illustrating first and second heat dissipation heat sinks;

FIG. 27 is a flowchart illustrating a usage procedure of the laser printing system;

FIG. 28 is a flowchart illustrating a procedure of creating a print setting, a search setting, and a distance measurement setting;

FIG. 29 is a diagram illustrating a relationship between a printing region and a setting surface;

FIG. 30 is a diagram illustrating display contents on a display section;

FIG. 31 is a diagram for explaining pattern search;

FIG. 32 is a flowchart illustrating a specific example of XYθ correction and Z correction;

FIG. 33 is a flowchart illustrating a specific example of XYθ correction and Z correction;

FIG. 34 is a diagram for explaining trapezoid correction;

FIG. 35 is a diagram for explaining a temporal change of a distance measurement unit;

FIG. 36 is a diagram for explaining a method of calibrating a distance measurement unit;

FIG. 37 is a flowchart illustrating a calibration procedure of a distance measurement unit; and

FIG. 38 is a diagram corresponding to FIG. 12, illustrating a modification of a laser light generation section.

### DETAILED DESCRIPTION

Hereinafter, embodiments of the present disclosure will be described with reference to the drawings. Note that the following description is an example.

That is, in the present specification, a laser printing apparatus as an example of a UV laser marker will be described, but the present disclosure can be generally applied to laser application equipment such as a “laser marker” or a “laser machining apparatus” capable of executing printing (laser printing) using UV laser light regardless of the names of the UV laser marker and the laser printing apparatus.

Furthermore, in the present specification, marking of characters will be described as a representative example of printing, but “printing” in the present disclosure is not limited to marking of characters. The printing in the present disclosure can be applied to "marking other than characters" such as marking of a figure.

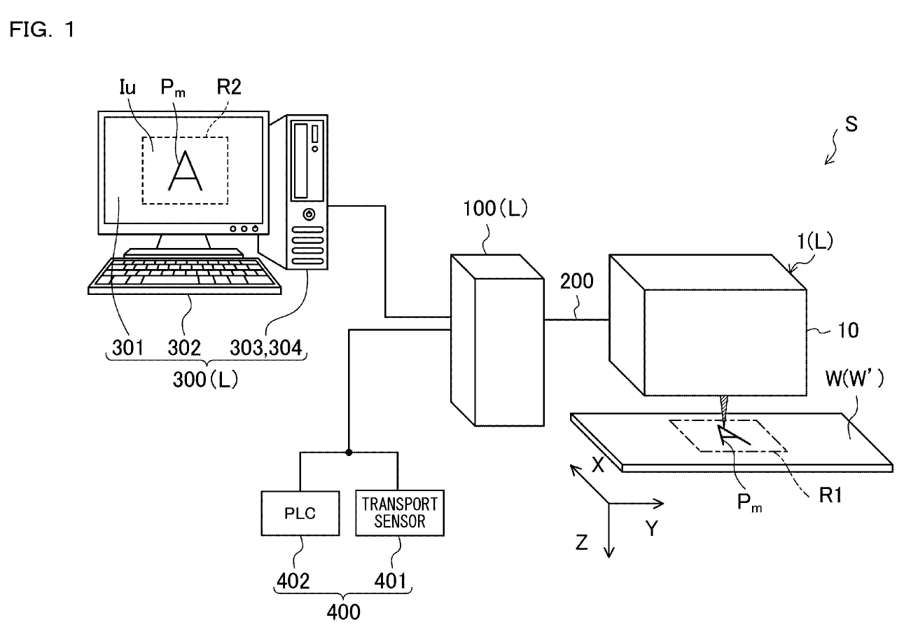

Furthermore, the “marking other than a character” includes marking of a two-dimensional code such as a barcode or a QR code (registered trademark) in addition to marking of a figure such as “:” or “×”. The word of the figure also includes an arbitrary figure such as a symbol in addition to the geometric figure such as "×". Characters and various figures to be marked are hereinafter collectively referred to as a "printing pattern", and a reference sign "Pm" is attached thereto (see FIG. 1).

In the following description, instead of the term "printing", it may be referred to as "laser printing", "marking", or "printing machining" or “machining".

### 1. Overall configuration

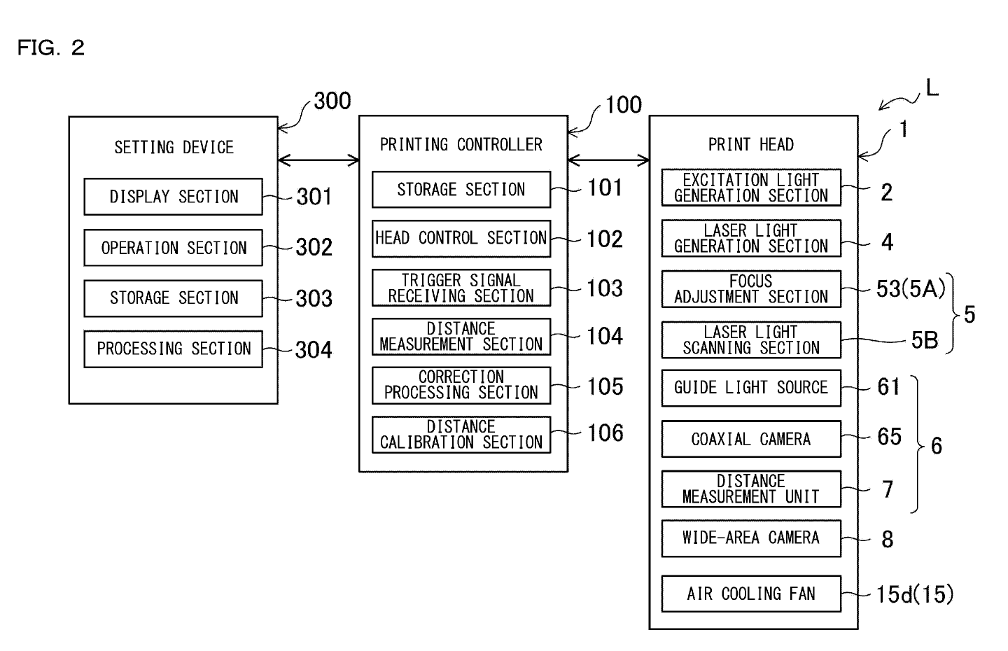

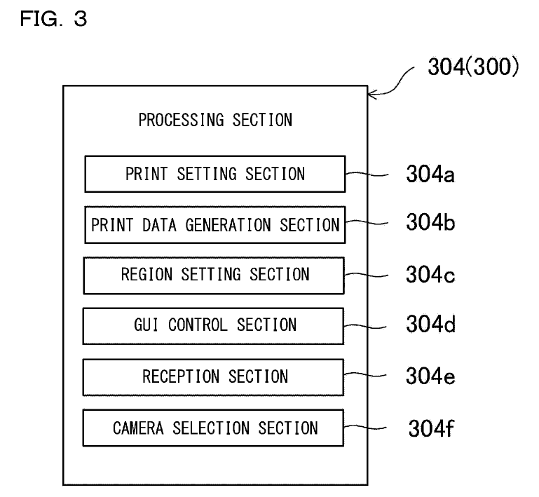

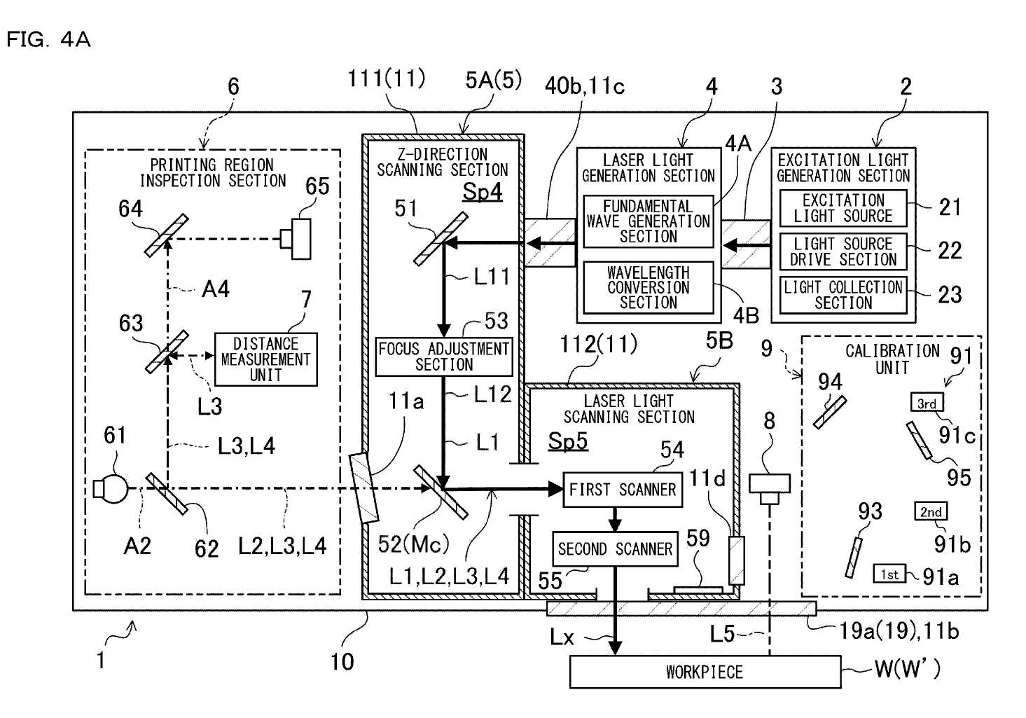

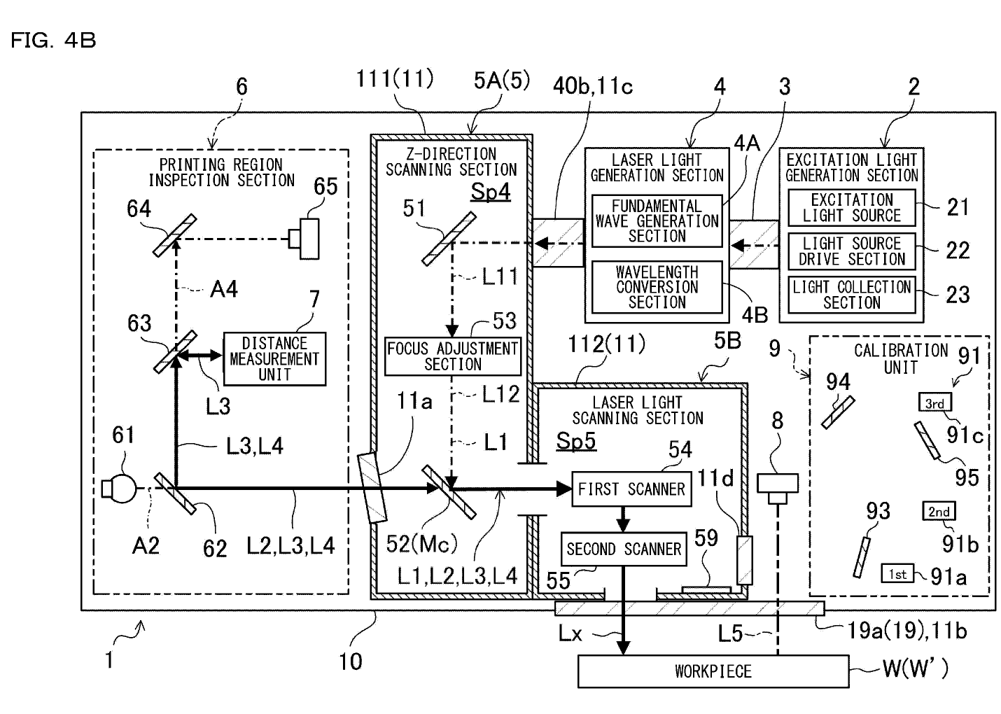

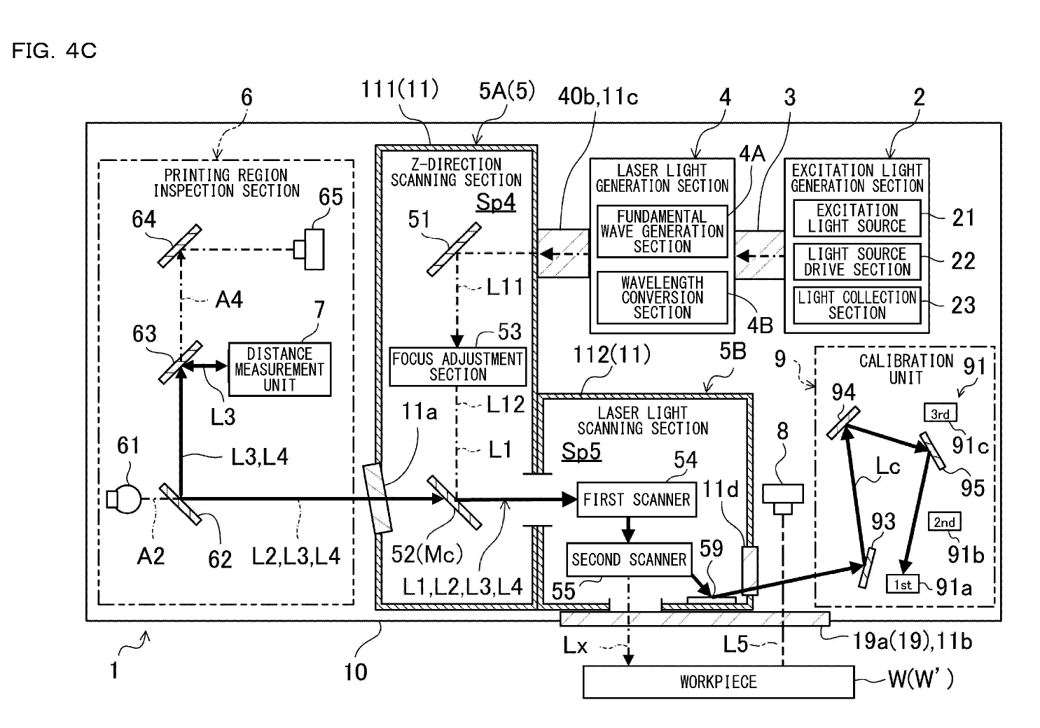

FIG. 1 is a diagram illustrating an overall configuration of a laser printing system S, and FIG. 2 is a diagram illustrating a schematic configuration of a laser printing apparatus L in the laser printing system S. FIG. 3 is a block diagram illustrating details of a setting device 300. FIGS. 4A to 4C are diagrams illustrating a schematic configuration of the print head 1.

As illustrated in FIG. 1, the laser printing system S includes a laser printing apparatus L and external equipment 400 connected to the laser printing apparatus L.

Among these, the laser printing apparatus L illustrated in FIGS. 1 and 2 is configured to print a predetermined printing pattern Pm in a printing region R1 by controlling the excitation light generation section 2, the laser light generation section 4, and the laser light scanning section 5B described later.

Here, the excitation light generation section 2 generates excitation light. The laser light generation section 4 generates UV laser light on the basis of the excitation light. The laser light scanning section 5B two-dimensionally scans the UV laser light generated by the laser light generation section 4 to irradiate the workpiece W with the UV laser light.

Note that, as illustrated in FIG. 1, the printing region R1 herein is a region set on the surface of the workpiece W as a printing object (an object to which printing is to be performed), and corresponds to the setting surface R2 in FIG. 1. The printing region R1 may be set to include the entire one or a plurality of workpieces W, or may be set to include a part of each workpiece W.

For example, in FIG. 1, the printing region R1 is configured as a rectangular region. Furthermore, the setting surface R2 here corresponds to a virtual plane that can be displayed on the display section 301 of the setting device 300. The setting surface R2 is used for various settings related to laser printing as described later.

The laser printing apparatus L irradiates the workpiece W with the laser light generated in the print head 1, and three-dimensionally scans the surface of the workpiece W to perform printing.

Note that the term "three-dimensional scanning" as used herein refers to a concept that refers to a combination of a two-dimensional operation (so-called "two-dimensional scanning") of scanning the irradiation position of the laser light on the surface of the workpiece W and a one-dimensional operation of adjusting the focal position of the laser light. Note that three-dimensional scanning is not essential. The laser printing apparatus L needs only be capable of performing at least two-dimensional scanning.

In particular, the laser printing apparatus L according to the present embodiment can emit, as laser light for printing on the workpiece W, laser light included in a wavelength range of ultraviolet (UV), for example, laser light having a wavelength around 355 nm. In the following description, the laser light for printing on the workpiece W may be referred to as “UV laser light” or “printing laser light” to be distinguished from other laser light. The laser printing apparatus L can pulse-oscillate UV laser light.

Furthermore, the laser printing apparatus L according to the present embodiment can measure the distance to the surface of the workpiece W via the distance measurement unit 7 built in the print head 1 and adjust the focal position using the measurement result. In order to calibrate the measurement result, a calibration unit 9 is also incorporated in the print head 1 of the laser printing apparatus L.

Specifically, as illustrated in FIGS. 1 and 2, the laser printing apparatus L according to the present embodiment includes the print head 1, a printing controller 100, a connection cable 200, and the setting device 300.

The print head 1 can emit UV laser light toward the printing region R1 by being controlled by the printing controller 100. The print head 1 can three-dimensionally scan UV laser light in the printing region R1. The excitation light generation section 2, the laser light generation section 4, and the laser light scanning section 5B are incorporated in the print head 1.

In addition, in order to realize various functions related to laser printing, the print head 1 includes a distance measurement unit 7 that emits and receives distance measurement light, a guide light source 61 that emits guide light for projecting the printing pattern Pm on the workpiece W, a coaxial camera 65 that receives visible light (hereinafter, this is referred to as “image forming light”) for image formation and captures an image, and a wide-area camera 8 that receives image forming light separately from the coaxial camera 65 and captures an image (see FIGS. 2 and 4A to 4C). The wide-area camera 8 is an example of an "imaging section" in the present embodiment.

In addition to the UV laser light, the print head 1 can two-dimensionally scan the guide light emitted from the guide light source 61, the distance measurement light projected and received by the distance measurement unit 7, and the image forming light received by the coaxial camera 65. This two-dimensional scanning is realized by the printing controller 100 operating the laser light scanning section 5B of the print head 1.

In other words, the optical path (laser optical path L1) of the UV laser light merges (is coaxial) with the optical path (guide optical path L2) of the guide light, the optical path (distance measurement optical path L3) of the distance measurement light, and the optical path (imaging optical path L4) of the image forming light related to the coaxial camera 65. Hereinafter, the optical axis of the coaxial optical path may be collectively referred to as a "scanning axis Lx".

On the other hand, the image forming light received by the wide-area camera 8 does not merge into the laser optical path L1. Hereinafter, the optical axis of the optical path of the image forming light related to the wide-area camera 8 may be referred to as a "non-scanning axis L5".

The printing controller 100 is configured as a controller for controlling the print head 1. In addition, the printing controller 100 can store settings related to the printing pattern Pm, for example, various conditions (printing conditions) for printing a desired printing pattern Pm, and can correct the printing conditions. The printing controller 100 is separate from the print head 1 in the present embodiment.

The connection cable 200 electrically connects the print head 1 and the printing controller 100. The connection cable 200 is configured by bundling and covering a cable for transmitting and receiving an electric signal between the print head 1 and the printing controller 100 and a cable for supplying power from the printing controller 100 to the print head 1, for example.

The setting device 300 sets various printing conditions and functions as a terminal for visualizing and displaying information related to laser printing. The setting device 300 includes, for example, a central processing unit (CPU) and a memory, and is connected to the printing controller 100 so as to be able to transmit and receive electric signals in a wired or wireless manner.

Note that, in the present embodiment, the setting device 300 is configured by a personal computer such as a desktop computer or a laptop computer, but the present disclosure is not limited to such a configuration.

The setting device 300 may be configured by, for example, a dedicated terminal connectable to the laser printing apparatus L, such as a touch panel console. Furthermore, the

setting device 300 can also be incorporated in and integrated with the printing controller 100, for example.

The external equipment 400 is connected to the printing controller 100 as necessary. In the example illustrated in FIG. 1, the external equipment 400 includes a conveyance speed sensor 401 and a programmable logic controller (PLC) 402.

The conveyance speed sensor 401 includes, for example, a rotary encoder, and can detect the conveyance speed of the workpiece W. The conveyance speed sensor 401 outputs a signal (detection signal) indicating the detection result to the printing controller 100. The printing controller 100 controls two-dimensional scanning or the like of the UV laser light on the basis of the detection signal input from the conveyance speed sensor 401.

The PLC 402 includes, for example, a microprocessor, and can input a trigger signal to the printing controller 100. The PLC 402 is used to control the laser printing system S according to a predetermined sequence.

Hereinafter, a configuration related to the hardware configuration of each of the setting device 300, the printing controller 100, and the print head 1, a configuration related to data setting transmitted from the setting device 300 to the printing controller 100, and a configuration related to control of the print head 1 by the printing controller 100 based on the data setting will be described in order.

### 2. Setting device 300

As illustrated in FIGS. 1 and 2, the setting device 300 according to the present embodiment includes a display section 301, an operation section 302, a storage section 303, and a processing section 304. The setting device 300 is a terminal operated by the user, and can also be called an “operation terminal”.

### Display section 301

The display section 301 displays information to the user. Specifically, the display section 301 displays information to the user via the display screen. The display section 301 can be configured by a liquid crystal display or an organic EL panel.

Furthermore, the display screen of the display section 301 also functions as a screen for receiving user's input (hereinafter, referred to as "user input") via the operation section 302. Therefore, the display section 301 displays the setting surface R2 corresponding to the printing region R1 as described above. A graphical user interface (GUI) that receives an input of the printing pattern Pm is arranged on the setting surface R2.

Note that the setting device 300 does not necessarily include the display section 301. The display section 301 may be included in the printing controller 100 or the print head 1. For example, in a case where the setting device 300 is incorporated in the printing controller 100 or a touch panel type console is used, a display screen provided in the printing controller 100 or the console can be used as a display section.

### Operation section 302

The operation section 302 receives the user input and inputs an electric signal corresponding to the user input to the CPU or the like. The operation section 302 can be configured by a keyboard and a pointing device. The pointing device includes a mouse, a joystick, and the like.

Note that the setting device 300 does not necessarily include the operation section 302. The operation section 302 may be included in the printing controller 100 or the print head 1. For example, in a case where the setting device 300 is incorporated in the printing controller 100 or a touch panel type console is used, a switch, a button, or the like provided in the printing controller 100 or the console can be used as the operation section.

### Storage section 303

The storage section 303 stores various types of information. The storage section 303 includes a volatile memory such as a random access memory (RAM) and a read-only memory (ROM), and a nonvolatile memory such as a hard disk drive (HDD) and a solid state drive (SSD). The storage section 303 temporarily or continuously stores information that is input by the user via the operation section 302, is set in advance by a manufacturer, or is transmitted and received to and from the printing controller 100 each time.

### Processing section 304

The processing section 304 executes various processing on the basis of the content stored in the storage section 303. The processing section 304 includes one or a plurality of processors (for example, a CPU).

The processing section 304 executes processing corresponding to each function so as to implement each of a plurality of different functions. For example, the processing section 304 can set a printing pattern Pm to be printed on the workpiece W and printing conditions for printing the printing pattern Pm on the basis of a user input. This function is implemented by, for example, a print setting section 304a of the processing section 304.

The printing pattern Pm and the printing conditions set by the processing section 304 are stored in the storage section 303 of the setting device 300, output to the printing controller 100, and stored in a storage section 101 of the printing controller 100. Hereinafter, the combination of the printing pattern Pm and the printing conditions is referred to as “print setting”. The storage section 303 of the setting device 300 may store the print settings as necessary.

### Other constituent elements

In addition, as illustrated in FIG. 3, the processing section 304 according to the present embodiment includes the print setting section 304a, a print data generation section 304b, a region setting section 304c, a GUI control section 304d, a reception section 304e, and a camera selection section 304f. Although described in detail below, these elements perform various processes related to laser printing. Furthermore, some or all of these elements may be configured by the printing controller 100 instead of the setting device 300.

### 3. Printing controller 100

The printing controller 100 is electrically connected to the print head 1. The printing controller 100 includes a head control section 102 for controlling the excitation light generation section 2, the laser light generation section 4, and the laser light scanning section 5B described above. The printing controller 100 is an example of a "controller" in the present embodiment. The head control section 102 is an example of a “control section” in the present embodiment.

Specifically, as illustrated in FIG. 2, the printing controller 100 according to the present embodiment includes a storage section 101 that stores the print setting transmitted from the setting device 300, the head control section 102 that controls the print head 1 on the basis of the print setting, and a trigger signal receiving section 103. Note that the trigger signal receiving section 103 may be included in the setting device 300.

### Storage section 100

The storage section 101 is configured to store the print settings defined by the setting device 300 and output the stored contents to the head control section 102 as necessary.

Specifically, the storage section 101 includes a volatile memory such as a RAM and a ROM, and a nonvolatile memory such as an HDD and an SSD, and can temporarily or continuously store information indicating print settings. Note that, in a case where the setting device 300 is incorporated in the printing controller 100, the storage section 303 of the setting device 300 may also serve as the storage section 101.

### Head control section 102

The head control section 102 executes printing processing on the workpiece W by controlling the excitation light generation section 2, the laser light generation section 4, and the laser light scanning section 5B. The printing processing indicates processing of forming a predetermined printing pattern Pm in the printing region R1.

Specifically, the head control section 102 controls the excitation light generation section 2, the laser light generation section 4, the laser light scanning section 5B, the distance measurement unit 7, and the like on the basis of the print settings stored in the storage section 101. When the head control section 102 performs printing processing, laser printing (printing operation) or the like by the print head 1 is executed.

Specifically, the head control section 102 includes a CPU, a memory, and an input/output bus, and generates a control signal on the basis of a signal indicating information input via the setting device 300 and a signal indicating printing conditions (details will be described later) read from the storage section 101. By outputting the control signal generated in this manner to each section of the laser printing apparatus L, the head control section 102 can control laser printing on the workpiece W, control measurement of the distance to the surface of the workpiece W, and control calibration of the distance measurement unit 7 using the calibration unit 9.

For example, when laser printing of the workpiece W is started, the head control section 102 reads laser power stored in the storage section 101, outputs a control signal generated based on the laser power to the excitation light generation section 2, and controls generation of laser excitation light (excitation light).

Furthermore, the head control section 102 outputs a control signal generated based on the pulse frequency stored in the storage section 101 and a predetermined duty ratio to the Q switch 45 to be described later, and controls the pulse oscillation of the UV laser light. The pulse frequency and the duty ratio are included in the printing conditions described above.

Furthermore, when printing is actually performed on the workpiece W, the head control section 102 reads a printing pattern Pm stored in the storage section 101, for example, and outputs a control signal generated based on the printing pattern Pm to the laser light scanning section 5B to perform two-dimensional scanning with UV laser light. As described above, the head control section 102 can control the laser light scanning section 5B so as to realize the two-dimensional scanning of the laser light.

### Trigger signal receiving section 103

The trigger signal receiving section 103 receives an input of a trigger signal. The trigger signal is a signal that functions as a trigger for causing the head control section 102 to execute printing processing. Specifically, the trigger signal receiving section 103 according to the present embodiment is electrically connected to the PLC 402 and receives the trigger signal output from the PLC 402. When receiving the trigger signal, the trigger signal receiving section 103 inputs an electric signal indicating the reception to the head control section 102. The head control section 102 receives the electrical signal and executes the printing processing.

### Other constituent elements

In addition, as illustrated in FIG. 2, the printing controller 100 according to the present embodiment includes a distance measurement section 104, a correction processing section 105, and a distance calibration section 106. Although described in detail below, these elements perform various processes related to laser printing. Furthermore, some or all of these elements may be configured by the setting device 300 instead of the printing controller 100.

### 4. Print head 1

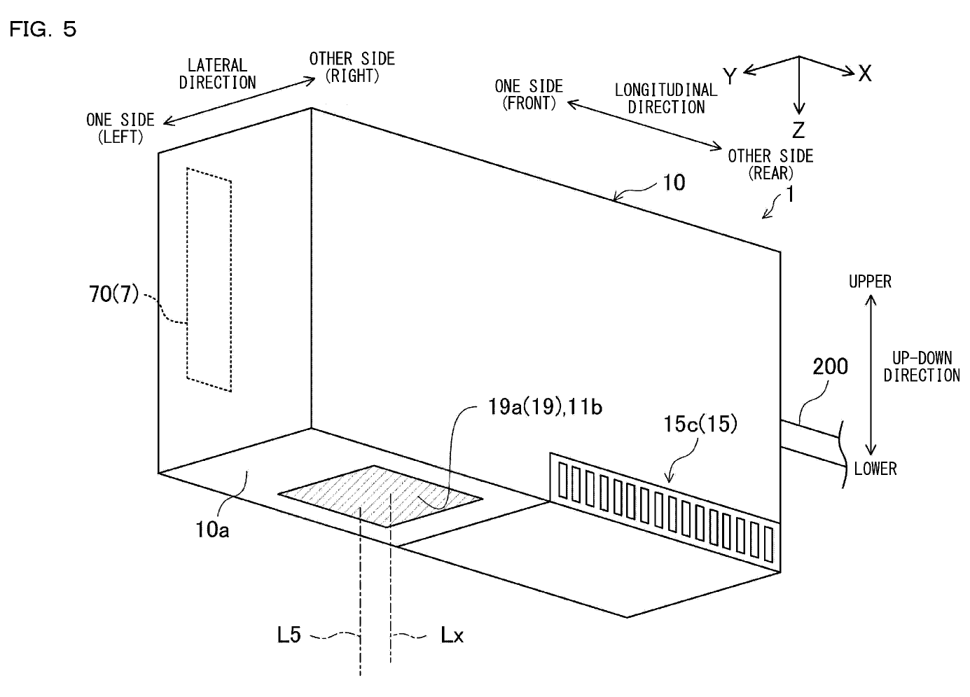

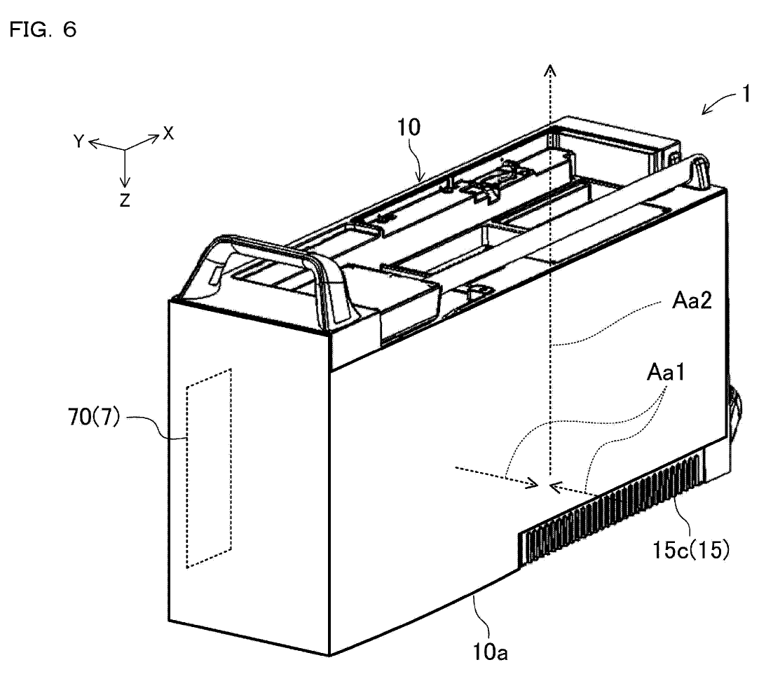

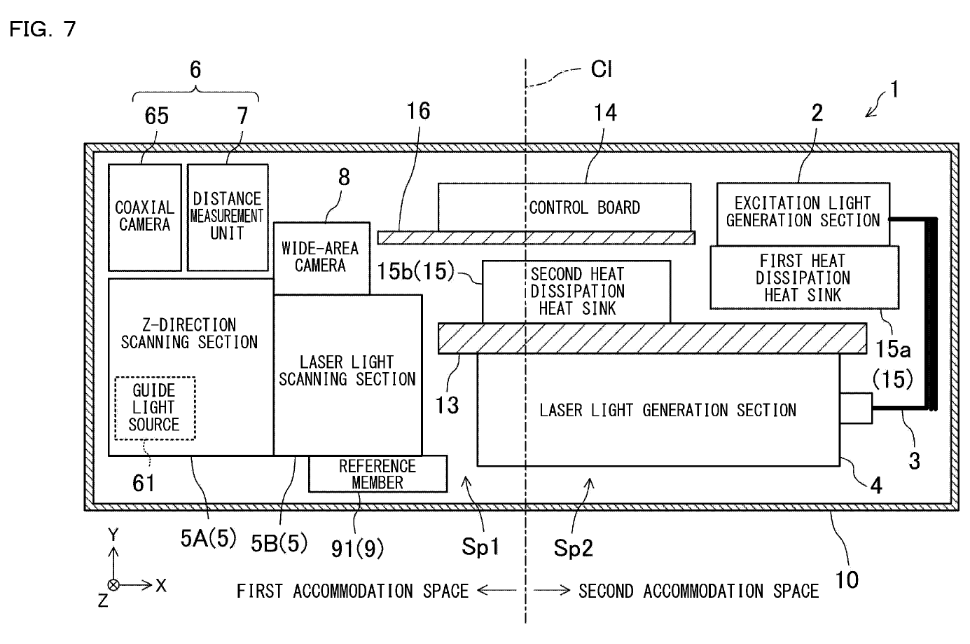

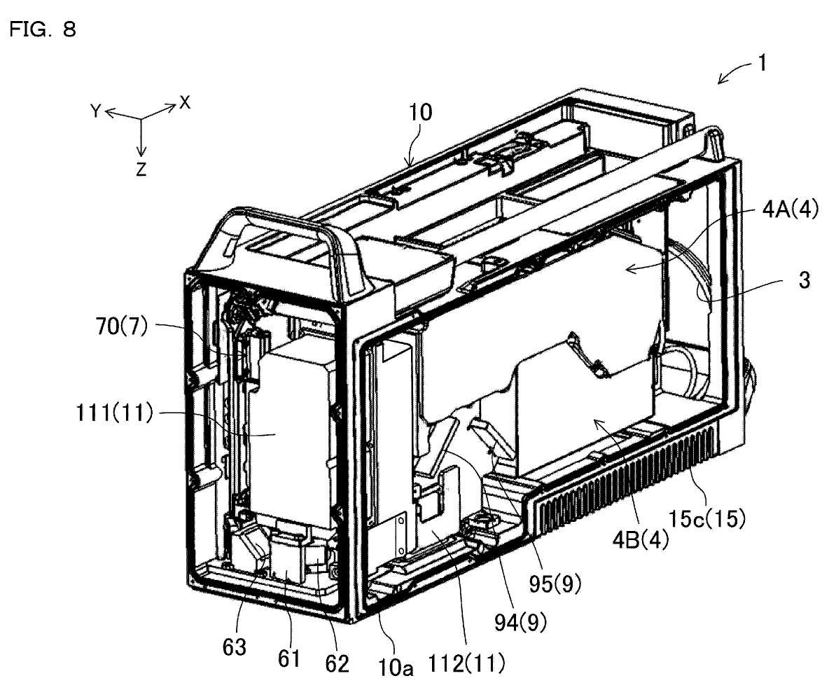

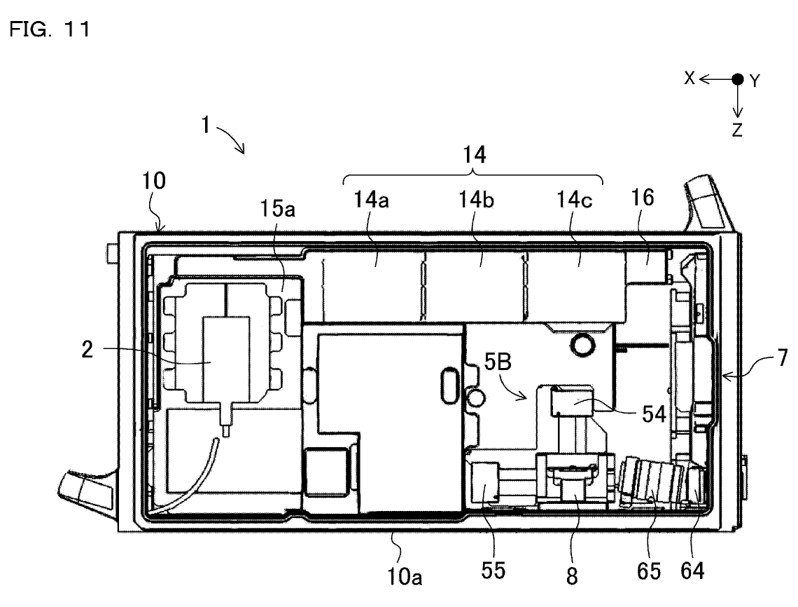

FIGS. 4A, 4B, and 4C are diagrams illustrating a schematic configuration of the print head 1. FIG. 5 is a perspective view schematically illustrating the appearance of the print head 1, and FIG. 6 is a perspective view illustrating the appearance of the print head 1 in detail. FIG. 7 is a diagram schematically illustrating an internal structure of a print head. Furthermore, FIGS. 8, 9, and 10 are perspective views illustrating the internal structure of the print head 1, and FIG. 11 is a left side view illustrating the internal structure of the print head 1.

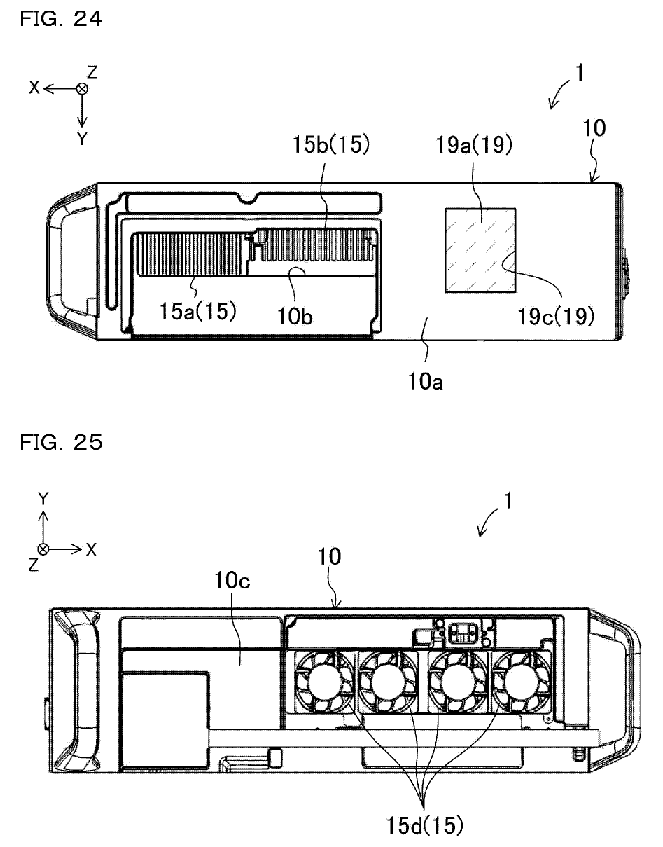

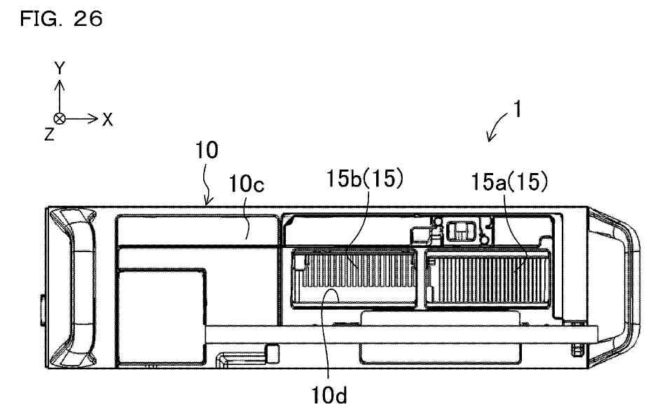

In addition, FIG. 24 is a bottom view illustrating the first and second heat dissipation heat sinks 15a and 15b. FIG. 25 is a plan view illustrating the air cooling fan 15d. FIG. 26 is a plan view illustrating the first and second heat dissipation heat sinks 15a and 15b.

The print head 1 receives a control signal from the printing controller 100, generates UV laser light, and irradiates the workpiece W with the UV laser light. The UV laser light with which the workpiece W is irradiated is three-dimensionally scanned as described above.

Specifically, the print head 1 includes an excitation light generation section 2, a coupling section 3, a laser light generation section 4, a three-dimensional scanning section 5, a printing region inspection section 6, a wide-area camera 8, a calibration unit 9, a housing 10, a sealing section 11, and an air cooling mechanism 15.

As illustrated in FIGS. 4A to 4C, the laser light generation section 4 includes a fundamental wave generation section 4A and a wavelength conversion section 4B. Similarly, as illustrated in FIGS. 4A to 4C, the three-dimensional scanning section 5 includes a Z-direction scanning section 5A including a focus adjustment section 53, and a laser light scanning section 5B including a first scanner 54 and a second scanner 55. The printing region inspection section 6 includes a guide light source 61, a coaxial camera 65, and a distance measurement unit 7.

As illustrated in FIGS. 4A to 4C and the like, the print head 1 includes an excitation light generation section 2, a coupling section 3, a laser light generation section 4, the Z-direction scanning section 5A, a laser light scanning section 5B, a printing region inspection section 6, a wide-area camera 8, a calibration unit 9, and a sealing section 11.

Specifically, the housing 10 of the print head 1 accommodates the excitation light generation section 2, the coupling section 3, the laser light generation section 4, the Z-direction scanning section 5A, the laser light scanning section 5B, the printing region inspection section 6, the wide-area camera 8, the calibration unit 9, and the sealing section 11.

As illustrated in FIGS. 5 and 6, the print head 1 according to the present embodiment extends in a predetermined longitudinal direction (X direction). Specifically, the housing 10 that defines the appearance of the print head 1 has a substantially rectangular outer shape extending in the longitudinal direction.

As illustrated in FIG. 5, the lower surface of the housing 10 is defined by a plate-shaped bottom plate 10a. The emission window 19 is disposed on the bottom plate 10a of the housing 10 (see FIGS. 5 and 24).

The emission window 19 emits UV laser light two-dimensionally scanned by the laser light scanning section 5B to the outside of the print head 1. Specifically, the emission window 19 is formed by fitting a plate-shaped first transparent member 19a capable of transmitting UV laser light and guide light, distance measurement light, and image forming light described later into a through hole 19c penetrating the bottom plate 10a in the plate thickness direction.

As illustrated in FIG. 5, the first transparent member 19a transmits both the scanning axis Lx scanned by the laser light scanning section 5B and the non-scanning axis L5 not scanned by the laser light scanning section 5B. As described above, the scanning axis Lx is configured

such that the laser optical path L1, the guide optical path L2, the imaging optical path L4, and the distance measurement optical path L3 are merged and coaxially disposed.

Other details of the emission window 19 will be described later.

Note that, in the following description, the longitudinal direction of the housing 10 in FIG. 5 may be simply referred to as a “longitudinal direction”, a “front-rear direction”, or an “X direction”, and the lateral direction of the housing 10 in FIG. 5 may be simply referred to as a “lateral direction”, a “left-right direction”, or a “Y direction”. Similarly, the height direction of the housing 10 in FIG. 5 may be simply referred to as “height direction”, “up-down direction”, or “Z direction”.

Furthermore, in the following description, the “longitudinal direction of the housing 10” refers to a depth direction on the paper surface of FIG. 5, a front side on the paper surface of FIG. 5 is referred to as “one side in the longitudinal direction” or “front side (front)”, and a back side on the paper surface of FIG. 5 is referred to as “the other side in the longitudinal direction” or “rear side (rear)”.

Furthermore, in the following description, the “lateral direction of the housing 10” refers to a left and right direction on the paper surface of FIG. 5, the left side on the paper surface of FIG. 5 is referred to as “one side in the lateral direction” or “left side (left)”, and the right side on the paper surface of FIG. 5 is referred to as “the other side in the lateral direction” or “right side (right)”.

Furthermore, in the following description, the “up-down direction of the housing 10” refers to the up-down direction on the paper surface of FIG. 5, and the upper side on the paper surface of FIG. 5 is simply referred to as “upper side (upper)”, and the lower side on the paper surface of FIG. 5 is simply referred to as “lower side (lower)”.

As illustrated in FIG. 7, a base plate 13 having a substantially flat plate shape is accommodated in the housing 10. The base plate 13 is fixed to the housing 10. The base plate 13 extends flat along the ZX plane and partitions the internal space of the housing 10 into one side and the other side in the lateral direction.

Of the internal space of the housing 10, the internal space on one side in the lateral direction with respect to the base plate 13 constitutes an accommodation space for the laser light generation section 4, and the internal space on the other side in the lateral direction with respect to the base plate 13 constitutes an accommodation space for the excitation light generation section 2, a control board 14, and the first heat dissipation heat sink 15a and the second heat dissipation heat sink 15b constituting the air cooling mechanism 15.

Here, the laser light generation section 4 disposed on one side in the lateral direction with respect to the base plate 13 is supported by the base plate 13. The laser light generation section 4 is supported by the housing 10 via the base plate 13.

Furthermore, as illustrated in FIG. 7, a board support plate 16 extending flat along the ZX plane is disposed on the other side in the lateral direction with respect to the base plate 13. The board support plate 16 is accommodated in the housing 10 and fixed to the housing 10. The board support plate 16 further partitions the internal space on the other side in the lateral direction with respect to the base plate 13 in the lateral direction (Y direction).

Here, the control board 14 is disposed on one side (+Y side) in the lateral direction with respect to the board support plate 16. The control board 14 is supported by the board support plate 16. Specifically, the control board 14 is supported by the housing 10 via the board support plate 16.

As illustrated in FIG. 11, the control board 14 includes a first board 14a, a second board 14b, and a third board 14c arranged in this order from the rear side of the housing 10. The first board 14a controls a second scanner 55 described later. The second board 14b controls a first scanner 54 described later. The third board 14c controls a focus adjustment section 53, which will be described later, similarly.

Furthermore, as described later, a first heat dissipation heat sink 15a and a second heat dissipation heat sink 15b are disposed in a space between the base plate 13 and the board support plate 16.

Furthermore, the front end portion of the base plate 13 is spaced apart from the front surface of the housing 10. The Z-direction scanning section 5A and the laser light scanning section 5B as the three-dimensional scanning section 5, a printing region inspection section 6, and a wide-area camera 8 are accommodated between the front end portion of the base plate 13 and the front surface of the housing 10.

Here, when the internal space of the print head 1 and the housing 10 is divided into two at the center portion in the longitudinal direction (see the center line Cl in FIG. 7), one is defined as a first accommodation space Sp1 and the other is defined as a second accommodation space Sp2. The first accommodation space Sp1 is an internal space located on the front side (-X side) with respect to the center line Cl. The second accommodation space Sp2 is an internal space located on the rear side (+X side) with respect to the center line Cl. The second accommodation space Sp2 is located on the opposite side of the first accommodation space Sp1 in the longitudinal direction.

As illustrated in FIG. 7, the Z-direction scanning section 5A, the laser light scanning section 5B, the coaxial camera 65, the distance measurement unit 7, and the wide-area camera 8 are each arranged in the first accommodation space Sp1 in the present embodiment. Furthermore, the excitation light generation section 2, the coupling section 3, and the first heat dissipation heat sink 15a are arranged in the second accommodation space Sp2.

Moreover, the laser light scanning section 5B, the base plate 13, the control board 14, the second heat dissipation heat sink 15b, and the board support plate 16 are disposed so as to straddle the first accommodation space Sp1 and the second accommodation space Sp2.

Hereinafter, configurations of the air cooling mechanism 15, the excitation light generation section 2, the coupling section 3, the laser light generation section 4, the three-dimensional scanning section 5, the sealing section 11, the wide-area camera 8, the printing region inspection section 6, and the calibration unit 9 will be described in order.

### Air cooling mechanism 15

The air cooling mechanism 15 includes an opening 15c and an air cooling fan 15d in addition to the first heat dissipation heat sink 15a and the second heat dissipation heat sink 15b.

### Opening 15c

As illustrated in FIGS. 5 and 6, the opening 15c is disposed on the bottom plate 10a of the housing 10. The opening 15c extends along the XY plane and has a rectangular shape whose dimension in the XY direction is longer than the dimension in the Z direction. The opening 15c has a plurality of openings arranged in the front-rear direction on the left and right side surfaces, and takes in air from the outside through the openings.

Furthermore, as illustrated in FIG. 24, a communication port 10b communicating with the internal space is opened in the bottom plate 10a of the housing 10. The air taken in by the opening 15c is taken into the internal space of the housing 10 through the communication port 10b.

### First heat dissipation heat sink 15a

The first heat dissipation heat sink 15a is thermally coupled to the excitation light generation section 2 and exchanges heat with the excitation light generation section 2. The first heat dissipation heat sink 15a cools the excitation light generation section 2.

The first heat dissipation heat sink 15a is built in the housing 10 and extends in the longitudinal direction of the housing 10. Specifically, the first heat dissipation heat sink 15a has a rectangular shape extending along the ZX plane and having a dimension in the ZX direction longer than a dimension in the Y direction.

As illustrated in FIG. 7, the first heat dissipation heat sink 15a is accommodated in the second accommodation space Sp2 as described above. The first heat dissipation heat sink 15a is also disposed so as to be sandwiched between the excitation light generation section 2 and the laser light generation section 4 in the lateral direction (left-right direction) orthogonal to the longitudinal direction of the housing 10. Specifically, the first heat dissipation heat sink 15a is interposed between the excitation light generation section 2 and the base plate 13 in the left-right direction of the housing 10.

As illustrated in FIG. 7, the first heat dissipation heat sink 15a is disposed side by side with the second heat dissipation heat sink 15b along the front-rear direction. Specifically, the first heat dissipation heat sink 15a is interposed between the second heat dissipation heat sink 15b and the coupling section 3 in the front-rear direction.

The first heat dissipation heat sink 15a is also disposed side by side with the opening 15c along the up-down direction. Specifically, the first heat dissipation heat sink 15a is interposed between the opening 15c and the air cooling fan 15d in the up-down direction.

The first heat dissipation heat sink 15a also includes a plurality of heat dissipation fins arranged in the longitudinal direction. Each of the plurality of fins constituting the first heat dissipation heat sink 15a extends so as to be orthogonal to the longitudinal direction.

### Second heat dissipation heat sink 15b

The second heat dissipation heat sink 15b is thermally coupled to the laser light generation section 4 via the base plate 13, and performs heat exchange with the laser light generation section 4. The second heat dissipation heat sink 15b cools the laser light generation section 4.

The second heat dissipation heat sink 15b is built in the housing 10 and extends in the longitudinal direction of the housing 10. Specifically, the second heat dissipation heat sink 15b has a rectangular shape extending along the ZX plane and having a dimension in the ZX direction longer than a dimension in the Y direction.

As illustrated in FIG. 7, the second heat dissipation heat sink 15b is disposed so as to straddle the first accommodation space Sp1 and the second accommodation space Sp2 as described above. The first heat dissipation heat sink 15a is also disposed so as to be sandwiched between the board support plate 16 and the laser light generation section 4 in the lateral direction (left-right direction) orthogonal to the longitudinal direction of the housing 10. Specifically, the second heat dissipation heat sink 15b is interposed between the board support plate 16 and the base plate 13 in the left-right direction of the housing 10.

As illustrated in FIG. 7, the second heat dissipation heat sink 15b is disposed side by side with the first heat dissipation heat sink 15a along the front-rear direction. Specifically, the second heat dissipation heat sink 15b is interposed between the wide-area camera 8 and the laser light scanning section 5B and the first heat dissipation heat sink 15a in the front-rear direction.

The second heat dissipation heat sink 15b is also disposed side by side with the opening 15c along the up-down direction. Specifically, the second heat dissipation heat sink 15b is interposed between the opening 15c and the air cooling fan 15d in the up-down direction.

The second heat dissipation heat sink 15b also includes a plurality of heat dissipation fins arranged in the longitudinal direction. Each of the plurality of fins constituting the second heat dissipation heat sink 15b extends so as to be orthogonal to the longitudinal direction.

### Air cooling fan 15d

The air cooling fan 15d air-cools the first heat dissipation heat sink 15a and the second heat dissipation heat sink 15b as heat dissipation heat sinks. As illustrated in FIG. 25, the air cooling fan 15d is disposed on the upper surface 10c of the housing 10. More specifically, the air cooling fan 15d includes a plurality of fans arranged along the front-rear direction.

Furthermore, as illustrated in FIG. 26, the communication port 10d is opened in the upper surface 10c of the housing 10, and the first heat dissipation heat sink 15a and the second heat dissipation heat sink 15b are fluidly connected via the communication port 10d.

The air cooling fan 15d is electrically connected to the printing controller 100, and operates upon receiving a control signal from the printing controller 100. The operation of the air cooling fan 15d generates an air flow flowing from the lower side (+Z side) toward the upper side (-Z side) along the up-down direction.

### Regarding air cooling operation

When the air cooling fan 15d operates, air is taken in from the opening 15c. This air is intended to be taken in from the side of the lower end of the print head 1 (see arrow Aa1 in FIG. 6). The air flow constituted by the air enters the internal space of the housing 10 through the communication port 10b opened in the bottom plate 10a of the housing 10. The opening 15c may be open on both side surfaces of the print head 1 or may be open only on one side surface.

The air flow that has entered the internal space of the housing 10 flows upward along the up-down direction (see an arrow Aa2 in FIG. 6). The air flow mainly flows in the space between the base plate 13 and the board support plate 16.

An air flow flowing in the space between the base plate 13 and the board support plate 16 passes through the first heat dissipation heat sink 15a and the second heat dissipation heat sink 15b. Therefore, heat exchange is performed between the air flow and the first heat dissipation heat sink 15a and the second heat dissipation heat sink 15b. The first heat dissipation heat sink 15a and the second heat dissipation heat sink 15b are cooled by this heat exchange. Then, the excitation light generation section 2 is cooled via the first heat dissipation heat sink 15a, and the laser light generation section 4 is cooled via the second heat dissipation heat sink 15b.

Thereafter, the air flow flowing through the space between the base plate 13 and the board support plate 16 flows out from the communication port 10d opened in the upper surface 10c of the housing 10, and is exhausted from the air cooling fan 15d arranged on the upper surface 10c.

The air cooling operation by the air cooling mechanism 15 is performed, for example, at the time of execution of laser printing.

### Excitation light generation section 2

The excitation light generation section 2 generates laser excitation light (excitation light) on the basis of the drive current. Specifically, the excitation light generation section 2 according to the present embodiment includes an excitation light source 21, a light source drive section 22, and a light collection section 23. The excitation light source 21 and the light collection section 23 are fixed in an excitation casing (not illustrated) and are optically coupled.

The light source drive section 22 supplies a drive current to the excitation light source 21. Specifically, the light source drive section 22 supplies a drive current to the excitation light source 21 on the basis of a control signal output from the head control section 102. More specifically, the light source drive section 22 determines a drive current on the basis of the target output (laser power) of the UV laser, and supplies the determined drive current to the excitation light source 21.

The excitation light source 21 oscillates a laser light according to the drive current. Specifically, the excitation light source 21 is supplied with a drive current from the light source drive section 22 and oscillates a laser light according to the drive current. The excitation light source 21 can be formed of, for example, a laser diode (LD). In a case where the excitation light source 21 is configured by an LD, a single LD element can be used, or an LD array in which a plurality of LD elements are linearly arranged, an LD bar, or the like can be used. In a case where an LD array or an LD bar is used as the excitation light source 21, the laser light oscillated from each element is output in a line and enters the light collection section 23.

The light collection section 23 collects the laser light output from the excitation light source 21 and outputs the laser light as excitation light. Specifically, the light collection section 23 is optically coupled to the excitation light source 21, and collects the laser light oscillated by the excitation light source 21 and outputs the laser light as excitation light. The light collection section 23 is configured by, for example, a focusing lens, and includes an incident surface on which laser light is incident and an emission surface that outputs excitation light.

Furthermore, the light collection section 23 is optically coupled to the laser light generation section 4 via the coupling section 3. Therefore, the excitation light output from the light collection section 23 is guided to the laser light generation section 4 via the coupling section 3.

### Coupling section 3

As illustrated in FIGS. 4A to 4C and 7, the coupling section 3 optically couples the excitation light generation section 2 and the laser light generation section 4. One end portion of the coupling section 3 is connected to the light collection section 23 of the excitation light generation section 2. The other end portion of the coupling section 3 located on the opposite side of the one end portion is connected to an incident section 41 of the laser light generation section 4.

Furthermore, the coupling section 3 is disposed adjacent to the excitation light generation section 2 in the second accommodation space Sp2. Specifically, the coupling section 3 is adjacent to the rear side (+X side) of the excitation light generation section 2 and the laser light generation section 4. More specifically, the coupling section 3 is disposed at the rear end of the internal space of the housing 10.

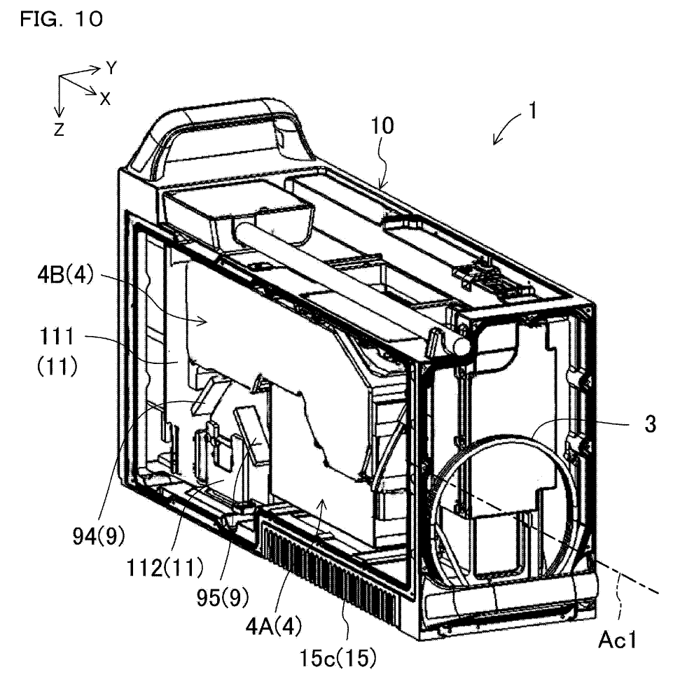

Furthermore, the coupling section 3 according to the present embodiment is configured by an optical fiber cable. The coupling section 3 constituted by the optical fiber cable is wound around a central axis Ac1 extending in the longitudinal direction (X direction) of the housing 10 in the internal space of the housing 10 (see FIG. 10). The coupling section 3 is wound so as to have a desired bending radius.

Furthermore, as illustrated in FIG. 10, the coupling section 3 wound around the central axis Ac1 extending in the X direction has a flat annular shape along the YZ plane.

### Laser light generation section 4

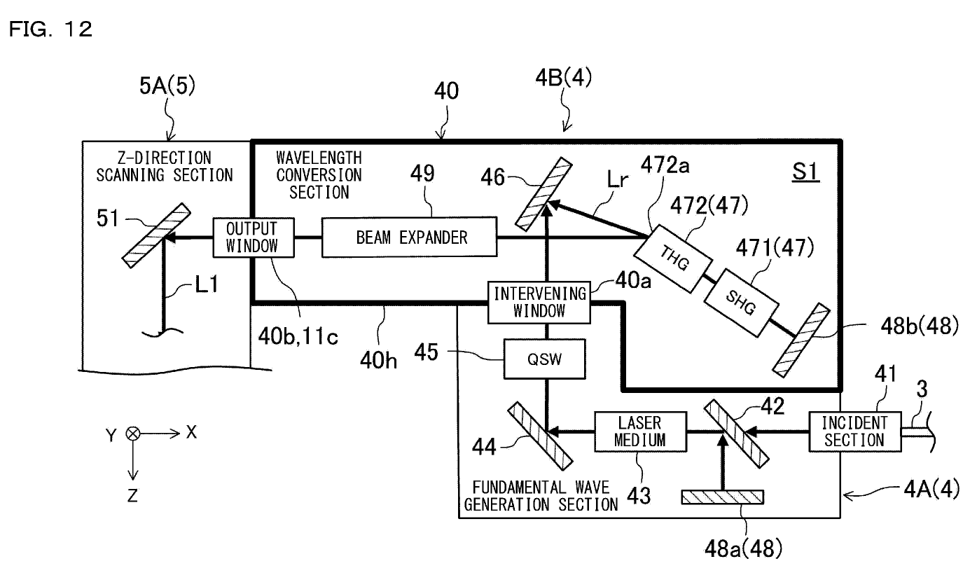

FIG. 12 is a diagram schematically illustrating an internal structure of the laser light generation section 4.

### Overall configuration

The laser light generation section 4 includes a nonlinear optical crystal 47. The laser light generation section 4 generates UV laser light based on the nonlinear optical crystal 47 and the excitation light generated by the excitation light generation section 2.

Specifically, the laser light generation section 4 includes a fundamental wave generation section 4A that generates a fundamental wave on the basis of the excitation light, and a wavelength conversion section 4B that hermetically seals the nonlinear optical crystal 47 and generates UV laser light on the basis of the nonlinear optical crystal 47 and the fundamental wave.

Specifically, the fundamental wave generation section 4A includes the incident section 41, a first optical member 42, a laser medium 43, a second optical member 44, a Q switch 45, and a first resonance member 48a indicating one of the pair of resonance members 48.

On the other hand, the wavelength conversion section 4B includes a third optical member 46, a first wavelength conversion element 471 and a second wavelength conversion element 472 as the nonlinear optical crystal 47, a second resonance member 48b indicating the other of the pair of resonance members 48, and a crystal sealing section 40.

Note that the inclusion of the crystal sealing section 40 in the wavelength conversion section 4B is merely a classification for convenience. The crystal sealing section 40 may be regarded as an element independent of the fundamental wave generation section 4A and the wavelength conversion section 4B.

### Pair of resonance members 48

The fundamental wave generation section 4A is optically coupled to the wavelength conversion section 4B sealed by the crystal sealing section 40. Using the optical coupling, the fundamental wave generation section 4A and the wavelength conversion section 4B constitute a resonator for resonating the laser light.

Specifically, the resonator includes a pair of resonance members 48 and a Q switch 45. The pair of resonance members 48 forms a resonance optical path Lr that reciprocates the fundamental wave (fundamental laser light) generated by the laser medium 43.

Specifically, the pair of resonance members 48 includes a first resonance member 48a accommodated in the fundamental wave generation section 4A and a second resonance member 48b accommodated in the wavelength conversion section 4B. Each of the first resonance member 48a and the second resonance member 48b is constituted by a mirror capable of reflecting laser light. A resonance optical path Lr that resonates the laser light is formed between the first resonance member 48a and the second resonance member 48b. The laser light forms a standing wave connecting the fundamental wave generation section 4A and the wavelength conversion section 4B on the resonance optical path Lr.

That is, the names of the fundamental wave generation section 4A and the wavelength conversion section 4B are merely names given to clarify the functions of the respective sections, and the fundamental wave generation section 4A and the wavelength conversion section 4B may be regarded as constituting one laser oscillator.

Furthermore, as illustrated in FIG. 12, in the present embodiment, the first wavelength conversion element 471 as SHG and the second wavelength conversion element 472 as THG are disposed in the middle of the resonance optical path Lr formed by the pair of resonance members 48. That is, the fundamental wave generation section 4A and the wavelength conversion section 4B according to the present embodiment constitute an intracavity resonator.

### Incident section 41

The incident section 41 is optically coupled to the excitation light generation section 2, particularly, the light collection section 23 via the coupling section 3. The excitation light generated by the excitation light generation section 2 is incident on the incident section 41 via the coupling section 3. The incident section 41 guides the excitation light incident on the incident section 41 to the first optical member 42.

### First optical member 42

The first optical member 42 forms the resonance optical path Lr by optically coupling the first resonance member 48a and the second resonance member 48b. Specifically, the first optical member 42 is optically coupled to the first resonance member 48a, and is optically coupled to the second resonance member 48b via the second optical member 44, an intervening window 40a, and the third optical member 46. For example, the first optical member 42 is constructed with a mirror that totally reflects the laser light.

Furthermore, the first optical member 42 is configured to merge the excitation light generated by the excitation light generation section 2 and incident on the incident section 41 into the resonance optical path Lr. The first optical member 42 includes, for example, a half mirror.

Specifically, the first optical member 42 transmits the excitation light incident on the incident section 41 and guides the excitation light to the laser medium 43. The excitation light guided to the laser medium 43 merges with the resonance optical path Lr and propagates.

The first optical member 42 also bends, toward the first resonance member 48a, the laser light that passes through the laser medium 43, the second optical member 44, and the Q switch 45 to reach the wavelength conversion section 4B, and then is reflected and returned by the second resonance member 48b. The first optical member 42 is also configured to guide the laser light reflected and returned by the first resonance member 48a to the laser medium 43 again.

Note that the first optical member 42 is not essential. As illustrated in a modification described later, the first optical member 42 can be omitted depending on the layout of each optical component in the fundamental wave generation section 4A.

### Laser medium 43

The laser medium 43 generates a fundamental wave (fundamental laser light) on the basis of the excitation light generated by the excitation light generation section 2. Specifically, the laser medium 43 is disposed on the resonance optical path Lr, and is configured to generate the fundamental wave by performing stimulated emission corresponding to the excitation light. Note that the term "fundamental wave" as used herein refers to laser light having a fundamental wavelength. The fundamental wave can be rephrased as "fundamental laser light".

More specifically, the laser medium 43 is a laser medium capable of forming an inverted distribution, and is configured to perform stimulated emission corresponding to the incident excitation light when the excitation light is incident on the medium. The wavelength (so-called fundamental wavelength) of photons emitted by stimulated emission increases or decreases according to the configuration of the laser medium 43, but is in the infrared range of about 1 μm in this example. That is, the fundamental wave according to the present embodiment is near-infrared laser light (NIR laser light).

As an example, the laser medium 43 according to the present embodiment includes rod-shaped Nd: YVO₄ (yttrium vanadate). The excitation light is incident from one end face of the rod-shaped laser medium 43, and a fundamental wave having a fundamental wavelength is emitted from the other end face (so-called one direction excitation system by end pumping).

In this example, the fundamental wavelength is set to 1064 nm in the infrared range as described above. On the other hand, the wavelength of the excitation light is set near the center wavelength of the absorption spectrum of Nd: YVO₄ in order to promote stimulated emission. However, the present invention is not limited to this example, and for example, rare earth-doped YAG, YLF, GdVO₄, or the like can be used as another laser medium. Various solid laser media can be used according to the application of the laser printing apparatus L.

Furthermore, a wavelength conversion element can be combined with the solid laser medium to convert the wavelength of the output laser light into an arbitrary wavelength. In this case, unlike FIG. 12, the laser medium 43 may be accommodated in the wavelength conversion section 4B.

Furthermore, the fundamental wave generation section 4A can also use, as an excitation system using the solid-state laser medium, a bidirectional excitation system in which excitation light is emitted from each end surface before and after the solid-state laser medium, instead of the above-described unidirectional excitation system.

### Second optical member 44

The second optical member 44 forms the resonance optical path Lr by optically coupling the first resonance member 48a and the second resonance member 48b. Specifically, the second optical member 44 is optically coupled to the first resonance member 48a via the first optical member 42, and is optically coupled to the second resonance member 48b via the intervening window 40a and the third optical member 46. For example, the second optical member 44 is constructed with a mirror that totally reflects the laser light.

Specifically, the second optical member 44 reflects the fundamental wave emitted from the laser medium 43 and the laser light having another wavelength that has passed through the laser medium 43, and guides the fundamental wave and the laser light to the Q switch 45. The laser light (including the fundamental wave) guided to the Q switch 45 sequentially passes through the Q switch 45 and the intervening window 40a to be described later, and then reaches the third optical member 46 of the wavelength conversion section 4B.

The second optical member 44 also bends the laser light reflected by the second resonance member 48b and returned toward the laser medium 43 after passing through the Q switch 45 and reaching the wavelength conversion section 4B. The first optical member 42 is also configured to guide the laser light reflected and returned by the first resonance member 48a to the laser medium 43 again.

Note that the second optical member 44 is not essential. As illustrated in a modification described later, the second optical member 44 can be omitted depending on the layout of each optical component in the fundamental wave generation section 4A.

### Q switch 45

The Q switch 45 is disposed on the resonance optical path Lr. The Q switch 45 is switched between an on state in which pulse oscillation of the fundamental wave generated by the laser medium 43 is suppressed and an off state in which the pulse oscillation is allowed on the basis of power supplied from the outside (RF signal to be described later).

In other words, the Q switch 45 is configured to cause the fundamental wave (fundamental laser light) generated by the laser medium 43 to perform pulse oscillation. Specifically, the Q switch 45 is disposed so as to be located on the optical axis of the resonance optical path Lr, and is interposed between the laser medium 43 and the nonlinear optical crystal 47, specifically, between the intervening window 40a and the second optical member 44 in the fundamental wave generation section 4A.

The Q switch 45 can change the continuous oscillation to high-speed repetitive pulse oscillation having a high peak output value (peak value). In other words, the Q switch 45 can convert a continuous wave (CW) laser into a pulsed laser and output the pulsed laser.

Furthermore, a Q switch control circuit that generates an RF signal to be applied to the Q switch 45 is connected to the Q switch. Although not illustrated, the Q switch control circuit is accommodated in the housing 10.

The laser light generation section 4 amplifies laser light composed of photons stimulated and emitted from the laser medium 43 by multiple reflection between the first resonance member 48a and the second resonance member 48b, and outputs the amplified laser light as UV laser light through the nonlinear optical crystal 47.

That is, when the Q switch 45 is temporarily turned on, the laser light incident on the Q switch 45 is deflected and separated from the resonance optical path Lr. In this case, as a result of multiple reflection of the laser light being restricted, generation of an inverted distribution in the laser medium 43 is promoted.

Then, when the Q switch 45 is switched to the off state after being turned on for a predetermined period, the laser light is amplified by multiple reflection. In this case, the high-output laser light is pulse-oscillated. In this way, by periodically switching on and off of the Q switch 45, it is possible to perform the high-speed repetitive pulse oscillation as described above.

In this way, by periodically switching on and off of the Q switch 45, it is possible to perform the high-speed repetitive pulse oscillation as described above. Examples of the control amount for controlling such pulse oscillation include a duty ratio related to a ratio between a period (on time) in which the Q switch 45 is turned on and a period (off time) in which the Q switch is turned off. When the duty ratio is large, the period during which the Q switch 45 is turned on becomes longer than when the duty ratio is small. In this case, the generation of the inverted distribution is promoted, and the output value (for example, pulse energy of laser light) of the pulse oscillation increases. Furthermore, another control amount for controlling the pulse oscillation includes a Q switch frequency indicating a frequency at which the Q switch repeats on and off. By increasing the Q switch frequency, the number of pulse oscillations emitted per unit time increases.

### Third optical member 46

The third optical member 46 forms the resonance optical path Lr by optically coupling the first resonance member 48a and the second resonance member 48b. Specifically, the third optical member 46 is optically coupled to the first resonance member 48a via the first optical member 42, the second optical member 44, and the intervening window 40a, and is also optically coupled to the second resonance member 48b. For example, the third optical member 46 is constructed with a mirror that totally reflects the laser light.

Specifically, the third optical member 46 reflects the laser light (including the fundamental wave) transmitted through the intervening window 40a and guides the laser light to the second resonance member 48b. The laser light (including the fundamental wave) guided to the second resonance member 48b is totally reflected by the second resonance member 48b, then propagates along the resonance optical path Lr, and returns to the first resonance member 48a via the third optical member 46 and the like.

Note that the third optical member 46 is not essential. The third optical member 46 can be omitted depending on the layout of each optical component in the wavelength conversion section 4B.

### Nonlinear optical crystal 47

The nonlinear optical crystal 47 is disposed on the resonance optical path Lr. The nonlinear optical crystal 47 generates UV laser light on the basis of the fundamental wave generated by the laser medium 43.

Specifically, the nonlinear optical crystal 47 is accommodated in the crystal sealing section 40 of the wavelength conversion section 4B. The nonlinear optical crystal 47 is hermetically sealed by the crystal sealing section 40. More specifically, the nonlinear optical crystal 47 is disposed on the resonance optical path Lr connecting the third optical member 46 and the second resonance member 48b in the wavelength conversion section 4B.

The nonlinear optical crystal 47 includes a first wavelength conversion element 471 and a second wavelength conversion element 472. The first wavelength conversion element 471 and the second wavelength conversion element 472 are disposed in order along a direction from the second resonance member 48b toward the third optical member 46.

### First wavelength conversion element 471

The first wavelength conversion element 471 includes a nonlinear optical crystal capable of generating the second harmonic. When the fundamental wave is incident, the first wavelength conversion element 471 doubles the frequency of the fundamental wave and emits the fundamental wave as a second harmonic (second harmonic generation: SHG). That is, the wavelength of the laser light generated when the fundamental wave is incident on the first wavelength conversion element 471 is in the visible light region of around 500 nm. In particular, in the present embodiment, the wavelength of the second harmonic is set to 532 nm.

In general, the conversion efficiency of the fundamental wave by the first wavelength conversion element 471 is less than 100%. Therefore, at least a part of the fundamental wave incident on the first wavelength conversion element 471 is emitted without being converted by the first wavelength conversion element 471. Therefore, when the fundamental wave is incident on the first wavelength conversion element 471, laser light including the fundamental wave and the second harmonic is emitted.

Note that, in this embodiment, LBO (LiB₃O₃) is used as the first wavelength conversion element 471. However, the present invention is not limited to this example, and KTP (KTiPO4), an organic nonlinear optical material, or another inorganic nonlinear optical material such as KN(KNbO₃), KAP (KAsPO₄), BBO (β-BaB₂O₄), or LBO (LiB₃O₅), or a bulk-type polarization reversal element (LiNbO₃ (periodically polled lithium niobate: PPLN), LiTaO₃, and the like) may be used as the first wavelength conversion element 471. Thus, in the present embodiment, various types of optical materials can be utilized.

### Second wavelength conversion element 472

The second wavelength conversion element 472 includes a nonlinear optical crystal capable of generating the third harmonic. When the fundamental wave and the second harmonic are incident (in particular, when the propagation directions of the fundamental wave and the second harmonic are equal to each other), the second wavelength conversion element 472 is configured to convert the fundamental wave and the second harmonic into a third harmonic having a frequency three times the frequency of the fundamental wave and emit the third harmonic (third harmonic generation: THG). That is, the wavelength of the laser light generated when the fundamental wave and the second harmonic are made incident on the second wavelength conversion element 472 is in the ultraviolet region (specifically, in the vicinity of the boundary between the visible light region and the ultraviolet region) of around 350 nm. In particular, in the present embodiment, the wavelength of the third harmonic is set to 355 nm.

Note that, in this embodiment, LBO (LiB₃O₃) is used as the second wavelength conversion element 472. However, the present invention is not limited to this example, and various types of optical materials such as KTP (KTiPO₄), an organic nonlinear optical material, and other inorganic nonlinear optical materials can be used as the second wavelength conversion element 472.

Furthermore, in general, the conversion efficiency of the fundamental wave by the second wavelength conversion element 472 is less than 100%. Therefore, at least a part of each of the fundamental wave and the second harmonic incident on the second wavelength conversion element 472 is emitted without being converted by the second wavelength conversion element 472. Therefore, when the fundamental wave and the second harmonic are incident on the second wavelength conversion element 472, laser light in which the fundamental wave, the second harmonic, and the third harmonic are mixed is emitted.

In order to extract the third harmonic from the laser light, the end surface 472a of the second wavelength conversion element 472 is slightly inclined with respect to the resonance optical path Lr. Such inclination makes it possible to extract the third harmonic from the laser light using refraction on the interface between substances and output the third harmonic as UV laser light.

Note that, when the third harmonic is extracted from the laser light, it is not essential to use the refraction described above. The third harmonic may be extracted from the laser light by disposing a beam splitter that reflects or transmits the third harmonic on the resonance optical path Lr.

### Beam expander 49

A beam expander 49 includes a plurality of optical lenses, and is configured to allow the third harmonic (UV laser light) emitted from the second wavelength conversion element 472 to enter and adjust the beam diameter of the UV laser light so as to be suitable for entering the focus adjustment section 53 described later. Note that, in a case where it is not necessary to increase the beam diameter of the UV laser light, the beam expander 49 can be omitted.

### Crystal sealing section 40

The crystal sealing section 40 constitutes a sealed chamber Sp3 that hermetically seals the nonlinear optical crystal 47. The crystal sealing section 40 also emits the UV laser light generated by the wavelength conversion section 4B to the outside of the sealed chamber Sp3.

Specifically, the crystal sealing section 40 according to the present embodiment includes a housing 40h, the intervening window 40a, and the emission window 40b.

The housing 40h surrounds the third optical member 46, the nonlinear optical crystal 47, the second resonance member 48b, and the beam expander 49 constituting the wavelength conversion section 4B from six directions of the front-rear direction, the up-down direction, and the left-right direction. The sealed chamber Sp3 that hermetically seals each part surrounded by the housing 40h is formed inside the housing 40h. The sealed chamber Sp3 is sealed from another space in the housing 10 by a member such as a sealing material.

The intervening window 40a optically couples the fundamental wave generation section 4A and the wavelength conversion section 4B. For example, the intervening window 40a transmits the laser light having passed through the Q switch 45. The intervening window 40a is provided, for example, in a wall portion surrounding the wavelength conversion section 4B in the housing 40h. The intervening window 40a can be configured, for example, by fitting a transparent member having translucency into a through hole formed in the wall portion.

As illustrated in FIG. 12, the intervening window 40a according to the present embodiment is disposed between the Q switch 45 of the fundamental wave generation section 4A and the third optical member 46 of the wavelength conversion section 4B. The fundamental wave generation section 4A and the wavelength conversion section 4B are optically coupled by the intervening window 40a disposed as described above (see also FIG. 3).

The output window 40b transmits the UV laser light generated by the wavelength conversion section 4B. The output window 40b is provided, for example, on a wall portion surrounding the wavelength conversion section 4B in the housing 40h. The output window 40b can be configured by, for example, fitting a transparent member having translucency into a through hole formed in the wall portion.

As illustrated in FIG. 12, the output window 40b according to the present embodiment is disposed between the beam expander 49 of the wavelength conversion section 4B and the fourth optical member 51 of the Z-direction scanning section 5A. The wavelength conversion section 4B and the Z-direction scanning section 5A are optically coupled by the output window 40b (see also FIGS. 4A to 4C).

### Regarding resonance

As illustrated in FIGS. 4A to 4C and 12, the excitation light having entered the fundamental wave generation section 4A from the excitation light generation section 2 via the coupler 3 passes through the first optical member 42 and enters the one end surface of the laser medium 43 in the fundamental wave generation section 4A. Then, the fundamental wave (fundamental laser light) emitted on the basis of the excitation light is reflected by the second optical member 44, then passes through the intervening window 40a, and enters the wavelength conversion section 4B.

Subsequently, the fundamental wave incident on the wavelength conversion section 4B is reflected by the third optical member 46, passes through the second wavelength conversion element 472, and is incident on the first wavelength conversion element 471. In the first wavelength conversion element 471, a part of the fundamental wave is converted into the second harmonic. Therefore, the first wavelength conversion element 471 emits laser light in which the fundamental wave and the second harmonic are mixed. The laser light is totally reflected by the second resonance member 48b and follows the optical path up to this point in the reverse direction.

Then, the laser light that has entered the first wavelength conversion element 471 again enters the second wavelength conversion element 472 after the second harmonic is generated again in the first wavelength conversion element 471. In the second wavelength conversion element 472, a part of the fundamental wave and the second harmonic is converted into the third harmonic. Therefore, the second wavelength conversion element 472 emits laser light in which the fundamental wave, the second harmonic, and the third harmonic are mixed. When the laser light is emitted from the end surface 472a of the second wavelength conversion element 472, the second and third harmonics are largely refracted and separated from the resonance optical path Lr as compared with the fundamental wave, and the fundamental wave is reflected again by the third optical member 46 to reach the intervening window 40a.

Here, the third harmonic separated from the resonance optical path Lr and guided to the beam expander 49 is emitted as UV laser light via the output window 40b after the beam diameter thereof is adjusted.

On the other hand, the other laser light reflected again by the third optical member 46 passes through the intervening window 40a and then reaches the Q switch 45. The fundamental wave guided to the Q switch 45 is deflected and separated from the resonance optical path Lr when the Q switch 45 is in the on state. As described above, in this case, a continuous wave (CW) having an output of zero or an extremely low output oscillates.

On the other hand, when the Q switch 45 is in the off state, the light passes through the Q switch 45 and then reaches the first resonance member 48a via the second optical member 44 and the first optical member 42. The fundamental wave reflected by the first resonance member 48a is reflected by the first optical member 42 and is incident on the laser medium 43. The fundamental wave incident on the laser medium 43 is incident on the wavelength conversion section 4B again via the second optical member 44 and the like.

By repeating such a process, the fundamental wave is multiple-reflected between the first resonance member 48a and the second resonance member 48b, and as a result, the laser light is amplified, and the high-output UV laser light intermittently performs pulse oscillation in combination with the on/off control of the Q switch 45.

### Z-direction scanning section 5A

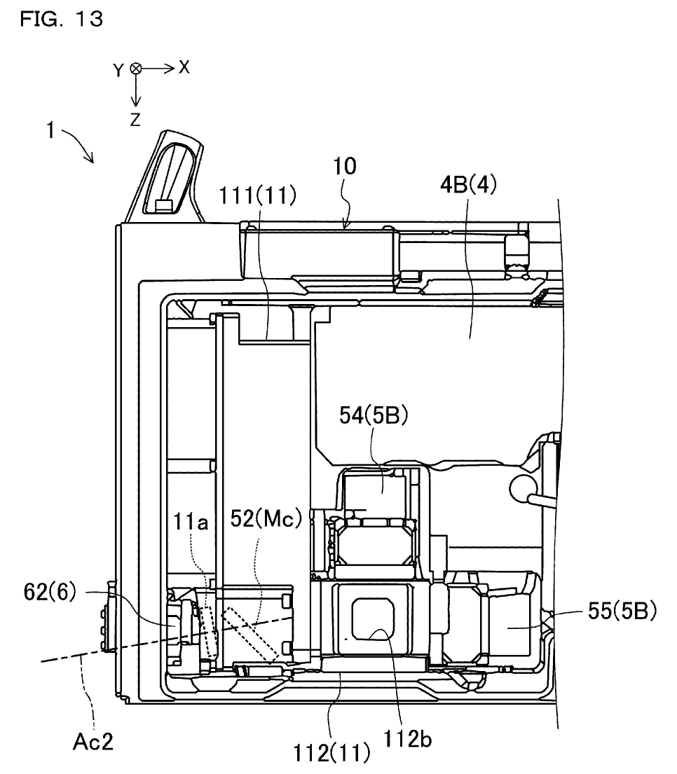

FIG. 13 is a side view illustrating a configuration of the three-dimensional scanning section 5.

The Z-direction scanning section 5A is interposed between the laser light generation section 4 and the laser light scanning section 5B, and optically connects the laser light generation section 4 and the laser light scanning section 5B. Specifically, the Z-direction scanning section 5A functions as a hub that optically connects the wavelength conversion section 4B of the laser light generation section 4 to the laser light scanning section 5B and optically connects the printing region inspection section 6 to the laser light scanning section 5B.

Specifically, the Z-direction scanning section 5A according to the present embodiment includes a fourth optical member 51, the focus adjustment section 53, and a fifth optical member 52. These elements are arranged in order from the top along the up-down direction, as suggested in FIG. 3.

### Overall configuration

The Z-direction scanning section 5A forms a laser optical path L1 of the UV laser light. The UV laser light to be formed on the laser optical path L1 is the UV laser light generated by the laser light generation section 4 and reaching the laser light scanning section 5B. The laser optical path L1 constitutes at least a part of an optical path that is emitted from the laser light generation section 4, passes through the Z-direction scanning section 5A and the laser light scanning section 5B, and is emitted from the emission window 19.

The fourth optical member 51, the focus adjustment section 53, and the fifth optical member 52 can be regarded as being disposed in the middle of the laser optical path L1. The laser optical path L1 can be divided into two optical paths with the focus adjustment section 53 as a boundary.

Hereinafter, the laser optical path L1 connecting the laser light generation section 4 and the focus adjustment section 53 is referred to as an upstream laser optical path L11, and the laser optical path L1 connecting the focus adjustment section 53 and the laser light scanning section 5B is referred to as a downstream laser optical path L12.

The upstream laser optical path L11 is provided inside the housing 10, and is an optical path from the output window 40b of the laser light generation section 4 to the focus adjustment section 53 via the fourth optical member 51.

On the other hand, the downstream laser optical path L12 is provided inside the housing 10, and is an optical path from the focus adjustment section 53 to the first scanner 54 of the laser light scanning section 5B via the fifth optical member 52.

In the case of such layout, the focus adjustment section 53 can be regarded as being disposed in the middle of the laser optical path L1 from the laser light generation section 4 to the fifth optical member 52.

### Fourth optical member 51

The fourth optical member 51 is disposed in the middle of the upstream laser optical path L11. The fourth optical member 51 includes, for example, a reflection mirror that reflects UV laser light. The fourth optical member 51 reflects the UV laser light emitted from the wavelength conversion section 4B and guides the UV laser light to the focus adjustment section 53 by bending the optical axis of the UV laser light downward.

### Focus adjustment section 53

The focus adjustment section 53 adjusts the focal position of the UV laser light generated by the laser light generation section 4, particularly the wavelength conversion section 4B. The UV laser light having passed through the focus adjustment section 53 enters the laser light scanning section 5B via the fifth optical member 52.

Specifically, the focus adjustment section 53 passes the UV laser light output from the wavelength conversion section 4B and reflected by the fourth optical member 51, and adjusts the focal position of the UV laser light.

More specifically, the focus adjustment section 53 can adjust the focal position of the UV laser light generated by the laser light generation section 4 on the basis of the measurement result of the distance measurement section 104 of the printing controller 100. Processing related to adjustment of the focal position based on the measurement result will be described later.

The focus adjustment section 53 also causes the printing laser light that has passed through the focus adjustment section 53 to be emitted toward the fifth optical member 52. The UV laser light reaching the fifth optical member 52 is guided to the laser light scanning section 5B via the fifth optical member 52.

Although not described in detail, the focus adjustment section 53 includes, for example, an incident lens that transmits the UV laser light output from the laser light generation section 4, a collimator lens that passes the UV laser light passing through the incident lens, an emission lens that passes the UV laser light passing through the incident lens and the collimator lens, and a lens drive section that moves the incident lens.

When the focal position is adjusted, for example, the lens drive section operates on the basis of a control signal output from the head control section 102. With this operation, the relative distance between the incident lens and the emission lens is changed while the optical axes of the incident lens, the collimator lens, and the emission lens are kept coaxial with respect to the UV laser light. By this change, the focal position of the UV laser light with which the workpiece W is irradiated is displaced.

The focal position of the UV laser light is displaced so as to approach to and move away from the emission window 19 of the print head 1. That is, the focus adjustment section 53 functions as a measure for scanning the UV laser light in the up-down direction. The scanning direction by the focus adjustment section 53 corresponds to the "Z direction" defined as described above.

### Fifth optical member 52 (merging mechanism Mc)

The fifth optical member 52 is disposed in the middle of the laser optical path L1, more specifically, in the middle of the downstream laser optical path L12. The fifth optical member 52 is constituted by, for example, a dichroic mirror that reflects UV laser light and transmits light having a wavelength other than UV. The fifth optical member 52 reflects the UV laser light emitted from the focus adjustment section 53 and guides the UV laser light to the laser light scanning section 5B by bending the optical axis of the UV laser light backward.

The fifth optical member 52 according to the present embodiment constitutes a merging mechanism Mc that merges the distance measurement light generated by the distance measurement light emitting section 7A of the distance measurement unit 7 with the laser optical path L1 of the UV laser light generated by the laser light generation section 4 and reaching the laser light scanning section 5B. The fifth optical member 52 can also separate reflected light of the distance measurement light from the laser optical path L1.

Specifically, the fifth optical member 52 constitutes a merging mechanism Mc that merges the distance measurement light, the guide light, and the image forming light (the image forming light related to the coaxial camera 65) into the laser optical path L1. The fifth optical member 52 can also separate reflected light of the guide light, the distance measurement light, and the image forming light from the laser optical path L1.

In other words, the fifth optical member 52 functions as a separation section that separates the guide optical path L2, the distance measurement optical path L3, and the imaging optical path L4 from the laser optical path L1, and also functions as a merging section that merges the guide optical path L2, the distance measurement optical path L3, and the imaging optical path L4 with the laser optical path L1.

In other words, the merging mechanism Mc constituted by the fifth optical member 52 makes the optical axis of the downstream laser optical path L12, the optical axis of the guide optical path L2, the optical axis of the distance measurement optical path L3, and the optical axis of the imaging optical path L4 of the coaxial camera 65 coaxial.

In other words, the optical axis of the guide optical path L2, the optical axis of the distance measurement optical path L3, and the optical axis of the imaging optical path L4 of the coaxial camera 65 can be regarded as branching from the optical axis of the laser optical path L1 starting from the merging mechanism Mc.

Specifically, the fifth optical member 52 according to the present embodiment includes a dichroic mirror that reflects UV laser light and transmits distance measurement light, image forming light, and guide light. Note that, in this configuration, the wavelength of the UV laser light is set to be different from the wavelengths of the guide light, the distance measurement light, and the image forming light.

### Laser light scanning section 5B

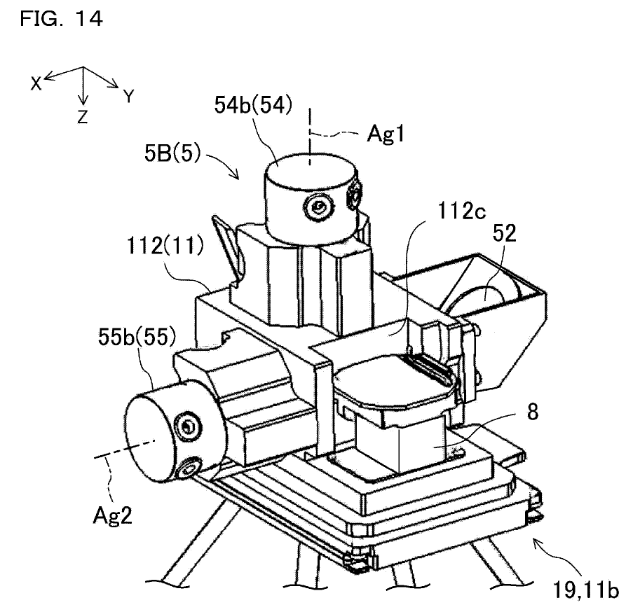

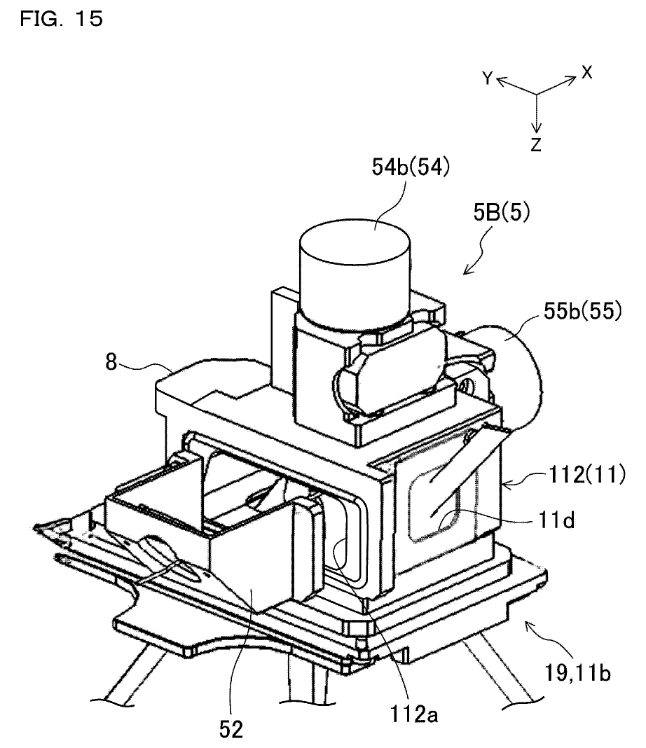

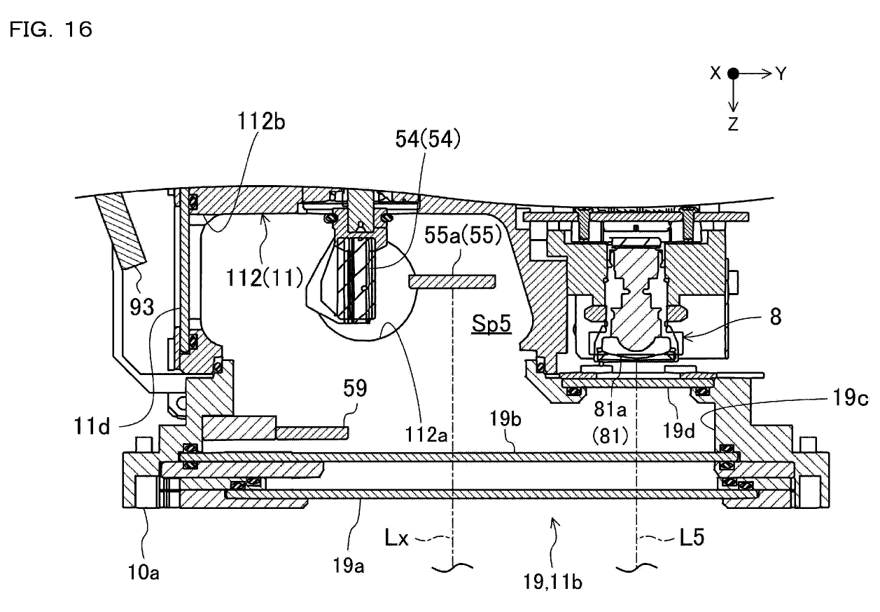

FIGS. 14 and 15 are perspective views illustrating a configuration of the laser light scanning section 5B. FIG. 16 is a cross-sectional view illustrating a configuration of the laser light scanning section 5B.

### Overall configuration

The laser light scanning section 5B two-dimensionally scans the UV laser light generated by the laser light generation section 4 and irradiates the workpiece W with the UV laser light. Specifically, the laser light scanning section 5B irradiates the workpiece W with the UV laser light emitted from the laser light generation section 4 and passing through the focus adjustment section 53, and two-dimensionally scans the surface of the workpiece W (for example, in the printing region R1).

More specifically, the laser light scanning section 5B includes a mirror member (the first mirror 54a and the second mirror 55a) that reflects the UV laser light generated by the laser light generation section 4, two-dimensionally scans the workpiece W with the UV laser light by the mirror member, and irradiates the workpiece W with the UV laser light.

More specifically, the laser light scanning section 5B is configured by a so-called biaxial (X-axis and Y-axis) galvano scanner. That is, the laser light scanning section 5B includes the first scanner 54 for scanning the UV laser light incident from the Z-direction scanning section 5A in the first direction, and the second scanner 55 for scanning the UV laser light scanned by the first scanner 54 in the second direction.

Here, the second direction refers to a direction substantially orthogonal to the first direction. Therefore, the second scanner 55 can scan the UV laser light in a direction substantially orthogonal to the first scanner 54.

In the present embodiment, the first direction is equal to the front-rear direction (the longitudinal direction of the housing 10), and the second direction is equal to the left-right direction (the lateral direction of the housing 10). That is, the first direction corresponds to the "X direction" defined as described above, and the second direction orthogonal thereto corresponds to the "Y direction" defined as described above. Both the X direction and the Y direction are orthogonal to the Z direction.

### First scanner 54

The first scanner 54 includes a first mirror 54a as a mirror member and a first motor 54b that rotates the first mirror 54a.

The first mirror 54a reflects the UV laser light generated by the laser light generation section 4. The first mirror 54a is disposed at the distal end of the first scanner 54. The first mirror 54a is disposed at substantially the same height as the fifth optical member 52 and behind the fifth optical member 52. The first mirror 54a rotates about a first rotation axis Ag1 extending in the up-down direction (see FIG. 14).

The first motor 54b adjusts the rotational attitude of the first mirror 54a around the first rotation axis Ag1 by rotating the first mirror 54a around the first rotation axis Ag1. By adjusting the rotational attitude of the first mirror 54a, the reflection angle of the UV laser light by the first scanner 54 in the first direction can be adjusted. By adjusting the reflection angle of the UV laser light in the first direction, the irradiation position of the UV laser light in the first direction can be changed.

### Second scanner 55

Similarly, the second scanner 55 includes a second mirror 55a as a mirror member and a second motor 55b that rotates the second mirror 55a.

The second mirror 55a reflects the UV laser light generated by the laser light generation section 4 and reflected by the first mirror 54a. The second mirror 55ais disposed at the distal end of the second scanner 55. The second mirror 55a is disposed at substantially the same height as the first mirror 54a and on the right of the first mirror 54a. The second mirror 55a rotates about a second rotation axis Ag2 extending in the front-rear direction (see FIG. 14).

The second motor 55b adjusts the rotational attitude of the second mirror 55a around the second rotation axis Ag2 by rotating the second mirror 55a around the second rotation axis Ag2. By adjusting the rotational attitude of the second mirror 55a, the reflection angle of the UV laser light by the second scanner 55 in the second direction can be adjusted. By adjusting the reflection angle of the UV laser light in the second direction, the irradiation position of the UV laser light in the second direction can be changed.

### Regarding operation

The laser light scanning section 5B operates the first scanner 54 and the second scanner 55 according to the print setting created in advance, thereby deflecting the UV laser light toward the printing region R1. The UV laser light deflected in this manner passes through the emission window 19 provided in the housing 10 of the print head 1 and is emitted into the printing region R1. With the UV laser light, a desired printing pattern Pm can be printed in the printing region R1.

Specifically, when UV laser light enters the laser light scanning section 5B from the Z-direction scanning section 5A, the UV laser light is sequentially reflected by the first mirror 54a of the first scanner 54 and the second mirror 55a of the second scanner 55, and is emitted from the emission window 19 to the outside of the print head 1.

At that time, by operating the first motor 54b of the first scanner 54 to adjust the rotational attitude of the first mirror 54a, the UV laser light can be scanned in the first direction on the surface of the workpiece W. At the same time, the second motor 55b of the second scanner 55 is operated to adjust the rotational attitude of the second mirror 55a, so that the UV laser light can be scanned in the second direction on the surface of the workpiece W.

Furthermore, not only the UV laser light but also the guide light or the distance measurement light having passed through the merging mechanism Mc is incident on the laser light scanning section 5B. The laser light scanning section 5B according to the present embodiment can two-dimensionally scan the incident guide light or distance measurement light by operating the first scanner 54 and the second scanner 55.

Furthermore, the laser optical path L1 of the UV laser light is also merged with (is coaxial with) the imaging optical path L4 of the coaxial camera 65. The laser light scanning section 5B according to the present embodiment can two-dimensionally scan an intersection point between the imaging optical path L4 and the workpiece W, that is, an imaging position by the coaxial camera 65 by operating the first scanner 54 and the second scanner 55.

Note that the rotational attitude that can be taken by the first mirror 54a and the second mirror 55a is basically set so that, when the UV laser light is reflected by the second mirror 55a, the reflected light falls within a range where the reflected light passes through the emission window 19, that is, within the range of the printing region R1.

### Regarding calibration optical path Lc

On the other hand, in the print head 1 according to the present embodiment, when the measurement result by the distance measurement unit 7 is corrected (calibration of the distance measurement unit 7), the calibration optical path Lc is configured by setting at least one of the first scanner 54 and the second scanner 55 to a specific rotational attitude (see FIG. 4C).

The calibration optical path Lc is an optical path connecting a reference member 91 of the calibration unit 9 and the distance measurement light emitting section 7A and the distance measurement light receiving section 7B of the distance measurement unit 7 via the laser light scanning section 5B.

As described later, since the reference member 91 is provided inside the housing 10, the calibration optical path Lc is also configured inside the housing 10. Therefore, the calibration optical path Lc does not pass through the emission window 19. Therefore, the above-described "specific rotational attitude" can be defined as a rotational attitude outside the scanning range of the UV laser light by the laser light scanning section 5B on the surface of the workpiece W, or can be defined as a rotational attitude not used when the laser light is scanned on the surface of the workpiece W, among the rotational attitudes formed by at least one of the first scanner 54 and the second scanner 55.

Furthermore, the “specific rotational attitude” can be a plurality of types of rotational attitudes. For example, in a case where a plurality of the reference members 91 is provided, a “specific rotational attitude” corresponding to each reference member 91 can be set.

Hereinafter, the distance measurement light propagating along the calibration optical path Lc is referred to as "second distance measurement light". The second distance measurement light refers to distance measurement light emitted from the distance measurement light emitting section 7A to the laser light scanning section 5B in order to correct the measurement result separately from the distance measurement light for measuring the distance from the laser printing apparatus L to the surface of the workpiece W.

### Sealing section 11

### Overall configuration

The sealing section 11 hermetically seals the fifth optical member 52 as the merging mechanism Mc.

Specifically, in addition to the fifth optical member 52, the sealing section 11 hermetically seals at least the first mirror 54a and the second mirror 55a of the laser light scanning section 5B.

More specifically, the sealing section 11 hermetically seals the focus adjustment section 53 in addition to the fifth optical member 52, the first mirror 54a, and the second mirror 55a.

As an example, the sealing section 11 according to the present embodiment is configured to hermetically seal the fourth optical member 51 in addition to the fifth optical member 52, the focus adjustment section 53, the first mirror 54a, and the second mirror 55a.

As illustrated in FIGS. 4A, 5, 13, and 16, the first transmission window 11a and the emission window 19 as the second transmission window 11b are disposed in the sealing section 11. That is, the emission window 19 can be regarded as an element of the sealing section 11.

Distance measurement light until it is merged into the laser optical path L1 by the fifth optical member 52 as a merging mechanism and distance measurement light separated from the laser optical path L1 by the fifth optical member 52 as a merging mechanism are transmitted through the first transmission window 11a. The first transmission window 11a allows optical access to the internal space of the sealing section 11.

Here, the former distance measurement light corresponds to the distance measurement light from emission from the distance measurement light emitting section 7A of the distance measurement unit 7 to arrival at the fifth optical member 52 as the merging mechanism. On the other hand, the latter distance measurement light corresponds to the distance measurement light reflected by the surface of the workpiece W and then transmitted through the fifth optical member 52 via the laser light scanning section 5B.

Hereinafter, the description of "distance measurement light until merging with the laser optical path L1 by the fifth optical member 52 serving as the merging mechanism" and the description of "distance measurement light separated from the laser optical path L1 by the fifth optical member 52 serving as the merging mechanism" are intended for the same purpose.

On the other hand, the UV laser light and the distance measurement light merged by the fifth optical member 52 as the merging mechanism are transmitted through the second transmission window 11b before the workpiece W is irradiated with the UV laser light and the distance measurement light.

Moreover, as illustrated in FIGS. 4A and 12, the output window 40b as the third transmission window 11c is disposed in the sealing section 11. That is, the output window 40b may be regarded as one element of the laser light generation section 4 or one element of the sealing section 11.

The UV laser light generated by the laser light generation section 4 is transmitted through the third transmission window 11c until reaching the fifth optical member 52 as the merging mechanism.

Moreover, as illustrated in FIGS. 4A and 16, the fourth transmission window 11d is disposed in the sealing section 11. The second distance measurement light guided from the laser light scanning section 5B to the reference member 91 is transmitted through the fourth transmission window 11d.

Furthermore, the sealing section 11 according to the present embodiment can be divided into a first sealing member 111 illustrated in FIGS. 4A, 8, 9, 10, and 13 and a second sealing member 112 illustrated in FIGS. 4A, 8, 9, 10, 13, 14, 15, and 16.

### First sealing member 111

The first sealing member 111 hermetically seals the components of the Z-direction scanning section 5A in the housing 10. The first sealing member 111 defines an accommodation space (first sealed space Sp4) for the component in the housing 10.

The first sealing member 111 has a thin box shape whose dimensions in the up-down direction and the horizontal direction are longer than those in the front-rear direction. The output window 40b as the third transmission window 11c and the first transmission window 11a are disposed in the first sealing member 111.

The third transmission window 11c is disposed at a portion where the laser light generation section 4 and the Z-direction scanning section 5A face each other, for example, on a rear surface near an upper end of the Z-direction scanning section 5A. For example, the third transmission window 11c is disposed at substantially the same height position as the fourth optical member 51.

Specifically, the third transmission window 11c is made of a transparent member that is fitted into a through hole that allows the laser light generation section 4 and the Z-direction scanning section 5A to communicate with each other and is capable of transmitting UV laser light.

The first transmission window 11a is disposed at a portion where the Z-direction scanning section 5A and the printing region inspection section 6 face each other, for example, on the front surface near the lower end of the Z-direction scanning section 5A. For example, the first transmission window 11a is disposed at substantially the same height position as the fifth optical member 52 and a sixth optical member 62 described later, and is disposed on a straight line connecting the fifth optical member 52 and the sixth optical member 62.

Specifically, the first transmission window 11a is made of a transparent member that is fitted in a through hole penetrating the front surface near the lower end of the Z-direction scanning section 5A and is capable of transmitting the guide light, the image forming light, and the distance measurement light.

Then, as illustrated in FIGS. 4A and 13, the first transmission window 11a is disposed in an attitude inclined with respect to the optical axes of the distance measurement light until merging with the laser optical path L1 by the fifth optical member 52 and the distance measurement light separated from the laser optical path L1 by the fifth optical member 52.

Specifically, the first transmission window 11a is disposed in an attitude in which the central axis Ac2 penetrating the central portion thereof is inclined with respect to the front-rear direction. More specifically, the central axis Ac2 of the first transmission window 11a extends along the ZX plane and is disposed in an attitude inclined with respect to the X direction and the Z direction.

### Second sealing member 112

The second sealing member 112 hermetically seals the components (first mirror 54a and second mirror 55a) of the laser light scanning section 5B in the housing 10. The second sealing member 112 defines an accommodation space (second sealed space Sp5) for the first mirror 54a and the second mirror 55a in the housing 10. The second sealing member 112 can also be referred to as a "mirror sealing member". The second sealing member 112 as a mirror sealing member hermetically seals at least the first mirror 54a and the second mirror 55a in the laser light scanning section 5B.

The second sealing member 112 has a substantially box shape. The emission window 19 as the second transmission window 11b and the fourth transmission window 11d are disposed in the second sealing member 112.

As illustrated in FIG. 16, the emission window 19 is configured by fitting the first transparent member 19a and the second transparent member 19b into a through hole 19c opened in the lower surface of the second sealing member 112.

The first transparent member 19a is detachably disposed in the through hole 19c. The second transparent member 19b is interposed between the first transparent member 19a and the second sealed space Sp5, and is undetachably disposed with respect to the through hole 19c.

Furthermore, as illustrated in FIG. 16, both the first transparent member 19a and the second transparent member 19b transmit both the scanning axis Lx scanned by the laser light scanning section 5B and the non-scanning axis L5 not scanned by the laser light scanning section 5B.

In other words, the first transparent member 19a and the second transparent member 19b transmit the UV laser light two-dimensionally scanned by the laser light scanning section 5B, the distance measurement light emitted from the distance measurement light emitting section 7A, the guide light emitted from the guide light source 61, the image forming light used for imaging by the coaxial camera 65, and the image forming light used for imaging by the wide-area camera 8, respectively.

The fourth transmission window 11d is made of a transparent member that is fitted into the through hole 112b opened in the right side surface (side surface on -Y side) of the second sealing member 112 and is capable of transmitting UV laser light.

In addition, a communication hole 112a that allows the internal space (second sealed space Sp5) of the second sealing member 112 to communicate with the internal space (first sealed space Sp4) of the first sealing member 111 is opened in the front surface (end surface on -X side) of the second sealing member 112. That is, in the present embodiment, the first sealed space Sp4 and the second sealed space Sp5 form an integrated internal space via the communication hole 112a.

Note that the first sealed space Sp4 and the second sealed space Sp5 may be non-integral and independent internal spaces by fitting a transparent member into the communication hole 112a. In this case, the transparent member fitted into the communication hole 112a functions as the second transmission window 11b.

### Wide-area camera 8

The wide-area camera 8 images the workpiece W to acquire the captured image Pw.

Specifically, the wide-area camera 8 has an imaging optical axis (non-scanning axis L5) independent of the laser optical path L1 of the UV laser light emitted from the emission window 19. The non-scanning axis L5 passes through the emission window 19. The wide-area camera 8 images the workpiece W through the emission window 19.

The wide-area camera 8 is also disposed outside the second sealing member 112 as a mirror sealing member. Specifically, the wide-area camera 8 according to the present embodiment is fixed to the outer surface of the second sealing member 112.

For details, a recess 112c recessed toward the first scanner 54 and the second scanner 55 is formed on a left side surface facing the left side (+Y direction) of the outer surface of the second sealing member 112 (see FIG. 14). The wide-area camera 8 is accommodated in the recess 112c in a state of being in contact with the outer surface of the second sealing member 112.

Furthermore, as illustrated in FIG. 16, the wide-area camera 8 is disposed at substantially the same height position as the first scanner 54 and the second scanner 55 in the housing 10. On the other hand, in the housing 10, the first scanner 54 and the second scanner 55 are disposed between the wavelength conversion section 4B and the emission window 19 in the Z direction. Therefore, in the housing 10, the wide-area camera 8 is disposed between the wavelength conversion section 4B and the emission window 19 in the Z direction. Note that the wide-area camera 8 only needs to be disposed between the wavelength conversion section 4B and the emission window 19 in the Z direction in the housing 10, and does not need to be arranged in a line in the X direction or the Y direction.

Furthermore, the wide-area camera 8 is disposed such that its imaging optical axis (non-scanning axis L5) passes through the sealed space (second sealed space Sp5) defined by the second sealing member 112. As illustrated in FIG. 16, the non-scanning axis L5 is disposed side by side with the scanning axis Lx at an interval in the Y direction. The non-scanning axis L5 extends parallel or substantially parallel to the scanning axis Lx.

Specifically, the wide-area camera 8 is disposed such that its imaging optical axis (non-scanning axis L5) passes through the first transparent member 19a and the second transparent member 19b of the emission window 19 in addition to the second sealed space Sp5.

More specifically, on one surface of the second sealing member 112, an imaging window 19d located on the opposite side (upper side in the illustrated example) of the first and second transparent members 19a and 19b with the sealed space (second sealed space Sp5) interposed therebetween is disposed. The imaging window 19d is formed of a transparent member that is fitted into a through hole penetrating the one surface of the second sealing member 112 in the Z direction and is capable of transmitting image forming light.

Then, the wide-area camera 8 according to the present embodiment is disposed so that its imaging optical axis (non-scanning axis L5) passes through the imaging window 19d in addition to the second sealed space Sp5, the first transparent member 19a, and the second transparent member 19b. Specifically, the wide-area camera 8 according to the present embodiment is disposed directly above the emission window 19, and is fixed in an attitude with its imaging lens 81 facing downward. As described above, the non-scanning axis L5 of the wide-area camera 8 is not coaxial with the scanning axis Lx scanned by the laser light scanning section 5B (see FIGS. 5 and 16 and the like).

The wide-area camera 8 can generate the captured image Pw having a wider visual field size than the image generated by the coaxial camera 65 by imaging the workpiece W without intervention of the laser light scanning section 5B.

The wide-area camera 8 is configured as an imaging measure that is non-coaxial with the UV laser light. Although the wide-area camera 8 cannot perform two-dimensional scanning via the laser light scanning section 5B, the wide-area camera 8 has a wider field of view than the coaxial camera 65, and can generate a wide-area image obtained by imaging the printing region R1 with a relatively wide field of view as the captured image Pw. The wide-area camera 8 is used, for example, to image the entire printing region R1 at a time.

The captured image Pw generated by the wide-area camera 8 can be displayed on the display section 301 in a state where at least a part thereof is enlarged or reduced. The display section 301 can display the captured image Pw generated by the wide-area camera 8 and the captured image Pw generated by the coaxial camera 65 side by side, or alternatively display one of the two types of captured images Pw.

In addition, the print head 1 includes a return light suppression measure 81a that suppresses incidence of return light of UV laser light reflected on the surface of the workpiece W on the wide-area camera 8. In the present embodiment, a return light suppression measure is realized by devising the configuration of the wide-area camera 8 itself.

Specifically, the return light suppression measure 81a according to the present embodiment includes a wavelength selective coating applied to the surface of the imaging lens 81 of the wide-area camera 8. The wavelength selective coating is a coating configured to transmit visible light and reflect UV laser light.

### Printing region inspection section 6

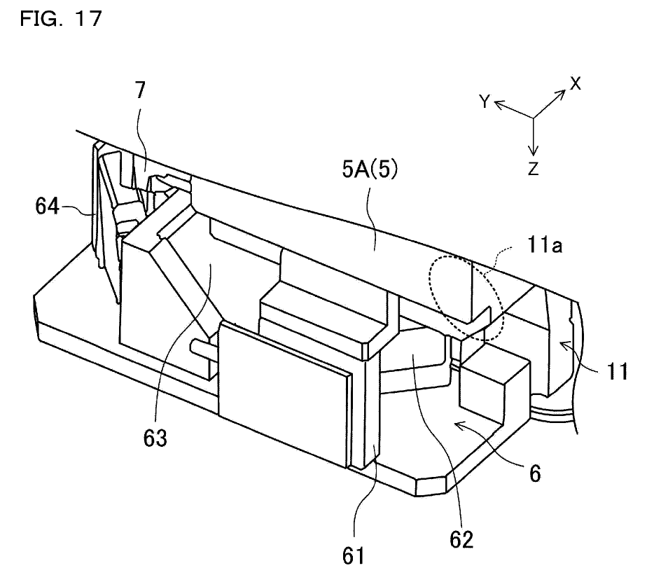

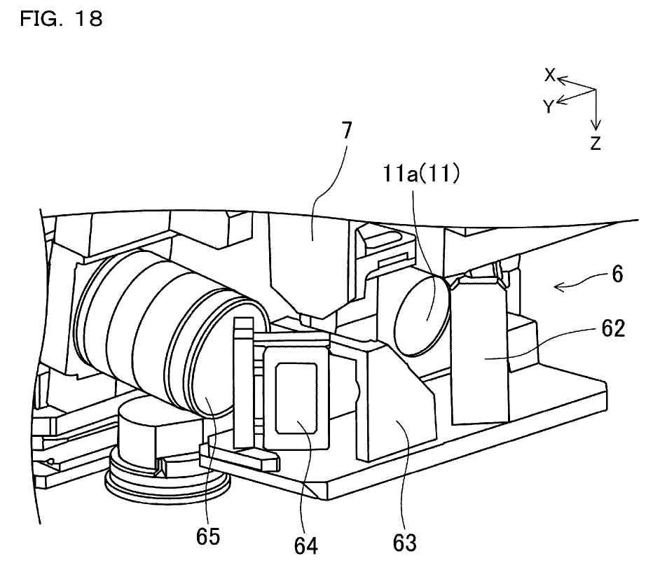

FIGS. 17 and 18 are perspective views illustrating a configuration of the printing region inspection section 6.

### Overall configuration

As illustrated in FIGS. 4A, 17, and 18, the printing region inspection section 6 includes the guide light source 61, a sixth optical member 62, a seventh optical member 63, an eighth optical member 64, the coaxial camera 65, and the distance measurement unit 7.

The guide light source 61, the sixth optical member 62, the seventh optical member 63, the eighth optical member 64, the coaxial camera 65, and the distance measurement unit 7 are all disposed inside the housing 10 and outside the sealing section 11.

First, components of the printing region inspection section 6 other than the distance measurement unit 7 will be described in detail.

### Guide light source 61

The guide light source 61 emits, onto the workpiece W, guide light for projecting a printing pattern Pm to be printed on the workpiece W. By emitting the guide light, the irradiation position of the UV laser light can be visually recognized. Therefore, the wavelength of the guide light is set to fall within the visible light range.

As described above, the guide light source 61 includes the guide optical path L2 branched from the laser optical path L1 between the laser light generation section 4 and the laser light scanning section 5B (specifically, the fifth optical member 52 as the merging mechanism Mc).

As an example, the guide light source 61 according to the present embodiment emits red laser light having a wavelength around 655 nm as the guide light. The wavelength of the guide light is set to be different from the wavelengths of the printing laser light, the distance measurement light, and the image forming light.

The guide light source 61 is coaxial with the UV laser light. Specifically, the guide light emitted from the guide light source 61 propagates along the guide optical path L2, and the guide optical path L2 is merged with the laser optical path L1 via the first transmission window 11a and the fifth optical member 52 as described above. Therefore, by appropriately operating the laser light scanning section 5B, the guide light can be two-dimensionally scanned in the printing region R1 exemplified in FIG. 1 and the like.

Furthermore, similarly to the laser light generation section 4 and the laser light scanning section 5B, the guide light source 61 is electrically connected to the head control section 102. The guide light source 61 executes emission of the guide light on the basis of the control signal output from the head control section 102.

### Sixth optical member 62

The sixth optical member 62 merges the guide light emitted from the guide light source 61 with the distance measurement light until merging into the laser optical path L1 by the fifth optical member 52 serving as the merging mechanism Mc, and the optical path (distance measurement optical path L3) of the distance measurement light separated from the laser optical path L1 by the fifth optical member 52 serving as the merging mechanism Mc. The sixth optical member 62 can be referred to as a guide light merging member.

Specifically, the sixth optical member 62 merges the guide light emitted from the guide light source 61 with the distance measurement light until merging into the laser optical path L1 by the fifth optical member 52, the optical path (distance measurement optical path L3) of the distance measurement light separated from the laser optical path L1 by the fifth optical member 52, and the optical path (imaging optical path L4) of the image forming light related to the coaxial camera 65.

In other words, the sixth optical member 62 functions as a separation section that separates the guide optical path L2 from the other optical paths L3 and L4 among the guide optical path L2, the distance measurement optical path L3, and the imaging optical path L4, and also functions as a merging section that merges the guide optical path L2 with the other optical paths L3 and L4.

As an example, the sixth optical member 62 according to the present embodiment includes a dichroic mirror that allows guide light to pass therethrough and reflects distance measurement light and image forming light.

Specifically, as illustrated in FIGS. 17 and 18, the sixth optical member 62 is interposed between the first transmission window 11a and the guide light source 61, and is disposed in front of the first transmission window 11a and behind the guide light source 61.

The sixth optical member 62 is disposed in an attitude in which the mirror surface faces diagonally backward to the left, and reflects the distance measurement light emitted from the distance measurement light emitting section 7A forward, and reflects the reflected light of the distance measurement light received by the distance measurement light receiving section 7B and the image forming light received by the coaxial camera 65 leftward.

### Seventh optical member 63

The seventh optical member 63 merges the image forming light according to the coaxial camera 65 with the distance measurement light until merging into the laser optical path L1 by the fifth optical member 52 and the optical path (distance measurement optical path L3) of the distance measurement light separated from the laser optical path L1 by the fifth optical member 52. The seventh optical member 63 can be referred to as an imaging light merging member.

In other words, the seventh optical member 63 functions as a separation section that separates the imaging optical path L4 from the distance measurement optical path L3, and also functions as a merging section that merges the imaging optical path L4 with the distance measurement optical path L3.

As an example, the seventh optical member 63 according to the present embodiment includes a dichroic mirror that transmits image forming light and reflects distance measurement light.

Specifically, as illustrated in FIGS. 4A, 17, and 18, the seventh optical member 63 is interposed between the sixth optical member 62 and the eighth optical member 64, and is disposed on the left of the sixth optical member 62 and on the right of the eighth optical member 64.

The seventh optical member 63 is disposed in an attitude in which the mirror surface is directed diagonally upward to the right, and reflects the distance measurement light emitted from the distance measurement light emitting section 7A rightward or reflects reflected light of the distance measurement light received by the distance measurement light receiving section 7B upward.

### Eighth optical member 64

The eighth optical member 64 guides the image forming light transmitted through the seventh optical member 63 to the coaxial camera 65. As an example, the eighth optical member 64 according to the present embodiment includes a reflection mirror that reflects image forming light.

Specifically, as illustrated in FIGS. 4A, 17, and 18, the eighth optical member 64 is interposed between the seventh optical member 63 and the coaxial camera 65, and is disposed on the left side of the seventh optical member 63 and in front of the coaxial camera 65. The eighth optical member 64 is disposed in an attitude in which the mirror surface faces diagonally rearward right, and reflects the image forming light transmitted through the seventh optical member 63 forward.

### Coaxial camera 65

The coaxial camera 65 images the workpiece W to acquire the captured image Pw.

Specifically, the coaxial camera 65 has an imaging optical axis (an optical axis extending along the imaging optical path L4) separated from the laser optical path L1 between the laser light generation section 4 and the laser light scanning section 5B. The coaxial camera 65 receives image forming light along the imaging optical axis to image the workpiece W via the laser light scanning section 5B and the emission window 19. By this imaging, the coaxial camera 65 acquires the captured image Pw including at least a part of the printing region R1.

The coaxial camera 65 has a smaller visual field size than the wide-area camera 8 described later, but can generate, as the captured image Pw, a coaxial image obtained by enlarging the printing region R1 at a relatively high magnification, or can two-dimensionally scan the imaging region via the laser light scanning section 5B. The coaxial camera 65 is used, for example, to locally enlarge and image a part of the printing region R1. The captured image Pw generated by the coaxial camera 65 can be displayed on the display section 301 in a state where at least a part thereof is enlarged or reduced.

The coaxial camera 65 is coaxial with the UV laser light. Specifically, reflected light (image forming light) used for image formation by the coaxial camera 65 propagates along the imaging optical path L4 and enters the coaxial camera 65, and the imaging optical path L4 joins the downstream laser optical path L12 in the fifth optical member 52 as described above. Therefore, the printing region R1 illustrated in FIG. 1 and the like can be two-dimensionally scanned by appropriately operating the laser light scanning section 5B.

Furthermore, the coaxial camera 65 is electrically connected to the head control section 102, similarly to the laser light generation section 4 and the laser light scanning section 5B. The coaxial camera 65 executes generation of the captured image Pw on the basis of the control signal output from the head control section 102.

### Distance measurement unit 7

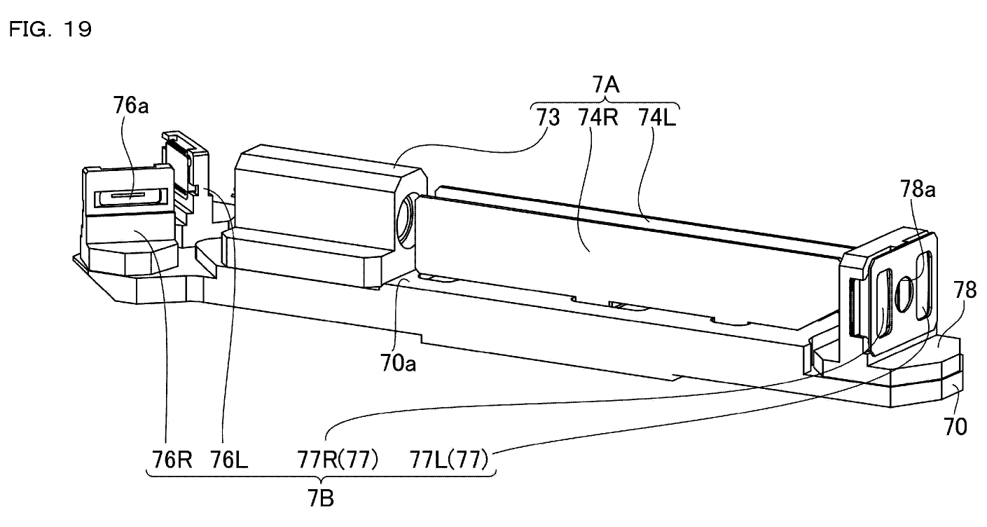

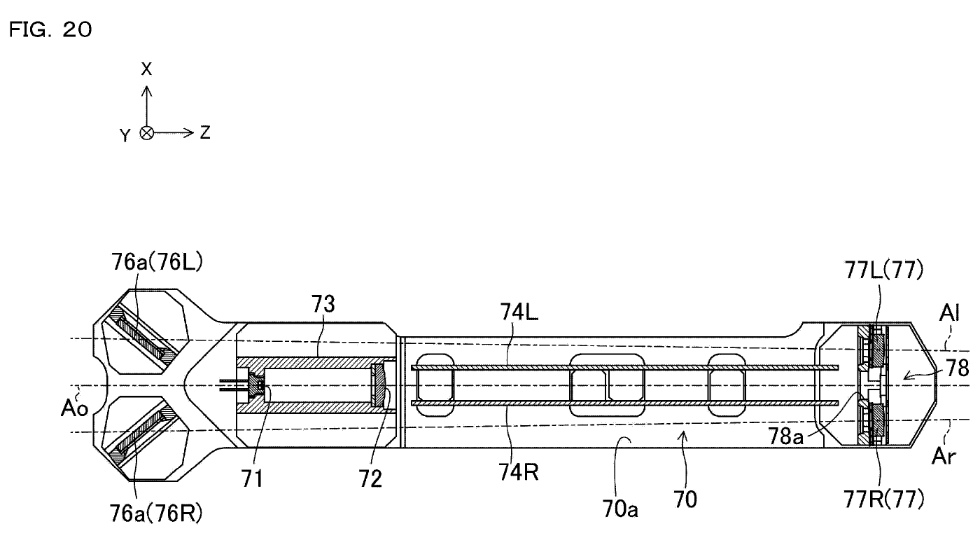

FIGS. 19 and 20 are perspective views illustrating a configuration of the distance measurement unit 7.

### Overall configuration

As illustrated in FIG. 4B, the distance measurement unit 7 projects distance measurement light via the laser light scanning section 5B, and irradiates the surface of the workpiece W with the distance measurement light. The distance measurement unit 7 also receives the distance measurement light reflected by the surface of the workpiece W via the laser light scanning section 5B.

The distance measurement unit 7 is mainly roughly divided into a module for projecting distance measurement light and a module for receiving the distance measurement light. Specifically, the distance measurement unit 7 includes a distance measurement light emitting section 7A configured as a module for projecting distance measurement light and a distance measurement light receiving section 7B configured as a module for receiving the distance measurement light. The distance measurement light emitting section 7Aand the distance measurement light receiving section 7B constitute the integrated distance measurement unit 7.

Among these, the distance measurement light emitting section 7A generates and emits distance measurement light for measuring the distance from the print head 1 to the surface of the workpiece W. Specifically, the distance measurement light emitting section 7A is provided inside the housing 10, generates the distance measurement light, and emits the distance measurement light to the laser light scanning section 5B. The distance measurement light emitting section 7A is an example of a "distance measurement light generation section" in the present embodiment.

On the other hand, the distance measurement light receiving section 7B receives the distance measurement light that has been merged at the fifth optical member 52 serving as the merging mechanism and two-dimensionally scanned via the laser light scanning section 5B, reflected on the surface of the workpiece W, returned via the laser light scanning section 5B, and separated from the laser optical path L1 by the fifth optical member 52. Specifically, similarly to the distance measurement light emitting section 7A, the distance measurement light receiving section 7B is provided inside the housing 10, and receives the distance measurement light reflected on the surface of the workpiece W and returned via the laser light scanning section 5B and the fifth optical member 52.

Moreover, the distance measurement unit 7 includes a support base 70 that supports the distance measurement light emitting section 7A and the distance measurement light receiving section 7B. The distance measurement unit 7 is fixed inside the housing 10 via the support base 70. The distance measurement light emitting section 7A and the distance measurement light receiving section 7B are unitized by the support base 70. As described later, the support base 70 has a plate shape extending in a predetermined longitudinal direction.

As illustrated in FIG. 7, the distance measurement unit 7 is disposed in a space on the left side (+Y side) in the first accommodation space Sp1. Specifically, as illustrated in FIGS. 5, 6 and 8, the distance measurement unit 7 is disposed in the first accommodation space Sp1 in an attitude in which the support base 70 is disposed along the up-down direction (height direction). More specifically, as illustrated in FIGS. 5 and 6, the distance measurement unit 7 is disposed in an attitude in which the longitudinal direction of the support base 70 is disposed along the up-down direction.

As illustrated in FIG. 7, the distance measurement unit 7 emits distance measurement light downward along the up-down direction of the housing 10 and receives distance measurement light (reflected light) propagating substantially upward along the up-down direction. The distance measurement unit 7 is optically coupled to the three-dimensional scanning section 5 via the seventh optical member 63, the sixth optical member 62, the first transmission window 11a, and the fifth optical member 52.

Hereinafter, the configurations of the respective parts of the distance measurement unit 7 will be described in order.

### Support base 70

As illustrated in FIGS. 19 and 20, the support base 70 is formed to extend along the optical axis of the distance measurement light emitting section 7A, that is, the optical axis Ao of the distance measurement light emitted from the distance measurement light emitting section 7A, and is provided inside the housing 10. The support base 70 according to the present embodiment is formed of an integral plate-like body and has a rectangular outer shape extending along the optical axis Ao. The longitudinal direction of the support base 70 corresponds to a direction extending along the optical axis Ao of the distance measurement light emitting section 7A.

Various members can be attached to the upper surface 70a of the support base 70. Specifically, a pair of light receiving elements 76L and 76R constituting the distance measurement light receiving section 7B is attached to a portion corresponding to one side in the longitudinal direction of the support base 70, that is, the upper side of the housing 10. On the other hand, at a portion corresponding to the other side in the longitudinal direction of the support base 70, that is, the lower side of the housing 10, a light receiving lens 77 constituting the distance measurement light receiving section 7B is provided together with the pair of light receiving elements 76L and 76R. Among the members constituting the distance measurement light receiving section 7B, at least the pair of light receiving elements 76L and 76R and the light receiving lens 77 can both be fixed on the support base 70.

On the other hand, the distance measurement light emitting section 7A is fixed to the upper surface of the support base 70 between the pair of light receiving elements 76L and 76R and the light receiving lens 77. As illustrated in FIG. 19, the distance measurement light emitting section 7A according to the present embodiment is formed by modularizing a distance measurement light source 71 that emits distance measurement light and a light projecting lens 72 that collects the distance measurement light emitted from the distance measurement light source 71. Among the members constituting the distance measurement light emitting section 7A, at least the distance measurement light source 71 and the light projecting lens 72 can both be fixed on the support base 70.

### Distance measurement light emitting section 7A

The distance measurement light emitting section 7A includes the distance measurement light source 71 and the light projecting lens 72 described above, a casing 73 that accommodates the distance measurement light source and the light projecting lens, and a pair of guide plates 74L and 74R that guides the distance measurement light collected by the light projecting lens 72. The distance measurement light source 71, the light projecting lens 72, and the guide plates 74L and 74R are arranged in order from the upper side of the housing 10, and the arrangement direction thereof is substantially equal to the up-down direction of the housing 10.

The casing 73 is formed in a cylindrical shape extending along the longitudinal direction of the support base 70 (the up-down direction of the housing 10). The distance measurement light source 71 is attached to one end portion of the casing 73, and the light projecting lens 72 is attached to the other end portion of the casing 73. The one end portion of the casing 73 is located on the upper side of the housing 10. The other end portion of the casing 73 is located on the lower side of the housing 10. The space between the distance measurement light source 71 and the light projecting lens 72 is substantially hermetically sealed.

The distance measurement light source 71 emits distance measurement light in accordance with a control signal input from the head control section 102. Specifically, the distance measurement light source 71 can emit laser light in a visible light region as distance measurement light. In particular, the distance measurement light source 71 according to the present embodiment emits red laser light having a wavelength around 690 nm as distance measurement light.

The distance measurement light source 71 is also fixed in such an attitude that the optical axis Ao of red laser light emitted as distance measurement light is along the longitudinal direction of the casing 73. Therefore, the optical axis Ao of the distance measurement light is along the longitudinal direction of the support base 70 (the up-down direction of the housing 10), passes through the central portion of the light projecting lens 72, and reaches the outside of the casing 73.

The light projecting lens 72 is located between the pair of light receiving elements 76L and 76R in the distance measurement light receiving section 7B and the light receiving lens 77 in the longitudinal direction of the support base 70. The light projecting lens 72 takes such an attitude that the optical axis Ao of the distance measurement light passes therethrough.

The light projecting lens 72 can be, for example, a plano-convex lens, and a spherical convex surface can be fixed in an attitude facing the outside of the casing 73. The light projecting lens 72 collects the distance measurement light emitted from the distance measurement light source 71 and emits the light to the outside of the casing 73. The distance measurement light emitted to the outside of the casing 73 reaches between the guide plates 74L and 74R.

The guide plates 74L and 74R are configured as a pair of members arranged in the lateral direction of the support base 70, and can be plate-shaped bodies extending in the longitudinal direction of the support base 70. A space for emitting distance measurement light is defined between one guide plate 74L and the other guide plate 74R. The distance measurement light emitted to the outside of the casing 73 passes through the space thus defined and reaches a lens base 78.

The lens base 78 is fixed to an upper surface of a front end portion of the support base 70, and can support the light receiving lens 77 in the distance measurement light receiving section 7B from below. As illustrated in FIG. 18, the lens base 78 is provided with a through hole 78a that penetrates the lens base 78 in the longitudinal direction of the support base 70, and distance measurement light emitted from the distance measurement light source 71 can pass therethrough.

Therefore, the distance measurement light emitted from the distance measurement light source 71 passes through the space inside the casing 73, the central portion of the light projecting lens 72, the space between the guide plates 74L and 74R, and the through-hole 78a of the lens base 78, and is output to the outside of the distance measurement unit 7. The distance measurement light output in this manner is reflected by the seventh optical member 63 and the sixth optical member 62, and then transmitted through the first transmission window 11a and the fifth optical member 52 to be incident on the laser light scanning section 5B.

The distance measurement light incident on the laser light scanning section 5B is sequentially reflected by the first mirror 54a of the first scanner 54 and the second mirror 55a of the second scanner 55, and is emitted from the emission window 19 to the outside of the print head 1.

As described in the description of the laser light scanning section 5B, the distance measurement light can be scanned in the first direction on the surface of the workpiece W by adjusting the rotational attitude of the first mirror 54a of the first scanner 54. At the same time, the distance measurement light can be scanned in the second direction on the surface of the workpiece W by adjusting the rotational attitude of the second mirror 55a of the second scanner 55.

The distance measurement light thus scanned is reflected on the surface of the workpiece W. A part (hereinafter, this is also referred to as “reflected light”) of the distance measurement light reflected in this manner is incident on the inside of the print head 1 via the emission window 19. The reflected light incident on the inside of the print head 1 returns to the fifth optical member 52 via the laser light scanning section 5B. Since the reflected light has the same wavelength as the distance measurement light, the reflected light passes through the fifth optical member 52, and then enters the distance measurement unit 7 via the first transmission window 11a, the sixth optical member 62, and the seventh optical member 63.

### Distance measurement light receiving section 7B

The distance measurement light receiving section 7B includes the pair of light receiving elements 76L and 76R and the light receiving lens 77 supported by the lens base 78 described above. The pair of light receiving elements 76Land 76Ris disposed at the upper end portion of the support base 70, while the light receiving lens 77 and the lens base 78 are disposed at the lower end portion of the support base 70. Therefore, the pair of light receiving elements 76L and 76R, the light receiving lens 77, and the lens base 78 are arranged substantially along the longitudinal direction of the housing 10 and the support base 70.

In the pair of light receiving elements 76L and 76R, the optical axes Al and Ar are disposed in the housing 10 so as to sandwich the optical axis Ao of the distance measurement light in the distance measurement light emitting section 7A. The pair of light receiving elements 76L and 76R receives the reflected light (that is, the distance measurement light emitted from the distance measurement light emitting section 7A and reflected by the workpiece W) returned to the laser light scanning section 5B.

Specifically, the pair of light receiving elements 76L and 76R is arranged in a direction orthogonal to the optical axis Ao of the distance measurement light emitting section 7A. In this embodiment, the arrangement direction of the pair of light receiving elements 76L and 76R is equal to the lateral direction of the support base 70, that is, the front-rear direction of the housing 10. In the same direction, one light receiving element 76L is disposed on the left side of the distance measurement light source 71, and the other light receiving element 76R is disposed on the right side of the distance measurement light source 71.

Each of the pair of light receiving elements 76L and 76R has a light receiving surface 76a directed obliquely forward, detects the light receiving position of the reflected light on each light receiving surface 76a, and outputs a signal (detection signal) indicating the detection result. The detection signal output from each of the light receiving elements 76L and 76R is input to the printing controller 100 and reaches the distance measurement section 104 described above.

Here, the light receiving element 76L disposed on the left side of the distance measurement light source 71 is fixed in an attitude in which the light receiving surface 76a thereof is directed diagonally to the left front, and the light receiving element 76R disposed on the right side of the distance measurement light source 71 is fixed in an attitude in which the light receiving surface 76a thereof is directed diagonally to the right front.

Examples of an element that can be used as each of the light receiving elements 76L and 76R include a CMOS image sensor including a complementary MOS (CMOS), a CCD image sensor including a charge-coupled device (CCD), a light position sensor (position sensitive detector (PSD)), and the like.

In the present embodiment, each of the light receiving elements 76L and 76R is configured using the CMOS image sensor. In this case, each of the light receiving elements 76L and 76R can detect not only the light receiving position of the reflected light but also the light reception amount distribution (light reception waveform) thereof. That is, in a case where each of the light receiving elements 76L and 76R is configured using the CMOS image sensor, pixels are arranged on each of the light receiving surfaces 76a at least in the left-right direction. In this case, each of the light receiving elements 76L and 76R can read a signal for each pixel, amplify the signal, and output the amplified signal to the outside. The intensity of the signal at each pixel is determined on the basis of the intensity of the reflected light at a spot when the reflected light forms the spot on the light receiving surface 76a.

The pair of light receiving elements 76L and 76R according to the present embodiment can detect at least a peak position indicating a light receiving position of the reflected light and a light reception amount of the reflected light (intensity of the reflected light). For example, the height of the peak in the light reception amount distribution of the reflected light can be used as the index indicating the light reception amount. Alternatively, a sum, an average, and an integral of the light reception amount distributions may be used.

Furthermore, although the peak position (peak position of spot) of the light reception amount distribution is used as the index indicating the light receiving position of the reflected light in the present embodiment, the barycentric position of the light reception amount distribution may be used instead.

The light receiving lens 77 is disposed in the housing 10 such that the optical axes Al and Ar of the pair of light receiving elements 76L and 76R pass therethrough. The light receiving lens 77 is also provided in the middle of the optical path connecting the seventh optical member 63 and the pair of light receiving elements 76L and 76R, and can collect the reflected light reflected by the seventh optical member 63 to the light receiving surfaces 76a and 76a of the pair of light receiving elements 76L and 76R, respectively.

Note that, similarly to the pair of light receiving elements 76L and 76R, the light receiving lens 77 according to the present embodiment is configured as a pair of left and right light receiving lenses 77L and 77R. The pair of light receiving lenses 77L and 77R is arranged in a direction orthogonal to the optical axis Ao of the distance measurement light emitting section 7A.

One light receiving lens 77L located on the left side of the pair of light receiving lenses 77L and 77R is disposed such that the optical axis Al of one light receiving element 76L located on the left side of the pair of light receiving elements 76L and 76R passes therethrough. Similarly, one light receiving lens 77R located on the right side of the pair of light receiving lenses 77L and 77R is disposed such that the optical axis Ar of one light receiving element 76R located on the right side of the pair of light receiving elements 76L and 76R passes therethrough.

As illustrated in FIG. 19, the interval between the light receiving lenses 77L and 77R in the front-rear direction is shorter than the interval between the light receiving elements 76L and 76R in the same direction.

The pair of light receiving lenses 77L and 77R collects the reflected light returned to the laser light scanning section 5B, and forms spots of the reflected light on the light receiving surfaces 76a of the corresponding light receiving elements 76L and 76R. Each of the light receiving elements 76L and 76R outputs a signal indicating the peak position of the spot thus formed and the light reception amount to the distance measurement section 104.

The optical path followed by the reflected light inside the print head 1 deviates from the optical path followed by the distance measurement light at the time of emission according to the distance to the surface of the workpiece W. At this time, the magnitude of the distance to the surface of the workpiece W is reflected in the deviation of the optical path followed by the distance measurement light, and furthermore, in the light receiving position on the light receiving surface 76a of each of the light receiving elements 76L and 76R. Therefore, the distance to the surface of the workpiece W can be measured by detecting the light receiving position (the position of the peak of the spot in the present embodiment) on each light receiving surface 76a.

However, for example, as a result of long-term use of the print head 1, calibration of the distance measurement unit 7 may be required. For this purpose, it is conceivable to separately prepare a jig independent of the print head 1, but in the print head 1, the above-described calibration unit 9 is provided inside the housing 10 as a member corresponding to such a jig.

### Calibration unit 9

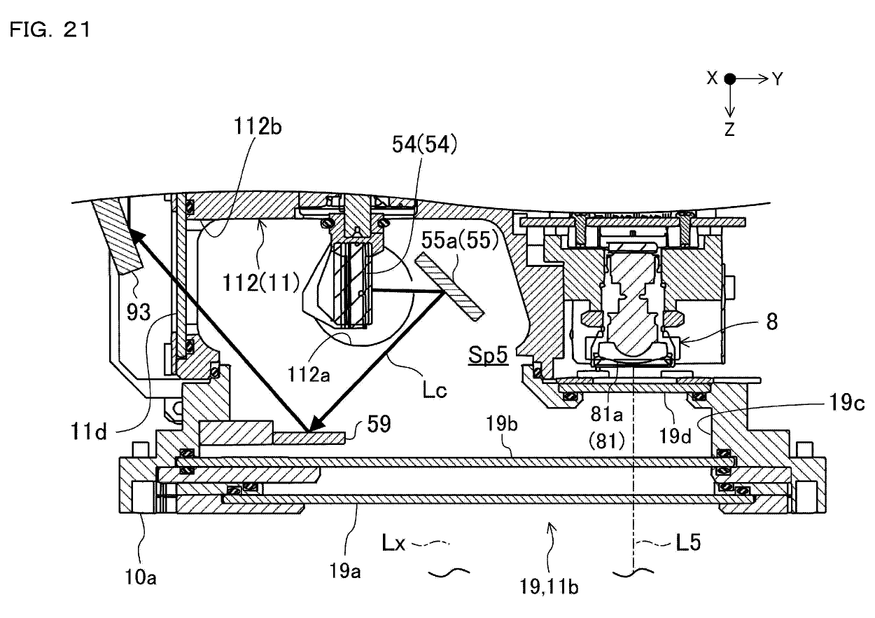

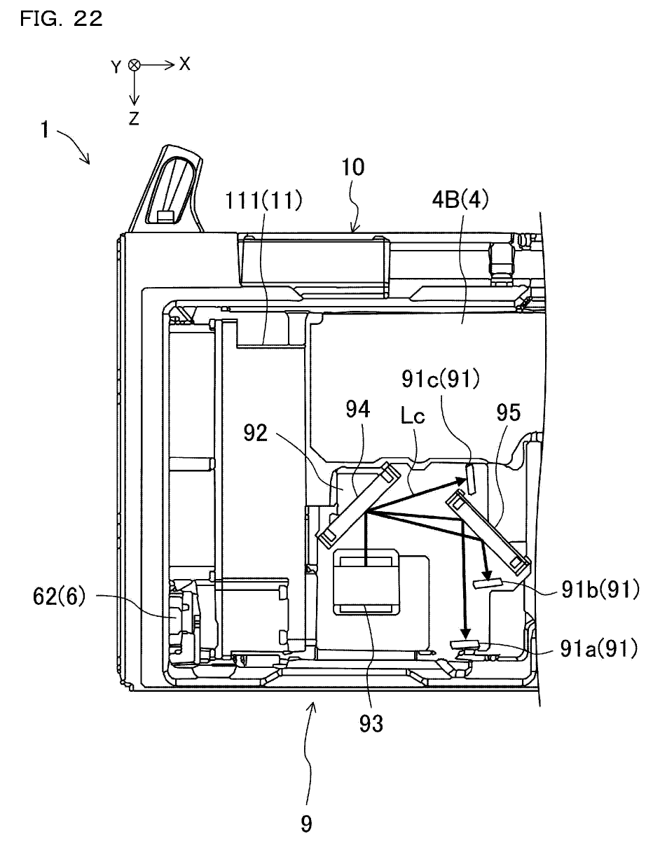

FIG. 21 is a transverse cross-sectional view illustrating the calibration optical path Lc. FIG. 22 is a side view illustrating the configuration of the calibration unit 9 and the calibration optical path Lc.

### Overall configuration

The calibration unit 9 includes, as main constituent elements, a plurality of reference members 91 and a support member 92 that supports each of the reference members 91. The calibration unit 9 also includes a first relay mirror 93, a second relay mirror 94, and a third relay mirror 95 that optically couple the laser light scanning section 5B and each of the plurality of reference members 91.

The calibration by the calibration unit 9 uses the distance measurement light emitted from the distance measurement unit 7 described above, particularly the distance measurement light emitting section 7A. For example, as illustrated in FIG. 4C, at the time of calibration, the distance measurement light reflected not on the surface of the workpiece W but on the surface of each reference member 91 is received by the distance measurement light receiving section 7B, and the distance measurement unit 7 can be calibrated on the basis of the light receiving position. In this case, the distance measurement unit 7 emits red laser light having a wavelength of about 690 nm as in the case of measuring the distance to the surface of the workpiece W.

However, in the following description, in order to clarify the distinction between the time of distance measurement and the time of calibration, distance measurement light for measuring the distance from the laser printing apparatus L to the surface of the workpiece W may be referred to as “first distance measurement light”, and distance measurement light for correcting (calibrating) the measurement result may be referred to as“ second distance measurement light”.

That is, the distance measurement light emitting section 7A as the distance measurement light generation section can emit, to the reference member 91 via the laser light scanning section 5B, distance measurement light (second distance measurement light) for correcting the measurement result of the distance from the laser printing apparatus L to the surface of the workpiece W.

The distance measurement light receiving section 7B can receive the first distance measurement light (hereinafter, also referred to as "first reflected light") reflected by the workpiece W and the second distance measurement light (hereinafter, also referred to as "second reflected light") reflected by each reference member 91 as the laser light scanning section 5B.

Here, the fifth optical member 52 as the merging mechanism Mc can merge the first distance measurement light or the second distance measurement light emitted from the distance measurement light emitting section 7A with the downstream laser optical path L12 and separate the first reflected light or the second reflected light from the downstream laser optical path L12 to guide the first reflected light or the second reflected light to the distance measurement light receiving section 7B.

Here, as illustrated in FIGS. 4C and 22, each reference member 91 is disposed inside the housing 10 and outside the sealing section 11. Each reference member 91 constitutes a calibration optical path Lc connected to the distance measurement light emitting section 7A via the laser light scanning section 5B.

Specifically, each reference member 91 is disposed at a position corresponding to the other end of the calibration optical path Lc that has the distance measurement light emitting section 7A at one end and passes through the laser light scanning section 5B. As an example, the calibration optical path Lc according to the present embodiment is configured in a case where at least one of the first scanner 54 and the second scanner 55 is in the specific rotational attitude described above.

More specifically, the calibration optical path Lc is an optical path having the distance measurement light emitting section 7A as one end and each reference member 91 as the other end, and passes through the laser light scanning section 5B while traveling between the distance measurement light emitting section 7A and each reference member 91.

Furthermore, the plurality of reference members 91 is disposed such that the optical path lengths of the calibration optical paths Lc corresponding to the reference members are predetermined reference distances. Specifically, the reference distance corresponding to each reference member 91 is measured at the time of manufacturing the print head 1. The measured reference distance is stored in advance in the storage section 101 as a reference distance storage section.

In the present embodiment, the plurality of reference members 91 include the first reference member 91a, the second reference member 91b, and the third reference member 91c in which the corresponding optical paths for calibration Lc and the optical path lengths thereof are different from each other.

Note that the reference distance may not coincide with the optical path length of the calibration optical path Lc. The reference distance may be, for example, a length of a section connecting the laser light scanning section 5B and each reference member 91, or may be a length of a section connecting one of the mirrors and each reference member 91 in a case where the first relay mirror 93, the second relay mirror 94, and the third relay mirror 95 are disposed between the laser light scanning section 5B and each reference member 91 as described later.

Furthermore, the first mirror 54a of the first scanner 54 and the second mirror 55a of the second scanner 55 are disposed in order between the distance measurement light emitting section 7A and each reference member 91 in the calibration optical path Lc.

Therefore, the second distance measurement light emitted from the distance measurement light emitting section 7A is sequentially reflected by the first mirror 54a and the second mirror 55a and applied to each reference member 91. Here, the second mirror 55a and each reference member 91 may be directly coupled to each other without an optical component such as a reflecting mirror interposed therebetween, or may be indirectly coupled to each other with one or more optical components interposed therebetween. In the present embodiment, the latter indirect coupling is adopted.

As illustrated in FIGS. 21 to 22, the print head 1 according to the present embodiment includes a reflection mirror that guides the second distance measurement light scanned by the second scanner 55 to the reference member 91. The reflection mirror is disposed between the second scanner 55 and each reference member 91 in the calibration optical path Lc.

Specifically, the print head 1 according to the present embodiment includes an internal relay mirror 59 disposed inside the sealing section 11, and a first relay mirror 93, a second relay mirror 94, and a third relay mirror 95 in order from the second scanner 55 toward each reference member 91. Each of these relay mirrors is laid out so as to totally reflect the second distance measurement light.

### Internal relay mirror 59

As illustrated in FIG. 21, the internal relay mirror 59 is disposed inside the second sealing member 112. The internal relay mirror 59 is disposed substantially below the first mirror 54a in an attitude with its mirror surface facing upward.

For details, the internal relay mirror 59 is attached to the vicinity of the peripheral edge portion of the emission window 19 (specifically, the outer side of the peripheral edge portion), and is disposed at a portion near the lower end in the first accommodation space Sp1. The internal relay mirror 59 is disposed such that the second distance measurement light reflected by the mirror surface of the second mirror 55a is incident on the internal relay mirror 59 when the second scanner takes a specific rotational attitude. The second distance measurement light reflected by the internal relay mirror 59 is emitted from the laser light scanning section 5B via the fourth transmission window 11d and is incident on the first relay mirror 93.

The above-described specific rotational attitude is at least an attitude in which the second mirror 55a is directed to the mirror surface of the internal relay mirror 59. Since the internal relay mirror 59 is provided outside the peripheral edge portion of the emission window 19, the path connecting the second mirror 55a and the internal relay mirror 59 does not pass through the emission window 19. In a case where such a path passes through the emission window 19, the scannable region is limited by the second scanner 55 at the time of non-calibration, but the scannable region can be secured as much as possible by performing layout so as not to pass through the emission window 19.

### First relay mirror 93

As illustrated in FIGS. 21 to 22, the first relay mirror 93 is disposed on the right side of the second scanner 55 in an attitude in which the mirror surface is directed obliquely upward to the left. Specifically, the first relay mirror 93 is fixed to the support member 92, and is disposed such that the second distance measurement light reflected by the internal relay mirror 59 is incident.

The second distance measurement light reflected by the first relay mirror 93 is incident on one of the plurality of reference members 91 according to the rotational attitudes of the first scanner 54 and the second scanner 55. When the second distance measurement light is incident on any of the plurality of reference members 91, the second distance measurement light passes through at least the second relay mirror 94 of the second relay mirror 94 and the third relay mirror 95.

### Second relay mirror 94

As illustrated in FIG. 22, the second relay mirror 94 is disposed above the first relay mirror 93 in an attitude with its mirror surface facing obliquely downward and rearward. Specifically, the second relay mirror 94 is fixed to the support member 92, and is disposed such that the second distance measurement light reflected by the first relay mirror 93 is incident.

The second distance measurement light reflected by the second relay mirror 94 is incident on the third reference member 91c or the third relay mirror 95 according to the rotational attitudes of the first scanner 54 and the second scanner 55.

### Third relay mirror 95

As illustrated in FIG. 22, the third relay mirror 95 is disposed behind the second relay mirror 94 in an attitude with its mirror surface facing obliquely downward and forward. Specifically, the third relay mirror 95 is fixed to the support member 92, and is disposed such that the second distance measurement light reflected by the second relay mirror 94 is incident on the third relay mirror 95.

The second distance measurement light reflected by the third relay mirror 95 is incident on the first reference member 91a or the second reference member 91b according to the rotational attitudes of the first scanner 54 and the second scanner 55.

### Support member 92

The support member 92 is disposed in a space on the right side of the second sealing member 112 in the first accommodation space Sp1. Specifically, the support member 92 is a substantially plate-like member extending along the ZX plane, and is disposed on the right of the laser light scanning section 5B.

The first relay mirror 93, the second relay mirror 94, the third relay mirror 95, and each reference member 91 are fixed to the right side surface of the support member 92. These optical components are located on the opposite side of the laser light scanning section 5B with the support member 92 interposed therebetween.

### Reference member 91

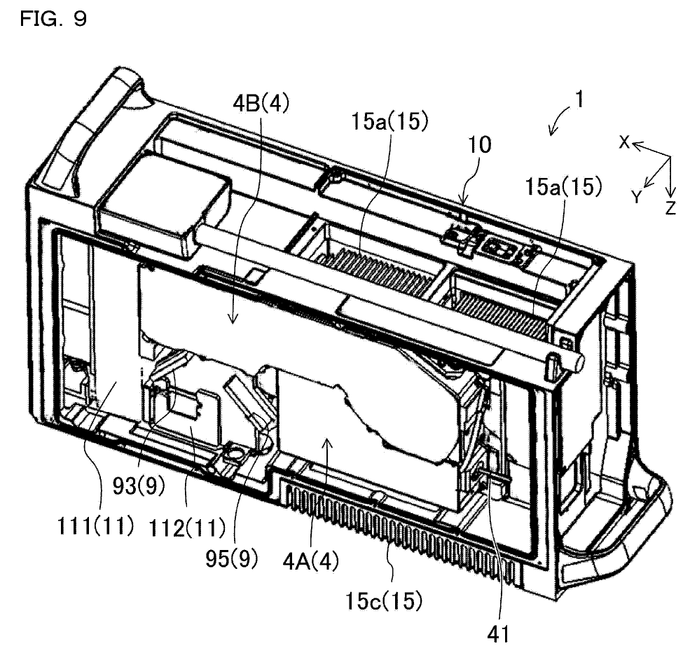

As illustrated in FIGS. 9 and 22, the plurality of reference members 91 are erected on the left side surface of the support member 92, and are arranged in order from the upper side to the lower side. Each reference member 91 may be made of a material that hardly generates so-called regular reflection light. For example, each reference member 91 can be configured using a so-called scatterer material, specifically, ceramic, paper, a material having a coated surface, a matted material, or the like.

In the present embodiment, each reference member 91 is made of ceramic, and diffusely reflected light as illustrated in FIG. 10A is likely to be generated. In this case, the intensity distribution of the reflected light received by the light receiving surface 76a of the distance measurement unit 7 substantially coincides with the normal distribution.

As illustrated in FIG. 22, the first reference member 91a, the second reference member 91b, and the third reference member 91c are arranged in this order from below, are disposed behind the second relay mirror 94 and at substantially the same positions as the third relay mirror 95 in the front-rear direction, and are disposed at substantially the same positions in the left-right direction.

The first reference member 91a is disposed below the second reference member 91b, the third relay mirror 95, and the third reference member 91c in an attitude with its light receiving surface facing upward.

The second reference member 91b is disposed above the first reference member 91a and below the third relay mirror 95 and the third reference member 91c in an attitude with its light receiving surface facing upward.

The third reference member 91c is disposed above the first reference member 91a, the second reference member 91b, and the third relay mirror 95 in an attitude with its light receiving surface facing forward.

In this way, by making the height positions of the plurality of reference members 91 different from each other, the plurality of reference members 91 is disposed such that the optical path lengths of the calibration optical paths Lc corresponding to the respective reference members are different from each other, and thus the respective reference distances are different from each other.

Furthermore, the calibration optical path Pc is reflected by the first mirror 54a and the second mirror 55a in order to extend obliquely downward, and then folded back by the internal relay mirror 59 and the first relay mirror 93 to extend obliquely upward. By providing such a folding, the optical path length of the calibration optical path Pc can be extended.

Moreover, as illustrated in FIG. 22, the calibration optical path Pc folded back by the internal relay mirror 59 and the first relay mirror 93 is folded back by the second relay mirror 94 and the third relay mirror 95 and extends obliquely downward. In this way, the optical path length of the calibration optical path Pc can be further extended by providing the additional folding. The extension of the optical path length of the calibration optical path Pc contributes to improvement of calibration accuracy by the calibration unit 9.

Furthermore, by extending the optical path length by folding, interference with other components in the housing 10 such as the wavelength conversion section 4B can be suppressed. This contributes to the compactness of the print head 1.

Moreover, as illustrated in FIG. 22, by interposing the third relay mirror 95 between the second reference member 91b and the third reference member 91c, it is possible to widen the difference between the reference distances d1 and d2 related to the first and second reference members 91a and 91b and the reference distance d3 related to the third reference member 91c. This also contributes to improvement of calibration accuracy by the calibration unit 9.

The storage section 101 as a reference distance storage section stores the reference distance d1 corresponding to the first reference member 91a, the reference distance d2 corresponding to the second reference member 91b, and the reference distance d3 corresponding to the third reference member 91c.

The optical path followed by the second reflected light in the print head 1 deviates from the optical path followed by the second distance measurement light at the time of emission according to the distance to the selected reference member 91. The magnitude of the distance at that time is reflected on the light receiving position on the light receiving surface 76a of each of the light receiving elements 76L and 76R. Therefore, the distance to the reference member 91 can be measured by detecting the light receiving position (peak position of the spot in the present embodiment) on each light receiving surface 76a.

In this manner, the laser printing apparatus L can basically measure the distance to the surface of the workpiece W or the reference member 91 on the basis of the light receiving position of the reflected light on the light receiving surface 76a of each of the light receiving elements 76L and 76R regardless of the time of distance measurement or calibration. As a distance measurement method, a so-called triangulation method is used.

### 5. Measurement method of distance

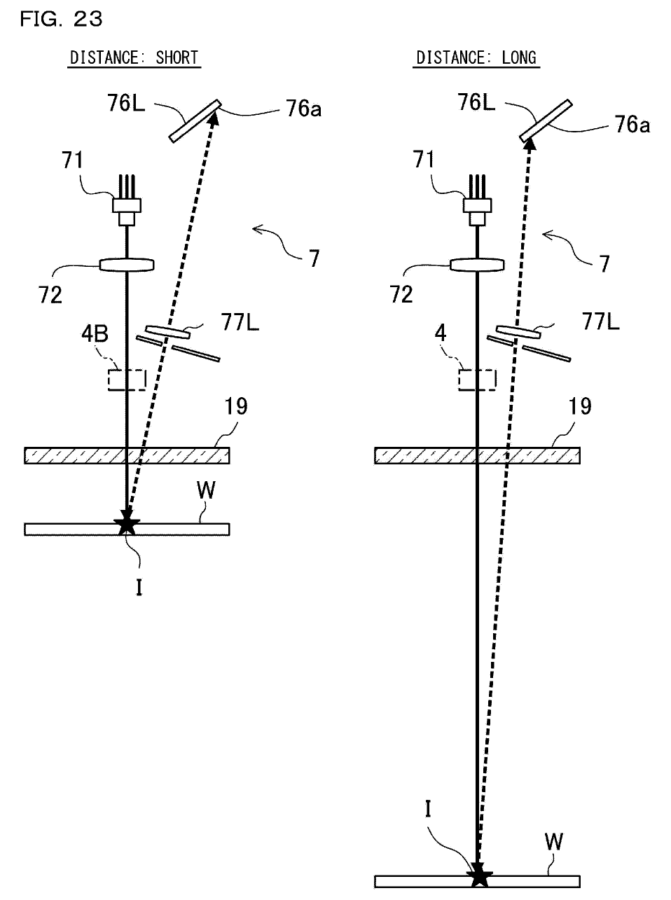

FIG. 23 is a diagram for explaining a triangulation method. Although only the distance measurement unit 7 is illustrated in FIG. 23, the following description is also applicable to a case where distance measurement light is emitted via the laser light scanning section 5B as described above.

As illustrated in FIG. 23, when the distance measurement light is emitted from the distance measurement light source 71 in the distance measurement light emitting section 7A, the surface of the workpiece W is irradiated with the distance measurement light. When the distance measurement light is reflected by the workpiece W, the reflected light (particularly, diffuse reflection light) propagates substantially isotropically if the influence of specular reflection is excluded.

The reflected light propagating in this manner includes a component incident on the light receiving element 76L via the light receiving lens 77L, but the incident angle on the light receiving element 76L increases or decreases according to the distance between the print head 1 and the workpiece W. When the incident angle on the light receiving element 76L increases or decreases, the light receiving position on the light receiving surface 76a increases or decreases.

In this manner, the distance between the print head 1 and the workpiece W and the light receiving position on the light receiving surface 76a are associated with each other with a predetermined relationship. Therefore, by grasping the relationship in advance and storing the relationship in, for example, the printing controller 100, the distance between the print head 1 and the workpiece W from the light receiving position on the light receiving surface 76a can be calculated. Such a calculation method is nothing but a method using a so-called triangulation method.

That is, the distance measurement section 104 measures the distance to the surface of the workpiece W by a triangulation method on the basis of the light receiving position of the distance measurement light in the distance measurement light receiving section 7B. For details, the distance measurement section 104 according to the present embodiment measures the distance from the print head 1 to the surface of the workpiece W by a triangulation method on the basis of the light receiving positions of the distance measurement light in the pair of light receiving elements 76.

Specifically, the storage section 101 previously stores the relationship between the light receiving position on the light receiving surface 76a and the distance between the print head 1 and the surface of the workpiece W. On the other hand, a signal indicating a light receiving position of the distance measurement light in the distance measurement light receiving section 7B, specifically, a peak position of a spot formed on the light receiving surface 76a by the reflected light is input to the distance measurement section 104.

The distance measurement section 104 measures the distance to the surface of the workpiece W on the basis of the signal thus input and the relationship stored in the storage section 101. The measured value obtained in this manner is input to, for example, the head control section 102, and is used for control of the focus adjustment section 53 and the like by the head control section 102.

On the other hand, when calibrating the distance measurement unit 7, the distance measurement light emitting section 7A emits distance measurement light to one of the plurality of reference members 91 instead of the workpiece W illustrated in FIG. 23. The distance measurement light receiving section 7B receives the distance measurement light reflected by the reference member 91 via the laser light scanning section 5B.

Similarly to the measurement of the distance to the surface of the workpiece W, the distance measurement section 104 measures the distance to the reference member 91 which is a target of emission of the distance measurement light on the basis of the light receiving position of the distance measurement light in the distance measurement light receiving section 7B.

### 6. Method of using laser printing system

### Outline of usage method

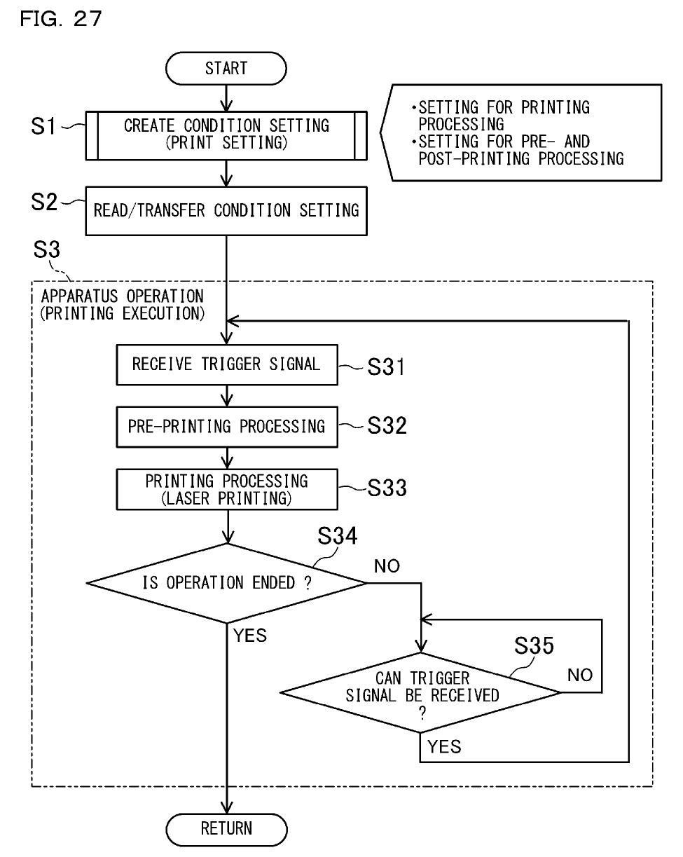

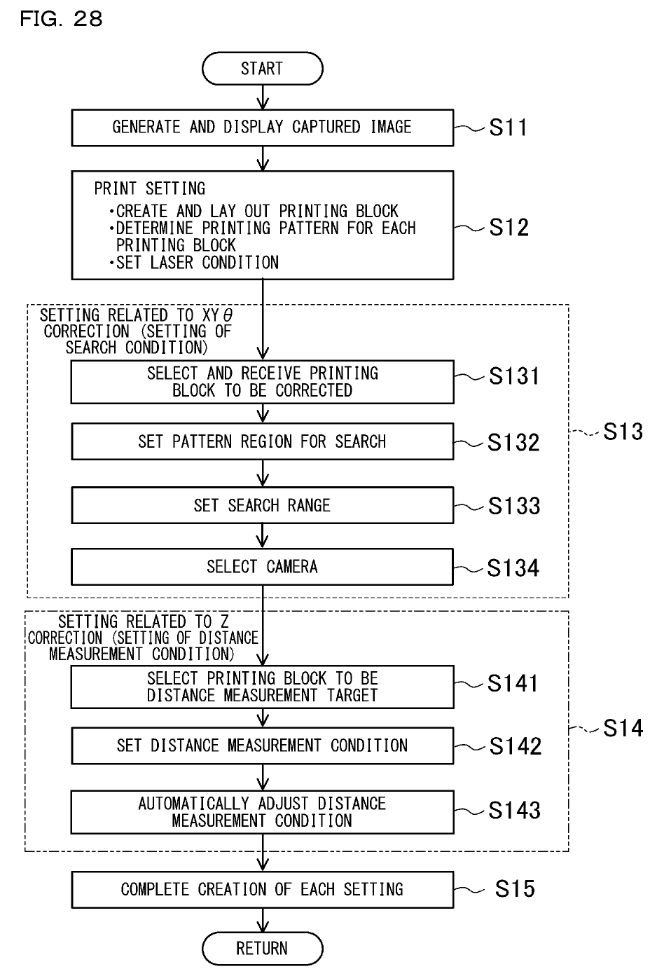

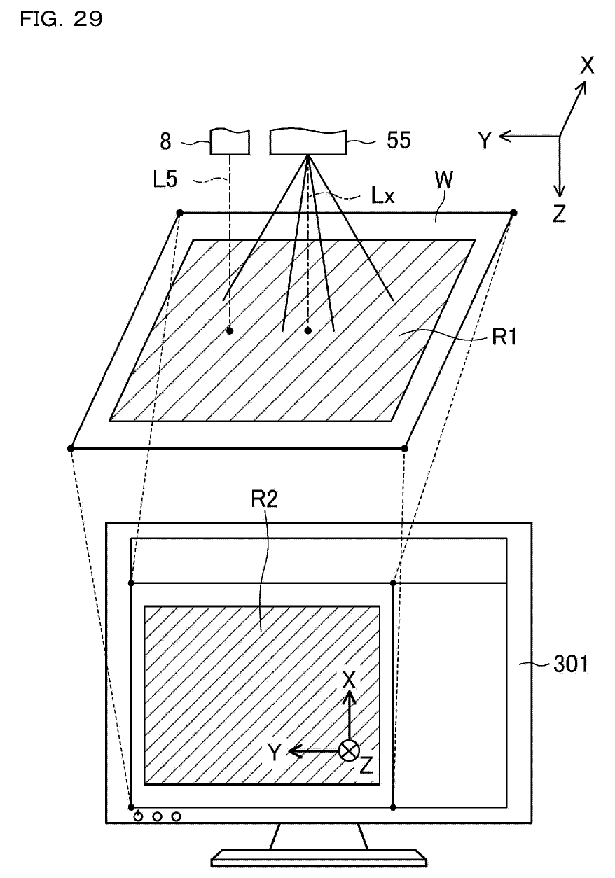

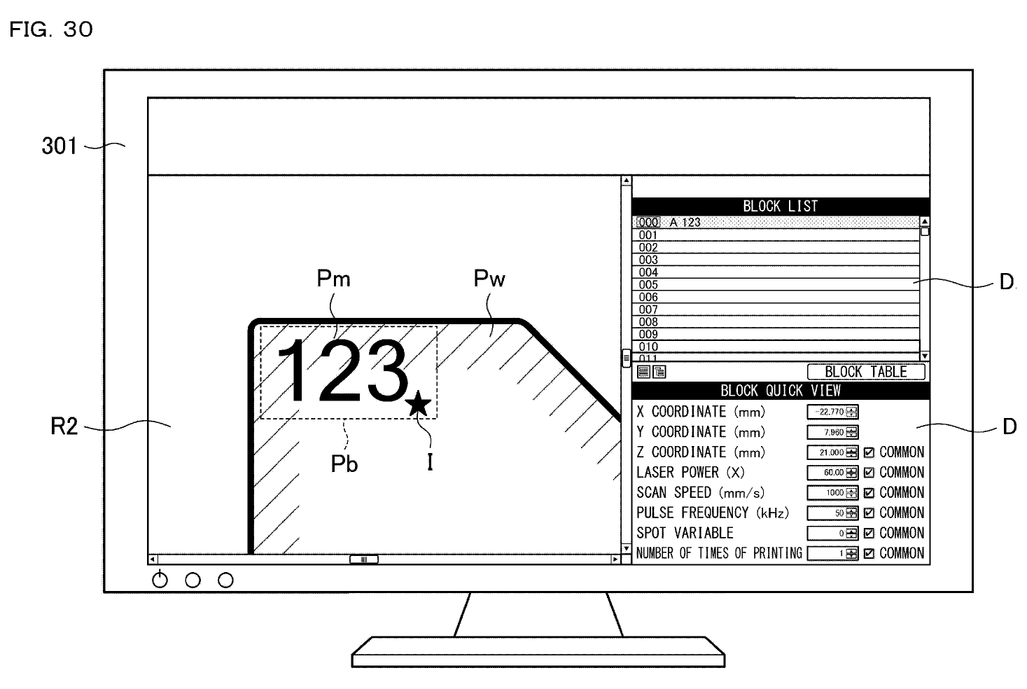

FIG. 27 is a flowchart illustrating a usage procedure of the laser printing system S. FIG. 28 is a flowchart illustrating processing related to print setting and workflow editing. FIG. 29 is a diagram illustrating a relationship between the printing region R1 and the setting surface R2. FIG. 30 is a diagram illustrating display contents on the display section 301.

The laser printing system S including the laser printing apparatus L can be installed and operated, for example, in a conveyance line on which a plurality of workpieces W is sequentially conveyed, such as a manufacturing line of a factory. In the operation, first, prior to the operation of the conveyance line, condition settings such as the installation position of the workpiece W to flow through the conveyance line and the output of the printing laser light and the distance measurement light with which the workpiece W is irradiated are created (step S1 in FIG. 27).

The setting contents created in step S1 are stored in the printing controller 100 after being created in advance, or are read by the printing controller 100 immediately after being created (step S2 in FIG. 27).

Then, when the conveyance line is operated, the printing controller 100 refers to the setting contents stored in advance or read immediately after the creation. The laser printing apparatus L is operated on the basis of the referred setting contents, and sequentially executes laser printing on each workpiece W supplied via the conveyance line (step S3 in FIG. 27).

Hereinafter, the workpiece W to be used in various settings such as the condition setting may be referred to as a "preparation workpiece W" or a "setting target W", and each workpiece W sequentially conveyed as a printing target as a result of moving the conveyance line may be referred to as a "new workpiece W’" or a "printing target W’". In a case where it is not necessary to distinguish the setting target W and the printing target W’, the setting target W and the printing target W’ may be simply referred to as “workpiece W”.

Furthermore, a reference sign "Pw" may be assigned to a captured image generated by capturing an image of the preparation workpiece W by the coaxial camera 65 or the wide-area camera 8, and a reference sign "Pw’" may be assigned to a captured image generated by capturing an image of the "printing target W’". In a case where it is not necessary to distinguish the setting target W and the printing target W’, the image may be simply referred to as "captured image Pw”.

Here, as exemplified in substeps S31 to S33 constituting step S3, the printing controller 100 of the laser printing apparatus L executes a series of processing including printing processing and another processing added as necessary when operating the device L. The printing controller 100 is an example of a "control section" in the present embodiment. Hereinafter, the "substep" is simply referred to as a "step".

Although details will be described later, the series of processing is processing executed by the printing controller 100 as a control section from when the trigger signal is input to the trigger signal receiving section 103 to when the trigger signal receiving section 103 transitions to a state where it can receive the input of a trigger signal again, as shown in steps S31 and S35.

The “another processing" mentioned here includes a "pre-printing processing (step S32)" performed before the execution of the printing processing on the basis of an anteroposterior relationship with the printing processing (step S33). The pre-printing processing according to the present embodiment includes “XYθ correction” and “Z correction”.

Hereinafter, specific examples of "print setting in laser printing" and "setting related to pre-printing processing" will be described in order on the basis of step S1 of the flow of FIG. 27.

### Procedure for creating each setting

FIG. 28 illustrates a specific process in step S1 of FIG. 27. As illustrated in FIG. 27, in the present embodiment, a control process related to print setting, a control process related to search setting related to XYθ correction, and a control process related to distance measurement setting related to Z correction are executed in order. Each control process is configured as an independent process.

First, in step S11, the coaxial camera 65 or the wide-area camera 8 built in the laser printing apparatus L generates the captured image Pw including at least a part of the printing region R1. The captured image Pw generated by the coaxial camera 65 or the wide-area camera 8 is output to the setting device 300.

The display section 301 of the setting device 300 displays the setting surface R2 associated with the printing region R1 and displays the captured image Pw on the setting surface R2 (see FIGS. 29 and 30). The captured image Pw is superimposed and displayed on the setting surface R2.

Therefore, the coordinate system (virtual coordinate system) defined on the setting surface R2 of the display section 301 can be associated with the coordinate system (camera coordinate system) defined on the captured image Pw (see the XYZ direction in FIG. 10).

In subsequent step S12, the print setting section 304a determines the print setting. The print setting section 304a reads the content stored in the storage section 303 or the like or reads an operation input or the like via the setting device 300 to determine the print setting.

### Creation of print setting

The print setting includes a printing pattern Pm indicating a print content (marking shape) and printing conditions indicating various settings and conditions related to the printing pattern Pm. The printing conditions include at least a setting related to the printing block Pb indicating the position of the printing pattern Pm.

In the present embodiment, the print setting section 304a illustrated in FIG. 3 sets the position and attitude of the printing pattern Pm to be printed on the workpiece W on the setting surface R2 displayed on the display section 301. The position and attitude of the printing pattern Pm can be set via the printing block Pb. The term "attitude of the printing pattern Pm" includes a rotation angle (θ) of the printing pattern Pm on the XY plane.

The printing block Pb can be used to adjust the layout (position), size, rotational attitude, and the like of the printing pattern Pm. Furthermore, the printing block Pb is used in association with an irradiation position (distance measurement position I) of the distance measurement light set on the surface of the workpiece W.

The display section 301 can display the printing pattern Pm and the printing block Pb to be superimposed on the captured image Pw. For example, in FIG. 30, a printing pattern Pm including a number "123" and a rectangular printing block Pb surrounding the printing pattern Pm are disposed on the setting surface R2 on the surface of the workpiece W. As illustrated in the drawing, the display section 301 displays the printing pattern Pm and the printing block Pb disposed in this manner so as to be superimposed on the captured image Pw.

Note that the shape of the printing block Pb is not limited to the illustrated example. Any shape can be used as long as the shape suggests the position and size of the printing pattern Pm. In addition, in the first place, the terms "printing pattern" and "printing block" are merely introduced for convenience, and are not intended to limit their applications.

Furthermore, although not illustrated, a plurality of workpieces W may be displayed on the setting surface R2, or only one workpiece W may be displayed as illustrated in FIG. 30. Furthermore, a plurality of printing blocks Pb may be disposed on one workpiece W, or one or a plurality of printing blocks Pb may be disposed on a part or all of the plurality of workpieces W.

Returning to step S12 of FIG. 28, in the same step, for example, the user manually creates the printing block Pb and disposes the printing block Pb on the setting surface R2. Since the setting surface R2 and the captured image Pw are associated with each other as described above, the user can dispose the printing block Pb while visually recognizing the captured image Pw.

Then, when one or more printing blocks Pb are disposed, the user determines a printing pattern Pm for each printing block Pb. The printing pattern Pm is determined, for example, when the user operates the operation section 302, and the print setting section 304a receives an operation input at that time via the reception section 304e.

Note that the printing conditions included in the print setting may include a condition related to UV laser light (hereinafter, referred to as "laser conditions") in addition to the setting related to the printing block Pb.

The laser conditions include one or more of the irradiation position of the UV laser beam, the target output (laser power) of the UV laser beam, the scanning speed (scan speed) of the UV laser beam by the laser light scanning section 5B, the repetition frequency (pulse frequency) of the UV laser beam, whether or not the laser spot of the UV laser beam is made variable (spot variable), and the number of times the UV laser beam traces the printing pattern Pm (number of times of printing). As illustrated in a menu D1 displayed at the lower right of FIG. 30, such printing conditions (laser conditions) can be set for each printing block Pb.

The laser condition is determined, for example, when the user inputs a numerical value or the like to each item in the menu D1 via the operation section 302, and the print setting section 304a receives the input content at that time via the reception section 304e.

The print setting section 304a reads the printing block Pb disposed in this manner and the printing pattern Pm and the laser condition determined for each printing block Pb, and determines a combination thereof in the print setting. The print setting section 304a according to the present embodiment temporarily or continuously stores the coordinates (coordinates in the printing coordinate system) of the printing block Pb on the setting surface R2 in the storage section 303 or the like.

As described above, since the setting surface R2 is displayed so as to be superimposed on the captured image Pw, the print setting section 304a according to the present embodiment sets the printing block Pb so as to be superimposed on the captured image Pw.

Specifically, the print data includes at least the coordinates and the rotation angle (coordinates and attitude in the printing coordinate system) of the printing block Pb on the setting surface R2, and is temporarily or continuously stored in the storage section 303 or the like.

The print data according to the present embodiment includes at least data related to the position and orientation of the printing pattern Pm, that is, data related to the printing block Pb.

When the print data is generated, the setting device 300 advances the control process from step S12 to step S13. In step S13, the setting device 300 performs the above-described search setting.

### Creation of search settings

Generally, each workpiece W sequentially subjected to laser printing when the conveyance line is operated may be displaced in the X direction and the Y direction (XY direction). Moreover, each workpiece W may have a deviation in attitude (attitude deviation) due to rotation on the XY plane. When the deviation occurs in the position and the attitude of the workpiece W, a relative positional relationship between the workpiece W and the printing point of the UV laser light also deviates, which is disadvantageous.

In response to such a disadvantage, the laser printing apparatus L according to the present embodiment can correct the deviation of the position and attitude of the workpiece W by using various methods. Hereinafter, in order to distinguish from the deviation in the Z direction described later, the deviation of the position of the workpiece W in the XY direction and the deviation of the attitude of the workpiece W due to the rotation on the XY plane are collectively referred to as "XY deviation". The XY deviation is different for each workpiece W conveyed by the conveyance line, and can be rephrased as a position and attitude error (workpiece error) for each workpiece W.

The influence of the XY deviation on the laser printing can be reduced or eliminated by correcting the deviation of the position and attitude of the printing pattern Pm for each workpiece W.

In other words, due to the XY deviation of the workpiece W, the printing pattern Pm printed on the workpiece W has relative deviation in position and attitude with respect to the workpiece W. The laser printing apparatus L according to the present embodiment can correct (that is, the correction of the printing pattern related to the XY deviation) the position in the XY direction and the attitude on the XY plane of the printing pattern so as to reduce or eliminate the latter deviation.

As an example, in the case of the present embodiment, the position and attitude of the printing pattern Pm are adjusted via the position and attitude of the printing block Pb. The laser printing apparatus L can adjust the printing block Pb by correcting the printing data, and perform the above-described "correction of the printing pattern Pm relating to the XY deviation" through the adjustment. As a result, the deviation in the relative position and attitude of the printing

pattern Pm with respect to the workpiece W due to the XY deviation of the workpiece W is corrected via the printing block Pb corresponding to the printing pattern Pm. Note that the correction through the printing block Pb is not essential.

Therefore, in step S13 subsequent to step S12, the region setting section 304c of the setting device 300 creates condition setting (search setting) for correcting the printing pattern related to the XY deviation. The laser printing apparatus L according to the present embodiment is configured to use pattern search as a method for correcting the printing pattern related to the XY deviation.

In order to use the pattern search, the region setting section 304c sets, on the captured image Pw, a pattern region Rp searched to specify the XY deviation of the workpiece W and a search region Rs defining a range in which the pattern region Rp is searched as conditions (search conditions) related to the pattern search. Note that the pattern region Rp is a region for correcting print data by the correction processing section 105, and is an example of a “correction region” in the present embodiment.

Note that it is not essential to set a part of the captured image Pw to the search region Rs (Setting of the search region Rs is not essential in the search condition). Instead of setting the search region Rs, the pattern search can be executed for the entire captured image Pw. Even in the case of such a configuration, processing equivalent to the following can be performed by treating the entire captured image Pw similarly to the search region Rs.

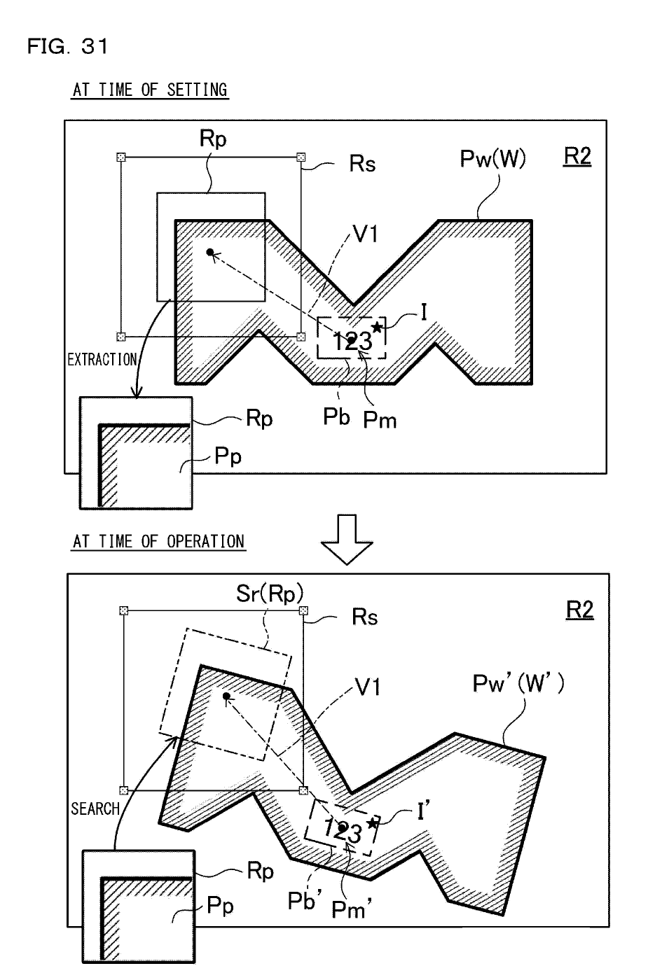

Hereinafter, a specific setting procedure of the search condition will be described with reference to FIG. 31.

First, in the first substep (step S131) in step S13, for example, the processing section 304 selects the printing block Pb to be corrected, more precisely, the printing block Pb to be corrected of the printing pattern Pm related to the XY deviation. The printing block Pb to be corrected of the printing pattern Pm related to the XY deviation is a printing block Pb corresponding to a correction candidate of the printing data by the correction processing section 105.

Subsequently, in the second substep (step S132) in step S13, the region setting section 304c sets the pattern region Rp for the captured image Pw displayed on the display section 301 (see FIG. 12). The position, attitude, and size of the pattern region Rp are determined for the captured image Pw, for example.

Note that, in the example illustrated in FIG. 31, the pattern region Rp is set so as to surround the printing pattern Pm, but the setting is not limited thereto. The pattern region Rp can also be set so as not to surround the printing pattern Pm.

Furthermore, as illustrated in FIG. 31, the region setting section 304c extracts the image information in the pattern region Rp. The image information may be a pattern image Pp obtained by extracting the captured image Pw in the pattern region Rp, or may be edge information of the captured image Pw in the pattern region Rp.

Furthermore, as illustrated in FIG. 31, the region setting section 304c stores a relative positional and postural relationship (hereinafter, this is referred to as a "relative positional relationship") between the pattern region Rp and the printing block Pb in the storage section 303 in association with the image information.

Subsequently, in the third substep (step S133) in step S13, the region setting section 131 sets the search region Rs used in the pattern search on the basis of the user input (see FIG. 31). The search region Rs may be set to include at least the pattern region Rp. The position, attitude, and size of the search region Rs are determined with respect to the setting surface R2, for example.

Note that it is not essential to set the search region Rs. Instead of setting the search region Rs, the pattern search can be executed for the entire captured image Pw. Even in the case of such a configuration, processing equivalent to the following can be performed by treating the entire captured image Pw similarly to the search region Rs.

The set search region Rs is stored in the storage section 303 or the like.

Subsequently, in the fourth substep (step S134) in step S13, the camera selection section 304f selects one of the coaxial camera 65 and the wide-area camera 8 on the basis of the size of the pattern region Rp as a correction region.

Specifically, the camera selection section 304f compares the size of the search region Rs set on the basis of the pattern region Rp with the visual field size of the coaxial camera 65, and determines whether or not the size of the search region Rs is equal to or smaller than the visual field size.

In a case where the determination is YES, the camera selection section 304f selects the coaxial camera 65. In this case, the head control section 102 of the printing controller 100 uses the coaxial camera 65 in pattern search related to the pattern region Rp1.

On the other hand, in a case where the determination is NO, the camera selection section 304f selects the wide-area camera 8. In this case, the head control section 102 of the printing controller 100 uses the wide-area camera 8 in pattern search related to the pattern region Rp.

The search conditions set in this manner are stored as search settings in the storage section 303 or the like. When the creation of the search setting is completed, the print setting section 304a proceeds from step S13 to step S14.

### Creation of distance measurement setting

In general, each workpiece W to be sequentially machined when the manufacturing line is operated is displaced in the Z direction. Such a positional deviation is undesirable because it causes a deviation in the focal position of the UV laser light.

Since the laser printing apparatus L according to the present embodiment includes the distance measurement unit 7, it is possible to detect the positional deviation in the Z direction on the basis of the distance to the surface of the workpiece W. Therefore, it is possible to correct the positional deviation in the Z direction and eventually the deviation of the focal position. Therefore, in step S14 subsequent to step S13, condition setting (distance measurement setting) for correcting the positional deviation in the Z direction is created.

Specifically, in step S14, a condition related to the distance measurement unit 7 (distance measuring condition) is determined. The print setting section 304a according to the present embodiment sets at least a distance measurement position I for measuring the distance from the print head 1 to the surface of the workpiece W on the captured image Pw as the distance measurement condition (see FIG. 30). The distance measurement position I is basically set so as to overlap the surface of the setting object W, and indicates coordinates to be irradiated with distance measurement light.

Note that, in a case where a plurality of printing blocks Pb is set, the print setting section 304a can set a distance measurement condition for each printing block Pb. In this case, the print setting section 304a can set the distance measurement position I in each printing block Pb (see the star in FIGS. 30 and 31). Alternatively, the print setting section 304a may set the distance measurement position I outside each printing block Pb.

First, in the first substep (step S141) in step S14, the printing block Pb to be a target of distance measurement (distance measurement target) is determined. Here, it is possible to select whether to set all the printing blocks Pb as distance measurement targets, to set a specific printing block Pb as a distance measurement target, or not to set a distance measurement target (no target). In a case where "no target" is selected, distance measurement is performed, but the measurement result is not used for position correction in the Z direction.

Furthermore, instead of measuring the distance (height), the inclination of the workpiece W can be detected. In a case where the inclination of the workpiece W is detected, the distance measurement positions I are set at least at three positions. By measuring the distance over three points, the inclination of the surface of the workpiece W can be detected. The laser printing apparatus L can also correct the inclination of the workpiece W with respect to the XY plane in addition to the positional deviation of the workpiece W in the Z direction.

Subsequently, in the second substep (step S142) in step S14, the print setting section 304a sets a distance measurement condition for each printing block Pb. Specifically, the print setting section 304a sets the central portion of the printing block Pb designated by the user input as the distance measurement position I, or designates coordinates designated by the user as the distance measurement position I.

Subsequently, in the third substep (step S143) in step S14, the print setting section 304a automatically adjusts the distance measurement condition. Specifically, as the distance measurement condition, the print setting section 304a automatically adjusts at least one of the amount of light emitted from the distance measurement light emitting section 7A, the light projection time of the distance measurement light emitting section 7A, the light reception gain of the distance measurement light receiving section 7B, and the exposure time of the distance measurement light receiving section 7B for each printing block Pb. Furthermore, the created distance measurement condition can be manually changed, or the distance measurement condition can be set in more detail.

The distance measurement conditions set in this manner are stored in the storage section 303 or the like as distance measurement settings. When the creation of the distance measurement setting is completed, the print setting section 304a proceeds from step S14 to step S15. The print setting section 304a returns from step S15 on the assumption that all settings have been created.

### 7. Operation of laser printing apparatus

Next, an operation procedure of the laser printing apparatus L will be described with reference to step S3 of FIG. 27 again. First, in step S31 of FIG. 27, when a trigger signal is input from the PLC 402 or the like to the printing controller 100, a new workpiece (printing target) W’ different from the workpiece (setting target) W used for various settings including the pattern region Rp is conveyed.

In subsequent step S32, the printing controller 100 executes pre-printing processing via the print head 1. In subsequent step S33, the printing controller 100 executes printing processing via the print head 1. In steps S32 and S33, the printing controller 100 executes a series of processing including printing processing.

Here, in steps S32 and S33, the printing controller 100 executes laser printing as printing processing and XYθ correction and Z correction as pre-printing processing.

When the series of processing illustrated in steps S32 and S33 is completed, the printing controller 100 advances the control process to step S34. In step S34, the printing controller 100 determines whether or not the operation of the laser printing apparatus L has ended on the basis of the condition settings transferred from the setting device 300, the input signal from the PLC 402, and the like. In a case where this determination is YES, the printing controller 100 ends the flow of FIG. 27.

On the other hand, in a case where the determination in step S34 is NO, the printing controller 100 waits until the trigger signal can be received again (step S35). When the trigger signal can be received, the printing controller 100 returns the control process to step S31.

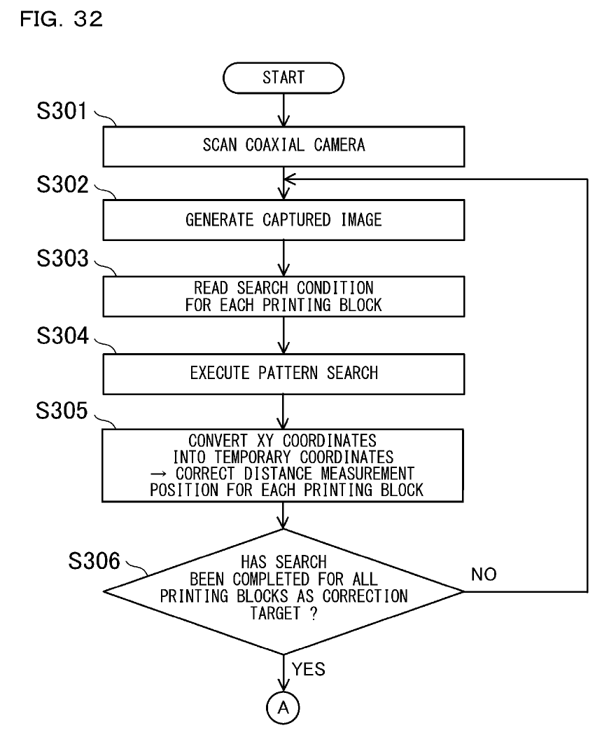

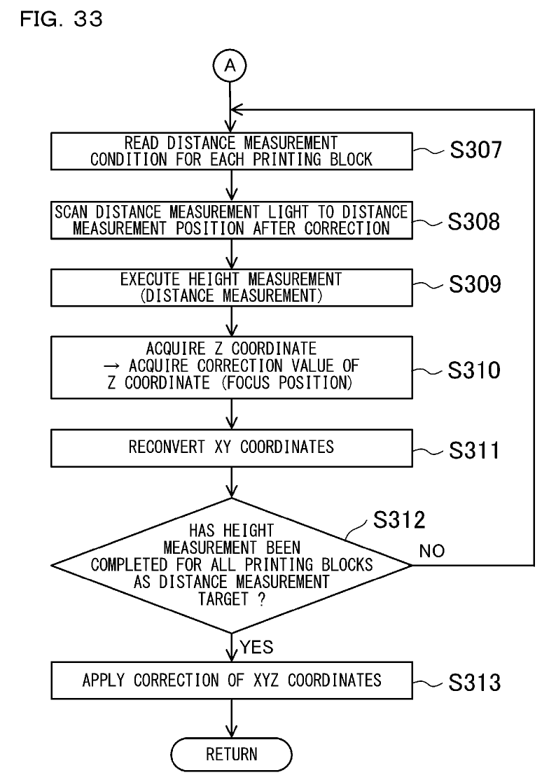

Hereinafter, a specific example of the pre-printing processing will be described with reference to FIGS. 32 and 33. First, in step S301 of FIG. 32, the printing controller 100 operates the laser light scanning section 5B. The printing controller 100 directs the imaging optical axis of the coaxial camera 65, that is, the scanning axis Lx toward a place where the workpiece W is assumed to be carried when the conveyance line is operated. Note that, in a case where the wide-area camera 8 is used instead of the coaxial camera 65, step S301 is unnecessary.

Thereafter, as illustrated in FIG. 1, it is assumed that a new workpiece W’ different from the workpiece W used for various settings including the pattern region Rp is conveyed below the print head 1 along with the input of the trigger signal.

Here, the printing block Pb corresponding to the printing pattern Pm is set by a coordinate system defined on the setting surface R2. Therefore, as illustrated in the lower part of FIG. 31, in a case where the printing target W’ has an XY misalignment with respect to the setting target W, there is a possibility that the printing pattern Pm cannot be formed at a desired position on the printing target W’.

Therefore, the printing controller 100 executes pattern search and XYθ correction based on the search result for the printing target W’ which is the new workpiece W’ described above.

Specifically, in step S302 subsequent to step S301, the printing controller 100 generates the captured image Pw’ via the camera selected in step S134, and displays the generated captured image Pw’ to be superimposed on the setting surface R2 (see FIG. 31).

Then, in step S303 subsequent to step S302, the printing controller 100 reads the condition setting (search condition) determined as in FIG. 28 for each of the printing blocks Pb selected in step S131 of FIG. 28.

In subsequent step S304, the printing controller 100 executes the pattern search. By executing the pattern search, the XY deviation of the pattern region Rp is detected between the initial workpiece W as the setting target W and a new workpiece W’ as the printing target W’ newly conveyed at the time of apparatus operation while having the same kind or the same type as the initial workpiece W.

The printing controller 100 determines the position and attitude of the pattern region Rp on the captured image Pw’ by executing pattern search in the same search region Rs as at the time of setting. This determination can be made, for example, on the basis of the position and attitude (see the virtual line Sr) of the image information (pattern image Pp).

For details, the printing controller 100 compares the image information (pattern image Pp) extracted in advance on the first workpiece W with the image information (image in the search region Rs) newly extracted on a new workpiece W’ different from the first workpiece W to find a region in which the two pieces of image information highly coincide with each other in the search region Rs as indicated by a virtual line Sr in FIG. 31. This search can be performed on the basis of the level of the correlation value. This correlation value is a parameter serving as an index in pattern search.

The printing controller 100 corrects the printing data on the basis of the relative positional relationship between the pattern region Rp and the printing block Pb, thereby correcting the position and attitude of the printing block Pb.

Note that the setting information related to the pattern search includes the relative positional relationship V1 between the pattern region Pr and the printing block Pb to be corrected (see FIG. 31). Therefore, if the position Sr of the pattern region Pr on the printing target W’ is specified, the printing block Pb’ and the printing pattern Pm’ corresponding to the position Sr can be determined on the basis of the relative positional relationship V1.

However, at this time point, the deviation (Z deviation) of the position and attitude between the workpieces W and W 'in the Z direction is not resolved. In a case where the Z deviation occurs (in a case where the height and inclination of the workpiece W change), the XY deviation further occurs due to the spread of the angle of view in the coaxial camera 65.

Therefore, only by correcting the position of the printing block Pb on the basis of the detection result obtained in step S304, the positional deviation in the XY direction due to the height of the printing target W’ remains.

Therefore, in step S305 following step S304, the correction processing section 105 temporarily corrects the XY deviation of the printing target W’ on the basis of the detection result of step S304.

Specifically, the correction processing section 105 shifts the printing coordinate system defined on the setting surface R2 in a direction of reducing the XY deviation detected by the correction processing section 105. Therefore, it is possible to convert the initially set XY coordinates into temporary XY coordinates (temporary coordinates) in which the XY deviation is at least partially reduced.

Then, by converting the XY coordinates into the temporary coordinates, the position of the printing block Pb set using the XY coordinates before the conversion moves along with the conversion into the temporary coordinates.

Note that the setting information related to the height correction includes coordinate information of the distance measurement position I set in association with each printing block Pb. Therefore, when the XY coordinates are converted into the temporary coordinates in step S305, the distance measurement position I also moves along with the movement of the printing block Pb.

That is, the correction processing section 105 generates the distance measurement position I’ on the printing target W’ by correcting the distance measurement position I set by the print setting section 304a (see FIG. 32).

As described above, the correction processing section 105 is configured to correct the position of the printing block Pb and the distance measurement position I between the setting object W and the printing object W’ on the basis of the detection result of the XY deviation.

Then, in step S306 subsequent to step S305, the printing controller 100 determines whether or not the pattern search has been completed for all the printing blocks Pb set as the correction target of the printing pattern Pm related to the XY deviation, and in a case where the determination is YES, the process proceeds to step S307 of FIG. 33, and in the case of NO, the process returns to step S302.

In subsequent step S307, the printing controller 100 reads condition settings (distance measurement conditions) determined as in FIG. 28 for each of the printing blocks Pb selected in step S141 of FIG. 28.

In subsequent step S308, the head control section 102 controls the laser light scanning section 5B so that the distance measurement position I’ after the correction is irradiated with the distance measurement light. Therefore, the distance from the print head 1 to the distance measurement position I’ reflecting the conversion to the temporary coordinate system can be measured.

In subsequent step S309, the distance measurement section 104 operates the distance measurement unit 7. At this time, the distance measurement light emitting section 7A measures the distance from the laser printing apparatus L to the surface of the printing target W’. The distance measurement light receiving section 7B receives the distance measurement light reflected on the surface of the printing target W’ and returned via the laser light scanning section 5B. Therefore, the distance from the print head 1 to the distance measurement position I’ corrected by the correction processing section 105 and the height of the printing target W’ at the distance measurement position I’ are measured.

In subsequent step S310, the correction processing section 105 acquires the Z coordinate of the workpiece W’ at the distance measurement position I’ and detects the Z deviation of the printing target W’ on the basis of the measurement result by the distance measurement section 104. This Z deviation can be detected on the basis of a difference between the acquired Z coordinate and a reference height (origin coordinate) in the Z direction.

The correction processing section 105 acquires the control parameter of the focus adjustment section 53 on the basis of the Z deviation of the printing target W’. The control parameter acquired here corresponds to a parameter (Z coordinate, focal position correction value) used when the focus adjustment section 53 corrects the focal position.

The parameters thus acquired are used for control of the focus adjustment section 53 by the head control section 102 before laser printing on the printing target W’ is executed. That is, the focus adjustment section 53 according to the present embodiment can adjust the focal position on the basis of the measurement result by the distance measurement section 104 in a state where the distance measurement position I has been corrected by the correction processing section 105 prior to the irradiation of the printing object W’ with the printing laser light.

In step S311 following step S310, the correction processing section 105 converts the XY coordinates again on the basis of the Z deviation detected in step S312. In the reconversion here, both the XY deviation detected by the pattern search and the position deviation in the XY direction caused by the height of the printing target W’ are considered.

Therefore, the XY deviation of the printing target W’ can be accurately corrected, and a desired printing pattern Pm can be formed at a desired position on the printing target W’.

Then, in step S312 following step S311, the printing controller 100 determines whether or not the height measurement has been completed for all the distance measurement positions I, and in a case where the determination is YES, the process proceeds to step S313, and in the case of NO, the process returns to step S307.

In step S313, the correction processing section 105 corrects the emission position of the UV laser light in the XYZ direction. In step S313, both the correction of the position and attitude in the XY direction in consideration of the influence of the height of the workpiece W and the correction of the position and attitude in the Z direction based on the height of the workpiece W (correction of the focal position) are considered.

Therefore, the pre-printing processing is completed. Thereafter, the process proceeds from step S313 of FIG. 33 to step S33 of FIG. 27, and the printing controller 100 executes printing processing with UV laser light.

Since the deviation of the position and attitude in the XYZ direction has already been corrected, the head control section 102 can perform the two-dimensional scanning in a state of considering the influence of the XY deviation and the Z deviation. Note that, in a case where inclination correction is performed with respect to height correction, height measurement is executed for at least three distance measurement positions I. In this case, in step S315 described above, correction for reducing the inclination (inclination correction) is executed. This inclination correction can be executed using trapezoid correction of the captured image Pw’, for example.

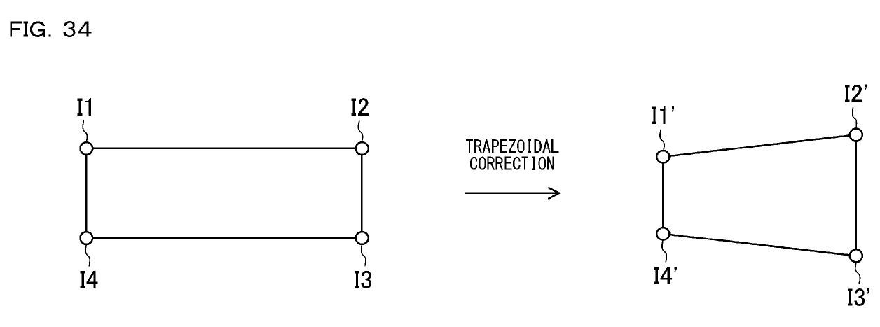

For example, as illustrated in FIG. 34, the heights of the distance measurement positions I1, I2, I3, and I4 are measured, and trapezoid correction may be performed so that the distance measurement positions I1 to I4 are set to four corners on the basis of the measurement result. In this case, the distance measurement positions I1, I2, I3, and I4 are converted into correction positions I1’, I2’, I3’, and I4’, respectively.

### 8. Distance calibration techniques

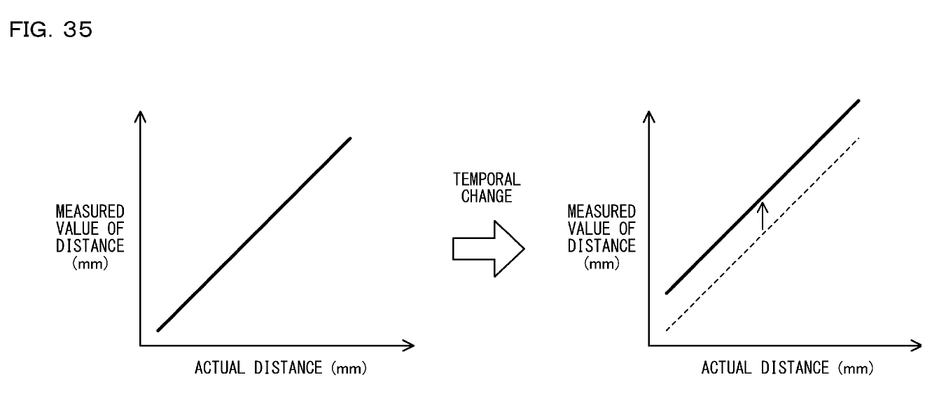

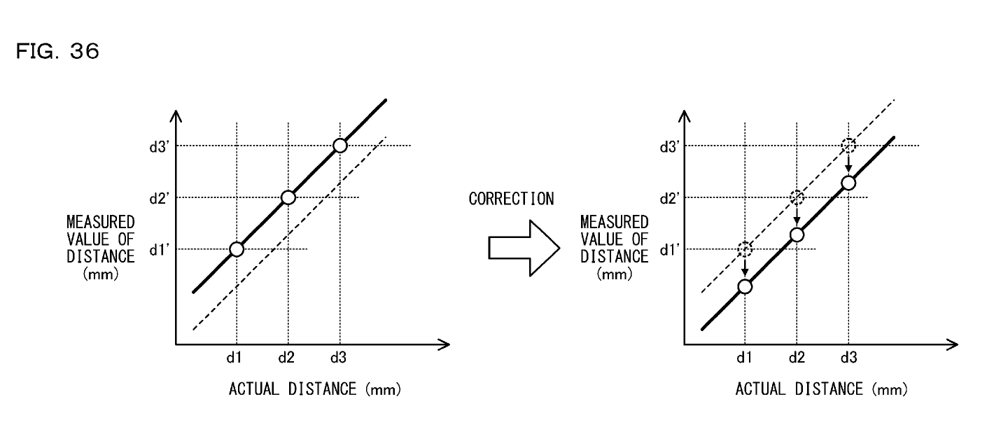

Next, as an application example of the measurement result by the distance measurement section 104, a method of calibrating the distance measurement unit 7 using the calibration unit 9 will be described. FIG. 35 is a diagram for explaining a temporal change of the distance measurement unit 7, and FIG. 36 is a diagram for explaining a method of calibrating the distance measurement unit 7.

As described above, the storage section 101 stores in advance the relationship between the light receiving position on the light receiving surface 76a and the distance between the print head 1 and the surface of the workpiece W.

As illustrated in the left diagram of FIG. 35, for example, at the initial stage immediately after manufacturing, the measured value of the distance obtained by the distance measurement unit 7 coincides with the actual distance (measured value of distance = actual distance).

However, for example, in a case where the position of the light receiving surface 76a changes back and forth or right and left due to circumstances such as a change with time, the relationship between the “actual distance” to the surface of the workpiece W and the light receiving position of the reflected light changes. In this case, when the relationship stored in the storage section 101 is used as it is, as illustrated in the right diagram of FIG. 35, a deviation occurs between the measured value of the distance and the actual distance (measured value of distance ≠ the actual distance).

In order to calibrate such a deviation, the calibration unit 9 is provided inside the housing 10. The distance calibration section 106 calibrates the deviation by correcting the measurement value using the calibration unit 9.

Specifically, in a case where the distance to the reference member 91 is measured using the calibration optical path Lc connecting the distance measurement light emitting section 7A and each reference member 91, the distance calibration section 106 according to the present embodiment corrects the measurement result by the distance measurement section 104 according to the comparison result between the measurement result and the reference distance stored in the storage section 101.

For details, the distance calibration section 106 executes correction on the measurement result using the calibration optical path Pc so as to match the reference distance stored in the storage section 101.

For more details, the distance calibration section 106 can correct the measurement result by the distance measurement section 104 by changing the stored content in the storage section 101. Alternatively or additionally, the distance calibration section 106 can correct the measurement result by the distance measurement section 104 by adjusting the gain of the signal read from each pixel arranged on the light receiving surface 57a for each pixel.

The calibration unit 9 according to the present embodiment includes the first reference member 91a, the second reference member 91b, and the third reference member 91c as the reference members 91. In this case, any one of the first reference member 91a, the second reference member 91b, and the third reference member 91c can be selected to correct the measurement result by the distance measurement section 104, or two or more of the first reference member 91a, the second reference member 91b, and the third reference member 91c can be selected to correct the measurement result by the distance measurement section 104.

In particular, the distance calibration section 106 according to the present embodiment can correct the measurement result by the distance measurement section 104 by using the reference distances d1, d2, and d3 related to the first reference member 91a, the second reference member 91b, and the third reference member 91c in combination.

Specifically, as illustrated in the left diagram of FIG. 36, the distance calibration section 106 measures distances related to each of the first reference member 91a, the second reference member 91b, and the third reference member 91c. When the measured value related to the first reference member 91a is denoted by d1’, the measured value related to the second reference member is denoted by d2’, and the measured value related to the third reference member 91c is denoted by d3’, it is expected that these measured values respectively coincide (d1’ = d1, d2’ = d2, d3’ = d3) with the reference distance, but there is a possibility that the measured value and the reference distance do not coincide (d1’ ≠ d1, d2’ ≠ d2, d3’ ≠ d3) due to circumstances such as a temporal change.

Therefore, as illustrated in the right diagram of FIG. 23, the distance calibration section 106 corrects the measured value of the distance related to the reference member 91 so as to coincide with the reference distance corresponding to each of the first reference member 91a, the second reference member 91b, and the third reference member 91c. As for a specific correction method, as described above, the storage content in the storage section 101 may be changed for correction, or the gain of the signal read from the light receiving surface 76a may be adjusted for each pixel for correction.

Note that the correction by distance calibration section 106 may be performed automatically or manually. As the timing of the automatic execution, for example, the correction may be executed at every preset cycle such as once a week, or may be executed when a predetermined temperature change or more occurs inside the housing 10. In addition to these timings or instead of these timings, for example, correction may be executed when a difference between a measurement result obtained from one light receiving element 76L and a measurement result obtained from the other light receiving element 76R becomes a predetermined value or more, correction may be executed when the print head 1 is activated, correction may be executed each time laser printing by UV laser light is performed, or measurement data may be sequentially stored in the printing controller 100, and correction may be executed when a moving average thereof deviates by a predetermined value or more.

These execution timings are stored in the storage section 101, and can be selected and/or changed via the setting device 300. Even in a case where the correction by the distance calibration section 106 is manually executed, the correction can be executed via the setting device 300.

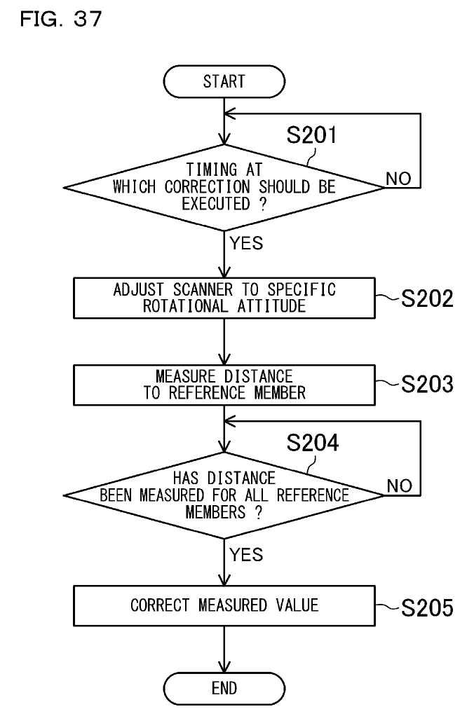

Hereinafter, a specific example of the calibration procedure will be described. FIG. 37 is a flowchart illustrating a calibration procedure of the distance measurement unit 7. The control process illustrated in the drawing is executed by the distance calibration section 106 in the printing controller 100.

First, in step S201, the distance calibration section 106 determines whether or not it is a timing at which correction should be executed. In a case where the determination is YES (for example, in a case where it is determined that a predetermined temperature change or more has occurred inside the housing 10), the process proceeds to step S202, and in a case where the determination is NO, the process returns to the determination of step S201.

In subsequent step S202, the distance calibration section 106 controls the laser light scanning section 5B via the head control section 102 to set the first scanner 54 and the second scanner 55 to specific rotational attitudes.

Specifically, the distance calibration section 106 determines the reference member 91 to be used for the measurement of the distance from among the plurality of reference members 91, and changes the attitudes of the first mirror 54a and the second mirror 55a such that the reference member 91 and the laser light scanning section 5B are optically coupled.

In subsequent step S203, the distance calibration section 106 controls the distance measurement unit 7 via the head control section 102 to measure the distance to the reference member 91 determined in step S202.

In subsequent step S204, the distance calibration section 106 determines whether or not the distance has been measured for all of the plurality of reference members 91. In a case where this determination is NO, the process returns to step S202, and a distance applied to another reference member 91 is measured. On the other hand, in a case where the determination in step S204 is YES, the process proceeds to step S205.

In subsequent step S205, the distance calibration section 106 calibrates the distance measurement unit 7 on the basis of the measured distance value obtained in step S203 and the reference distance stored in the storage section 101. This calibration is executed by correcting the measured value of the distance related to each reference member 91 to match the reference distance determined for each reference member 91.

Note that, in a case where calibration is performed using only one of the plurality of reference members 91, the determination according to step S204 can be omitted.

### 9. Effects and the like

As described above, according to the embodiment, the coupling section 3 that optically couples the excitation light generation section 2 and the laser light generation section 4 is built in the print head 1 (See FIGS. 4A, 7, 10, etc.). This allows the coupling section 3 to be covered by the housing 10 of the print head 1, which can be kept in a desired state. As a result, the excitation light can be appropriately sent from the excitation light generation section 2 to the laser light generation section 4, which contributes to high power of the UV laser light.

Moreover, as illustrated in FIG. 16, the wide-area camera 8 images the workpiece W, so that laser printing in a wider printing region R1 can be supported. Therefore, even if the UV laser light is increased in power, the position correction of the printing pattern Pm and the confirmation of the printing result can be sufficiently performed, and the printing failure can be suppressed.

Furthermore, as illustrated in FIG. 7, the wide-area camera 8 and the excitation light generation section 2 are disposed on opposite sides in the longitudinal direction (X direction) of the housing 10. With this arrangement, it is possible to suppress the thermal influence of the excitation light generation section 2 on the wide-area camera 8 as much as possible. Therefore, the wide-area camera 8 can exhibit desired performance, which is advantageous for suppressing printing failure using the wide-area camera 8.

Furthermore, as described with reference to FIG. 16, by applying wavelength selective coating as the return light suppression measure 81a to the surface of the imaging lens 81 of the wide-area camera 8, it is possible to suppress incidence of UV laser light on the wide-area camera 8. This is advantageous for suppressing printing failure using the wide-area camera 8.

Moreover, by using the wavelength selective coating for the return light suppression measure 81a, the number of components can be suppressed as compared with a configuration in which a new component is newly installed. This is advantageous for compactness of the print head 1.

Furthermore, as illustrated in FIG. 7, the coaxial camera 65 and the excitation light generation section 2 are disposed on opposite sides in the longitudinal direction (X direction) of the housing 10. With this arrangement, it is possible to suppress the thermal influence of the excitation light generation section 2 on the coaxial camera 65 as much as possible. Therefore, the coaxial camera 65 can exhibit desired performance, which is advantageous for suppressing printing failure using the wide-area camera 8 and the coaxial camera 65 in combination.

Furthermore, according to still another embodiment of the present disclosure, the coupling section may be configured by an optical fiber cable, and the coupling section may be disposed adjacent to the excitation light generation section in the second accommodation space in a state of being wound around a center axis extending in the longitudinal direction.

Furthermore, as illustrated in FIG. 10, an optical fiber cable (coupling section 3) that optically couples the excitation light generation section 2 and the laser light generation section 4 is built in the print head 1. In general, deflection of the optical fiber cable may lead to inconvenience in stabilizing the output of the UV laser light.

On the other hand, by covering the optical fiber cable as the coupling section 3 with the housing 10 of the print head 1, it is possible to maintain the optical fiber cable in a desired state without causing deflection of the optical fiber cable. This contributes to an increase in power of the UV laser light.

Moreover, by disposing the optical fiber cable as the coupling section 3 in a state of being wound around the central axis Ac1 extending in the longitudinal direction, it is possible to suppress an increase in volume of the housing 10 in the longitudinal direction.

Furthermore, as described with reference to FIG. 23, the distance measurement section 104 measures the distance from the print head 1 to the surface of the workpiece W, so that the focus of the UV laser light can be manually or automatically adjusted using the measurement result. Therefore, even in a case where workpieces having steps on the upper and lower sides or a plurality of workpieces W having different upper and lower heights are set as printing objects, it is possible to suppress printing failure.

Furthermore, as illustrated in FIG. 7, the distance measurement unit 7 and the excitation light generation section 2 are disposed on opposite sides in the longitudinal direction (X direction) of the housing 10. With this arrangement, it is possible to suppress the thermal influence of the excitation light generation section 2 on the distance measurement unit 7 as much as possible. Therefore, the measurement accuracy of the distance measurement unit 7 can be kept high, which is advantageous for suppressing printing failure using the measurement result.

Furthermore, as illustrated in FIGS. 5 and 6, by disposing the distance measurement unit 7 in an attitude in which the longitudinal direction of the support base 70 is disposed along in the height direction (Z direction), the distance measurement unit 7 can be further separated from the excitation light generation section 2. It is possible to further suppress the thermal influence of the excitation light generation section 2 on the distance measurement unit 7. Therefore, the measurement accuracy of the distance measurement unit 7 can be kept high, which is advantageous for suppressing printing failure using the measurement result.

Furthermore, as illustrated in FIGS. 32 and 33, the focus adjustment section 53 automatically adjusts the focal position of the UV laser light. Automatic adjustment of the focal point of the UV laser light contributes to improvement of user convenience.

Furthermore, according to the present disclosure, the print head may include a heat dissipation heat sink that is disposed so as to straddle the first housing space and the second housing space and extends in the longitudinal direction.

Furthermore, as illustrated in FIG. 7, by disposing the second heat dissipation heat sink 15b so as to straddle the first accommodation space Sp1 and the second accommodation space Sp2, heat can be dissipated over a wide range inside the print head 1. This makes it possible to suppress the thermal influence of various components on the distance measurement unit 7. As a result, the measurement accuracy of the distance measurement unit 7 can be kept high, which is advantageous for suppressing printing failure using the measurement result.

Furthermore, the excitation light generation section 2 and the laser light generation section 4 sandwiching the first and second heat dissipation heat sinks 15a and 15b can be efficiently cooled by the first and second heat dissipation heat sinks 15a and 15b. Therefore, the thermal influence of the excitation light generation section 2 and the laser light generation section 4 on the distance measurement unit 7 can be suppressed as much as possible. Therefore, the measurement accuracy of the distance measurement unit 7 can be kept high, which is advantageous for suppressing printing failure using the measurement result.

Furthermore, as illustrated in FIG. 25, the first and second heat dissipation heat sinks 15a and 15b can be cooled by the air cooling fan 15d. Therefore, the thermal influence of the excitation light generation section 2 and the laser light generation section 4 on the distance measurement unit 7 can be suppressed through the cooling of the first and second heat dissipation heat sinks 15a and 15b. As a result, the measurement accuracy of the distance measurement unit 7 can be kept high, which is advantageous for suppressing printing failure using the measurement result.

### 10. Other embodiments

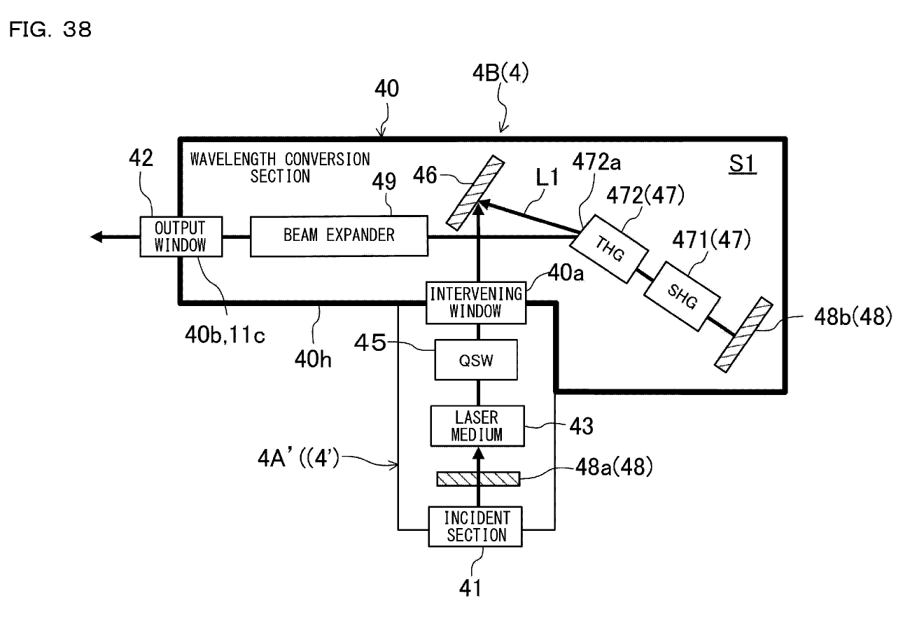

The layout of the optical component illustrated in FIG. 12 is merely an example. For example, as illustrated in FIG. 38, the optical components from the first resonance member 38a to the intervening window 40a may be laid out in the same straight line.

Furthermore, in the above embodiment, the laser printing apparatus L including the distance measurement unit 7 has been exemplified, but such a configuration is not essential in the present disclosure. The laser printing apparatus L may not include the distance measurement unit 7.

Furthermore, in the above embodiment, the wide-area camera 8 is configured to be disposed outside the sealing section 11, but such a configuration is not essential in the present disclosure. The wide-area camera 8 may be disposed inside the sealing section 11.

Furthermore, in the above embodiment, the fifth optical member 52 as the merging mechanism Mc is configured to be hermetically sealed by the sealing section 11, but such a configuration is not essential in the present disclosure. The merging portion of the UV laser light and the distance measurement light may not be hermetically sealed.

What is claimed is:

1. A UV laser marker comprising:
an excitation light generation section configured to generate excitation light;
a laser light generation section including a nonlinear optical crystal and configured to generate UV laser light on a basis of the nonlinear optical crystal and the excitation light generated by the excitation light generation section;
a coupling section configured to optically couple the excitation light generation section and the laser light generation section;
a laser light scanning section configured to two-dimensionally scan the UV laser light generated by the laser light generation section and irradiate a printing object with the UV laser light;
a print head configured to incorporate the excitation light generation section, the laser light generation section, the coupling section, and the laser light scanning section; and
a printing controller electrically connected to the print head and including a control section configured to control the excitation light generation section, the laser light generation section, and the laser light scanning section,
wherein the print head includes:
an emission window configured to emit UV laser light two-dimensionally scanned by the laser light scanning section to an outside of the print head; and
an imaging section having an imaging optical axis independent of a laser optical path of the UV laser light emitted from the emission window and configured to image the printing object via the emission window.

2. The UV laser marker according to claim 1, wherein
the print head includes a housing extending in a predetermined longitudinal direction and configured to accommodate the excitation light generation section, the laser light generation section, the coupling section, and the laser light scanning section,
the imaging section is disposed in a first accommodation space indicating one of two spaces when an internal space of the housing is divided into two at a center portion in the longitudinal direction, and
the excitation light generation section is disposed in a second accommodation space indicating another of the two spaces when the internal space of the housing is divided into two at the center portion in the longitudinal direction.

3. The UV laser marker according to claim 1, wherein
the print head includes a return light suppression measure configured to suppress incidence of return light of UV laser light reflected on a surface of the printing object on the imaging section.

4. The UV laser marker according to claim 3, wherein
the return light suppression measure is configured by a wavelength selective coating applied to a surface of an imaging lens of the imaging section.

5. The UV laser marker according to claim 2, wherein
the print head includes a coaxial camera having an imaging optical axis separated from the laser optical path between the laser light generation section and the laser light scanning section, and configured to receive image forming light along the imaging optical axis to image the printing object via the laser light scanning section and the emission window, and
the coaxial camera is disposed in the first accommodation space.

6. The UV laser marker according to claim 2, wherein
the coupling section is configured by an optical fiber cable, and
the coupling section is disposed adjacent to the excitation light generation section in the second accommodation space in a state of being wound around a center axis extending in the longitudinal direction.

7. The UV laser marker according to claim 2, wherein
the print head includes:
a distance measurement light generation section configured to generate and emit distance measurement light for measuring a distance from the print head to a surface of the printing object;
a merging mechanism configured to merge the distance measurement light generated by the distance measurement light generation section with the laser optical path; and
a distance measurement light receiving section configured to receive distance measurement light that merges in the merging mechanism and is two-dimensionally scanned via the laser light scanning section, the distance measurement light being reflected on the surface of the printing object, returned via the laser light scanning section, and separated from the laser optical path by the merging mechanism,
the printing controller includes a distance measurement section configured to measure a distance from the print head to the surface of the printing object on a basis of a light receiving position of the distance measurement light received by the distance measurement light receiving section,
the distance measurement light generation section and the distance measurement light receiving section constitute an integrated distance measurement unit, and
the distance measurement unit is disposed in the first accommodation space.

8. The UV laser marker according to claim 7, wherein
the distance measurement unit includes a support base configured to support the distance measurement light generation section and the distance measurement light receiving section, and
the distance measurement unit is disposed in the first accommodation space in an attitude in which the support base is disposed along a height direction orthogonal to the longitudinal direction.

9. The UV laser marker according to claim 7, wherein
the print head includes a focus adjustment section disposed in a middle of a laser optical path of the UV laser light generated by the laser light generation section and reaching the laser light scanning section and configured to adjust a focal position of the UV laser light generated by the laser light generation section on a basis of a measurement result of the distance measurement section.

10. The UV laser marker of claim 2, wherein
the print head includes a heat dissipation heat sink disposed to straddle the first accommodation space and the second accommodation space and extending in the longitudinal direction.

11. The UV laser marker according to claim 10, wherein
the heat dissipation heat sink is disposed to be sandwiched between the excitation light generation section and the laser light generation section in a lateral direction orthogonal to the longitudinal direction.

12. The UV laser marker according to claim 10, further comprising
an air cooling fan configured to air-cool the heat dissipation heat sink.
